(19) United States
(12) Patent Application Publication
(10) Pub. No.: US 2010/0285959 A1
(43) Pub. Date: Nov. 11, 2010

(54) HERBICIDAL MIXTURES

(76) Inventors: Gregory Russell Armel, Knoxville, TN (US); Josephine Cecilia Cotterman, Wilmington, DE (US); Edison Hidalgo, Newark, DE (US); Michael L. Link, Byron, GA (US); David William Saunders, Dallas Center, IA (US); Mark S. Casini, Elkton, MD (US); Patrick Lee Rardon, Elkton, MD (US); Stephen Douglas Strachan, Oxford, PA (US); Leslie Lloyd, Newton, IA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/296,474

(22) PCT Filed: Apr. 10, 2007
(86) PCT No.: PCT/US07/08930

§ 371 Date: Sep. 1, 2009

Related U.S. Application Data
(60) Provisional application No. 60/790,659, filed on Apr. 10, 2006.
(60) Provisional application No. 60/852,139, filed on Oct. 17, 2006.

(51) Int. Cl. A01N 25/32; A01N 43/54; A01P 13/00

(52) U.S. Cl. 504/105; 504/136

(57) ABSTRACT

Disclosed is a herbicidal mixture comprising (a) at least one herbicide compound selected from the pyrimidines of Formula 1, including all geometric and stereoisomers, N-oxides, and salts thereof:

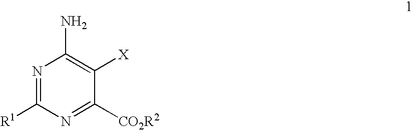

wherein
R¹ is cyclopropyl, 4-Br-phenyl or 4-Cl-phenyl;
X is Cl or Br;
R² is H, C₁-C₁₄ alkyl, C₂-C₁₄ alkoxyalkyl, C₃-C₁₄ alkoxyalkoxyalkyl, C₂-C₁₄ hydroxyalkyl or benzyl; and
(b) at least one additional herbicide or herbicide safener compound selected from the group consisting of (b1) ACCase inhibitors, (b2) AHAS inhibitors, (b3) photosystem II inhibitors, (b4) photosystem I electron diverters, (b5) PPO inhibitors, (b6) EPSP synthase inhibitors, (b7) GS inhibitors, (b8) VLCFA inhibitors, (b9) auxin mimics, (b10) auxin transport inhibitors, (b11) other herbicides selected from the group consisting of flamprop-M-methyl, flamprop-M-isopropyl, difenzoquat, DSMA, MSMA, bromobutide, flurenol, cinmethylin, cumyluron, dazomet, dymron, methyldymron, etobenzanid, fosamine-ammonium, isoxaflutole, asulam, clomazone, mesotrione, metam, oxaziclomefone, oleic acid, pelargonic acid and pyributicarb, (b12) herbicide safeners selected from the group consisting of benoxacor, 1-bromo-4-[(chloromethyl)sulfonyl]benzene, cloquintocet-mexyl, cyometrinil, dichlormid, 2-(dichloromethyl)-2-methyl-1,3-dioxolane, fenchlorazole-ethyl, fenclorim, flurazole, fluxofenim, furilazole, isoxadifen-ethyl, mefenpyr-diethyl, methoxyphenone, naphthalic anhydride and oxabetrinil, and their salts. Also disclosed is a method for controlling the growth of undesired vegetation comprising contacting the vegetation or its environment with a herbicidally effective amount of a mixture of the invention (e.g., as a composition described herein).

This application claims priority benefit of U.S. Provisional Patent Application No. 60/790,659, filed Apr. 10, 2006 and U.S. Provisional Patent Application 60/852,139, filed Oct. 17, 2007. These priority applications are hereby incorporated by reference in their entirety to the extent that they are not inconsistent with the disclosure herein.

### FIELD OF THE INVENTION

This invention relates to herbicidal mixtures of certain pyrimidine derivatives, their N-oxides and salts, and to compositions comprising such mixtures, and methods for controlling undesirable vegetation.

### BACKGROUND OF THE INVENTION

The control of undesired vegetation is extremely important in achieving high crop efficiency. Achievement of selective control of the growth of weeds especially in such useful crops as rice, soybean, sugar beets, corn (maize), potatoes, wheat, barley, tomatoes, sugarcane and plantation crops, among others, is very desirable. Unchecked weed growth in such useful crops can cause significant reduction in productivity and thereby result in increased costs to the consumers. The control of undesired vegetation in noncrop areas is also important.

Combinations of herbicides are typically used to broaden the spectrum of plant control or enhance the level of control of any given species through additive effect. Certain rare combinations surprisingly give a greater-than-additive or synergistic effect. Such valuable combinations have now been discovered. Additionally, certain rare combinations surprising give a less than additive or safening effect on useful crops. Such valuable combinations have also now been discovered.

PCT Patent Publication WO 2005/063721 discloses herbicidally active 4-pyrimidine carboxylic acids of Formula i

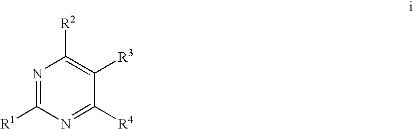

wherein R¹ is cyclopropyl optionally substituted with 1-5 R⁵, or phenyl optionally substituted with 1-3 R⁷; R² is ((O)ⱼC(R¹⁵)(R¹⁶))ₖR; R is CO₂H or a herbicidally effective derivative of CO₂H; R³ is halogen, cyano, nitro; R⁴ is —N(R²⁴)R²⁵ or —NO₂; j is 0 or 1; and k is 0 or 1; provided that when k is 0, then j is 0; and R⁵, R⁷, R¹⁵, R¹⁶, R²⁴ and R²⁵ are as defined in the disclosure. However, it does not specifically disclose the mixtures of the present invention or their surprising synergistic utility.

### SUMMARY OF THE INVENTION

This invention is directed to a herbicidal mixture comprising (a) at least one herbicide compound selected from the pyrimidines of Formula 1, including all geometric and stereoisomers, N-oxides, and salts thereof:

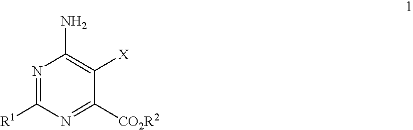

wherein
R¹ is cyclopropyl, 4-Br-phenyl or 4-Cl-phenyl;
X is Cl or Br; and
R² is H, C₁-C₁₄ alkyl, C₂-C₁₄ alkoxyalkyl, C₃-C₁₄ alkoxyalkoxyalkyl, C₂-C₁₄ hydroxyalkyl or benzyl; and
(b) at least one additional herbicide or herbicide safener compound selected from the group consisting of
(1)) ACCase (acetyl-coenzyme A carboxylase) inhibitors;
(b2) AHAS (acetohydroxy acid synthase) inhibitors;
(b3) photosystem II inhibitors;
(b4) photosystem I electron diverters;
(b5) PPO (protoporphyrinogen oxidase) inhibitors;
(b6) EPSP (5-enol-pyruvylshikimate-3-phosphate) synthase inhibitors;
(b7) GS (glutamine synthetase) inhibitors;
(b8) VLCFA (very long chain fatty acid) elongase inhibitors;
(b9) auxin mimics;
(b10) auxin transport inhibitors;
(b11) other herbicides selected from the group consisting of flamprop-M-methyl, flamprop-M-isopropyl, difenzoquat, DSMA, MSMA, bromobutide, flurenol, cinmethylin, cumyluron, dazomet, dymron, methyldymron, etobenzanid, fosamine-ammonium, isoxaflutole, asulam, clomazone, mesotrione, metam, oxaziclomefone, oleic acid, pelargonic acid and pyributicarb;
(b12) herbicide safeners selected from the group consisting of benoxacor, 1-bromo-4-[(chloromethyl)sulfonyl]benzene, cloquintocet-mexyl, cyometrinil, dichlormid, 2-(dichloromethyl)-2-methyl-1,3-dioxolane, fenchlorazole-ethyl, fenclorim, flurazole, fluxofenim, furilazole, isoxadifen-ethyl, mefenpyr-diethyl, methoxyphenone, naphthalic anhydride and oxabetrinil; and
   salts of compounds of (b1) through (b12).

This invention also relates to a herbicidal composition comprising a herbicidally effective amount of a mixture of the invention and at least one of a surfactant, a humectant, a solid diluent or a liquid diluent.

This invention further relates to a method for controlling the growth of undesired vegetation comprising contacting the vegetation or its environment with a herbicidally effective amount of a mixture of the invention (e.g., as a composition described herein).

### DETAILS OF THE INVENTION

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

Numeric ranges are inclusive of each and every integer value defining the range.

In the above recitations, the term “alkyl” includes straight-chain or branched alkyl, such as, methyl, ethyl, n-propyl, i-propyl, or the different butyl, pentyl or hexyl isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkoxyalkoxy” denotes alkoxy substitution on alkoxy. “Alkoxyalkoxyalkyl” denotes alkoxyalkoxy substitution on alkyl. Examples of “alkoxyalkoxyalkyl” include CH₃OCH₃OCH₂, CH₃OCH₃OCH₂CH₂, CH₃CH₂OCH₃OCH₂ and CH₃OCH₃CH₂OCH₂CH₂. “Hydroxyalkyl” denotes hydroxy substitution on alkyl. Examples of “hydroxyalkyl” include HOCH₂CH₂ and HOCH₂CH₂CH₂CH₂.

Compounds in the mixtures of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers.

One skilled in the art recognizes that because in the environment and under physiological conditions salts of chemical compounds are in equilibrium with their corresponding nonsalt forms, salts share the biological utility of the nonsalt forms. Thus a wide variety of salts of the compounds of Formula 1 are useful for control of undesired vegetation (i.e. are agriculturally suitable). The salts of the compounds in the mixtures of this invention including Formula 1 include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. When a compound of Formula 1 contains an acidic moiety such as a carboxylic acid or phenol, salts also include those formed with organic or inorganic bases such as pyridine, triethylamine or ammonia, or amides, hydrides, hydroxides or carbonates of sodium, potassium, lithium, calcium, magnesium or barium. Accordingly, the present invention compromises compounds selected from Formula 1, N-oxides and salts thereof.

Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

“ACCase inhibitors” are chemical compounds that inhibit the acetyl-CoA carboxylase enzyme, which is responsible for catalyzing an early step in lipids and fatty acid synthesis in plants. Lipids are essential components of cell membranes, and without them, new cells cannot be produced. The inhibition of acetyl CoA carboxylase and the subsequent lack of lipid production leads to losses in cell membrane integrity, especially in regions of active growth such as meristems. Eventually shoot and rhizome growth ceases, and shoot meristems and rhizome buds begin to die back. Examples of ACCase inhibitors include but are not limited to fenoxaprop and clodinafop.

“AHAS inhibitors” are chemical compounds that inhibit acetohydroxy acid synthase (AHAS), also known as acetolactate synthase (ALS), and thus kill plants by inhibiting the production of the branched-chain aliphatic amino acids such as valine, leucine and isoleucine, which are required for DNA synthesis and cell growth. Examples of AHAS inhibitors include but are not limited to chlorsulfuron, metsulfuron-methyl and imazapyr.

“Photosystem II inhibitors” are chemical compounds that bind to the D-1 protein at the Q_{B}-binding niche and thus block electron transport from Q_{A} to Q_{B} in the chloroplast thylakoid membranes. The electrons blocked from passing through photosystem II are transferred through a series of reactions to form toxic compounds that disrupt cell membranes and cause chloroplast swelling, membrane leakage, and ultimately cellular destruction. The Q_{B}-binding niche has three different binding sites: binding site A binds the triazines such as atrazine, triazinones such as hexazinone, and uracils such as bromacil, binding site B binds the phenylureas such as diuron, and binding site C binds benzothiadiazoles such as bentazon, nitriles such as bromoxynil and phenyl-pyridazines such as pyridate.

“Photosystem I electron diverters” are chemical compounds that accept electrons from Photosystem I, and after several cycles, generate hydroxyl radicals. These radicals are extremely reactive and readily destroy unsaturated lipids, including membrane fatty acids and chlorophyll. This destroys cell membrane integrity, so that cells and organelles “leak”, leading to rapid leaf wilting and desiccation, and eventually to plant death. Examples of this second type of photosynthesis inhibitor include but are not limited to paraquat and diquat.

“PPO inhibitors” are chemical compounds that inhibit the enzyme protoporphyrinogen oxidase, quickly resulting in formation of highly reactive compounds in plants that rupture cell membranes, causing cell fluids to leak out. Examples of PPO inhibitors include but are not limited to carfentrazone, acifluorfen and lactofen.

“EPSP synthase inhibitors” are chemical compounds that inhibit the enzyme, 5-enol-pyruvylshikimate-3-phosphate synthase, which is involved in the synthesis of aromatic amino acids such as tyrosine, tryptophan and phenylalanine. EPSP inhibitor herbicides are readily absorbed through plant foliage and translocated in the phloem to the growing points. Glyphosate is a relatively nonselective postemergence herbicide that belongs to this group. Glyphosate includes esters and salts such as ammonium, isopropylammonium, potassium, sodium (including sesquisodium) and trimesium (alternatively named sulfosate).

“GS inhibitors” are chemical compounds that inhibit the activity of the glutamine synthetase enzyme, which plants use to convert ammonia into glutamine. Consequently, ammonia accumulates and glutamine levels decrease. Plant damage probably occurs due to the combined effects of ammonia toxicity and deficiency of amino acids required for other metabolic processes. The GS inhibitors include but are not limited to glufosinate and its esters and salts and other phosphinothricin derivatives.

Elongase is one of the enzymes located in or near chloroplasts which are involved in biosynthesis of very-long-chain fatty acids (VLCFAs). In plants, very-long-chain fatty acids are the main constituents of hydrophobic polymers that prevent desiccation at the leaf surface and provide stability to pollen grains. “VLCFA elongase inhibitors” are herbicides having a wide variety of chemical structures, which inhibit the elongase. Such herbicide include but are not limited to cafenstrole, indanofan, chloroacetamides and oxyacetamides.

Auxin is a plant hormone that regulates growth in many plant tissues. “Auxin mimics” are chemical compounds mimicking the plant growth hormone auxin, thus causing uncontrolled and disorganized growth leading to plant death in susceptible species. Examples of auxin mimics include but are not limited to picloram, clopyralid, triclopyr and 2,4-D.

“Auxin transport inhibitors” are chemical substances that inhibit auxin transport in plants, such as by binding with an auxin-carrier protein. Examples of auxin transport inhibitors include but are not limited to naptalam (also known as N-(1-naphthyl)phthalamic acid and 2-[(1-naphthalenylamino)carbonyl]benzoic acid) and diflufenzopyr.

“Herbicide safeners” are substances added to a herbicide formulation to eliminate or reduce phytotoxic effects of the herbicide to certain crops. These compounds protect crops from injury by herbicides but typically do not prevent the herbicide from killing weeds. Examples of herbicide safeners include but are not limited to isoxadifen-ethyl and naphthalic anhydride.

“Humectants” are hygroscopic substances which increase residency time of the mixture of the invention on foliage. Examples of humectants include but are not limited to glycerol, propylene glycerol and glyceryl triacetate.

Where reference is made in the following Embodiments to “Formula 1”, the term “Formula 1” is meant to include all geometric and stereoisomers, N-oxides, and salts thereof.

Embodiments of the present invention include:

Embodiment A1. A mixture comprising a herbicide compound of Formula 1 wherein R² is H, C₁-C₁₀ alkyl, C₂-C₁₀ alkoxyalkyl, C₃-C₁₀ alkoxyalkoxyalkyl, C₂-C₁₀ hydroxyalkyl or benzyl.

Embodiment A2. A mixture comprising a herbicide compound of Embodiment A1 wherein R² is H, C₁-C₄ alkyl, C₂-C₄ alkoxyalkyl, C₃-C₄ alkoxyalkoxyalkyl, C₂-C₄ hydroxyalkyl or benzyl.

Embodiment A3. A mixture comprising a herbicide compound of Embodiment A2 wherein R² is H or C₁-C₂ alkyl.

Embodiment A4. A mixture comprising a herbicide compound of Embodiment A1 wherein R² is C₅-C₁₀ alkyl, C₅-C₁₀ alkoxyalkyl, C₅-C₁₀ alkoxyalkoxyalkyl or C₅-C₁₀ hydroxyalkyl.

Embodiment A5. A mixture comprising a herbicide compound of Embodiment A4 wherein R² is C₅-C₈ alkyl, C₅-C₈ alkoxyalkyl or C₅-C₈ alkoxyalkoxyalkyl.

Embodiment A6. A mixture comprising a herbicide compound of Formula 1 wherein R¹ is cyclopropyl.

Embodiment A7. A mixture comprising a herbicide compound of Formula 1 wherein X is Cl.

Embodiment A8. A mixture comprising a herbicide compound of Formula 1 wherein X is Br.

Embodiment B1. A mixture comprising a herbicide compound of Formula 1 and an additional herbicide compound selected from (b1) such as clodinafop, fenoxaprop, fluazifop, pinoxaden, quizalofop or tralkoxydim.

Embodiment B2. A mixture comprising a herbicide compound of Formula 1 and an additional herbicide compound selected from (b2) such as chlorimuron-ethyl, chlorsulfuron, flupyrsulfuron-methyl, foramsulfuron, metsulfuron-methyl, nicosulfuron, rimsulfuron, sulfometuron-methyl, thifensulfuron-methyl, tribenuron-methyl, imazamethabenz-methyl, imazapyr, imazaquin or imazethapyr.

Embodiment B3. A mixture comprising a herbicide compound of Formula 1 and an additional herbicide compound selected from (b3) such as ametryn, amicarbazone, atrazine, bentazon, bromacil, bromoxynil, chlorotoluron, diuron, hexazinone, isoproturon, metribuzin, pyridate, simazine or terbutryn.

Embodiment B4. A mixture comprising a herbicide compound of Formula 1 and an additional herbicide compound selected from (b4) such as paraquat.

Embodiment B5. A mixture comprising a herbicide compound of Formula 1 and an additional herbicide compound selected from (b5) such as carfentrazone, oxadiazon, oxyfluorfen, profluazol, acifluorfen, flumioxazin, azafenidin or sulfentrazone.

Embodiment B6. A mixture comprising a herbicide compound of Formula 1 and an additional herbicide compound selected from (b6) such as glyphosate or sulfosate.

Embodiment B7. A mixture comprising a herbicide compound of Formula 1 and an additional herbicide compound selected from (b7) such as glufosinate or glufosinate-ammonium.

Embodiment B8. A mixture comprising a herbicide compound of Formula 1 and an additional herbicide compound selected from (b8) such as acetochlor, alachlor, flufenacet, metolachlor or S-metolachlor.

Embodiment B9. A mixture comprising a herbicide compound of Formula 1 and an additional herbicide compound selected from (b9) such as 2,4-D, aminopyralid, clopyralid, dicamba, fluroxypyr, MCPA, MCPP, picloram or triclopyr.

Embodiment B10. A mixture comprising a herbicide compound of Formula 1 and an additional herbicide compound selected from (b10) such as diflufenzopyr or naptalam.

Embodiment B11. A mixture comprising a herbicide compound of Formula 1 and an additional herbicide compound selected from (b11) such as fosamine-ammonium or isoxaflutole.

Embodiment B12. A mixture comprising a herbicide compound of Formula 1 and an additional herbicide safener compound selected from (b12) such as isoxadifen-ethyl or naphthalic anhydride.

Embodiment B13. A mixture comprising a herbicide compound of Formula 1 and at least two additional herbicide or herbicide safener compounds (b) selected from the group consisting of (b1), (b2), (b3), (b4), (b5), (b6), (b7), (b8), (b9), (b10), (b11) and (b12).

Embodiment B14. A mixture comprising a herbicide compound of Formula 1, atrazine and chlorimuron-ethyl.

Embodiment B 15. A mixture comprising a herbicide compound of Formula 1, atrazine and metsulfuron-methyl.

Embodiment B16. A mixture comprising a herbicide compound of Formula 1, atrazine and nicosulfuron.

Embodiment B17. A mixture comprising a herbicide compound of Formula 1, atrazine and rimsulfuron.

Embodiment B 18. A mixture comprising a herbicide compound of Formula 1, atrazine and thifensulfuron-methyl.

Embodiment B19. A mixture comprising a herbicide compound of Formula 1, atrazine and tribenuron-methyl.

Embodiment B20. A mixture comprising a herbicide compound of Formula 1, bromacil and diuron.

Embodiment B21. A mixture comprising a herbicide compound of Formula 1, bromoxynil and 2,4-D.

Embodiment B22. A mixture comprising a herbicide compound of Formula 1, diflufenzopyr and glyphosate.

Embodiment B23. A mixture comprising a herbicide compound of Formula 1, diflufenzopyr, glyphosate and chlorimuron-ethyl.

Embodiment B24. A mixture comprising a herbicide compound of Formula 1, diflufenzopyr, glyphosate and metsulfuron-methyl.

Embodiment B25. A mixture comprising a herbicide compound of Formula 1, diflufenzopyr, glyphosate and nicosulfuron.

Embodiment B26. A mixture comprising a herbicide compound of Formula 1, diflufenzopyr, glyphosate and rimsulfuron.

Embodiment B27. A mixture comprising a herbicide compound of Formula 1, diflufenzopyr, glyphosate and thifensulfuron-methyl.

Embodiment B28. A mixture comprising a herbicide compound of Formula 1, diflufenzopyr, glyphosate and tribenuron-methyl.

Embodiment B29. A mixture comprising a herbicide compound of Formula 1, diflufenzopyr and nicosulfuron.

Embodiment B30. A mixture comprising a herbicide compound of Formula 1, diflufenzopyr and rimsulfuron.

Embodiment B31. A mixture comprising a herbicide compound of Formula 1, flumetsulam and clopyralid.

Embodiment B32. A mixture comprising a herbicide compound of Formula 1, flupyrsulfuron-methyl and clodinafop.

Embodiment B33. A mixture comprising a herbicide compound of Formula 1, flupyrsulfuron-methyl and diflufenican.

Embodiment B34. A mixture comprising a herbicide compound of Formula 1, glyphosate and atrazine.

Embodiment B35. A mixture comprising a herbicide compound of Formula 1, glyphosate, atrazine and chlorimuron-ethyl.

Embodiment B36. A mixture comprising a herbicide compound of Formula 1, glyphosate, atrazine and metsulfuron-methyl.

Embodiment B37. A mixture comprising a herbicide compound of Formula 1, glyphosate, atrazine and nicosulfuron.

Embodiment B38. A mixture comprising a herbicide compound of Formula 1, glyphosate, atrazine and rimsulfuron.

Embodiment B39. A mixture comprising a herbicide compound of Formula 1, glyphosate, atrazine and thifensulfuron-methyl.

Embodiment B40. A mixture comprising a herbicide compound of Formula 1, glyphosate, atrazine and tribenuron-methyl.

Embodiment B41. A mixture comprising a herbicide compound of Formula 1, glyphosate and chlorimuron-ethyl.

Embodiment B42. A mixture comprising a herbicide compound of Formula 1, glyphosate and metsulfuron-methyl.

Embodiment B43. A mixture comprising a herbicide compound of Formula 1, glyphosate and nicosulfuron.

Embodiment B44. A mixture comprising a herbicide compound of Formula 1, glyphosate and rimsulfuron.

Embodiment B45. A mixture comprising a herbicide compound of Formula 1, glyphosate and thifensulfuron-methyl.

Embodiment B46. A mixture comprising a herbicide compound of Formula 1, glyphosate and tribenuron-methyl.

Embodiment B47. A mixture comprising a herbicide compound of Formula 1, hexazinone and diuron.

Embodiment B48. A mixture comprising a herbicide compound of Formula 1, hexazinone, diuron and ametryn.

Embodiment B49. A mixture comprising a herbicide compound of Formula 1, iodosulfuron-methyl and clodinafop.

Embodiment B50. A mixture comprising a herbicide compound of Formula 1, mesosulfuron-methyl, iodosulfuron-methyl and diflufenican.

Embodiment B51. A mixture comprising a herbicide compound of Formula 1, metsulfuron-methyl, chlorsulfuron and clodinafop.

Embodiment B52. A mixture comprising a herbicide compound of Formula 1, metsulfuron-methyl, chlorsulfuron and fenoxaprop.

Embodiment B53. A mixture comprising a herbicide compound of Formula 1, metsulfuron-methyl and clodinafop.

Embodiment B54. A mixture comprising a herbicide compound of Formula 1, metsulfuron-methyl and fenoxaprop.

Embodiment B55. A mixture comprising a herbicide compound of Formula 1, metsulfuron-methyl, sulfometuron-methyl and hexazinone.

Embodiment B56. A mixture comprising a herbicide compound of Formula 1, rimsulfuron and dicamba.

Embodiment B57. A mixture comprising a herbicide compound of Formula 1, thifensulfuron-methyl and clodinafop.

Embodiment B58. A mixture comprising a herbicide compound of Formula 1, thifensulfuron-methyl and fenoxaprop.

Embodiment B59. A mixture comprising a herbicide compound of Formula 1, thifensulfuron-methyl, metsulfuron-methyl and clodinafop.

Embodiment B60. A mixture comprising a herbicide compound of Formula 1, thifensulfuron-methyl, metsulfuron-methyl and fenoxaprop.

Embodiment B61. A mixture comprising a herbicide compound of Formula 1, tribenuron-methyl and bromoxynil.

Embodiment B62. A mixture comprising a herbicide compound of Formula 1, tribenuron-methyl and clodinafop.

Embodiment B63. A mixture comprising a herbicide compound of Formula 1, tribenuron-methyl and fenoxaprop.

Embodiment B64. A mixture comprising a herbicide compound of Formula 1, tribenuron-methyl and MCPP.

Embodiment B65. A mixture comprising a herbicide compound of Formula 1, tribenuron-methyl, metsulfuron-methyl and clodinafop.

Embodiment B66. A mixture comprising a herbicide compound of Formula 1, tribenuron-methyl, metsulfuron-methyl and fenoxaprop.

Embodiment B67. A mixture comprising a herbicide compound of Formula 1, tribenuron-methyl, thifensulfuron-methyl and clodinafop.

Embodiment B68. A mixture comprising a herbicide compound of Formula 1, tribenuron-methyl, thifensulfuron-methyl and fenoxaprop.

Embodiment B69. A mixture comprising a herbicide compound of Formula 1, tritosulfuron and dicamba.

Embodiment B70. A mixture comprising a herbicide compound of Formula 1, diflufenzopyr and chlorimuron-ethyl.

Embodiment B71. A mixture comprising a herbicide compound of Formula 1, diflufenzopyr and metsulfuron-methyl.

Embodiment B72. A mixture comprising a herbicide compound of Formula 1, diflufenzopyr and thifensulfuron-methyl.

Embodiment B73. A mixture comprising a herbicide compound of Formula 1, diflufenzopyr and tribenuron-methyl.

Embodiment B74. A mixture comprising a herbicide compound of Formula 1, rimsulfuron and S-metolachlor.

Embodiment B75. A mixture comprising a herbicide compound of Formula 1 and isoxadifen-ethyl.

Embodiment B76. A mixture comprising a herbicide compound of Formula 1 and naphthalic anhydride.

Embodiment B77. A mixture comprising a herbicide compound of Formula 1 and a mixture of isoxadifen-ethyl and foramsulfuron.

Embodiment B78. A mixture comprising a herbicide compound of Formula 1 and glycerol.

Specific embodiments include a mixture wherein the herbicide compound of Formula 1 and its salts is selected from the group consisting of:
6-amino-5-chloro-2-cyclopropyl-4-pyrimidinecarboxylic acid (Compound 1),
methyl 6-amino-5-chloro-2-cyclopropyl-4-pyrimidinecarboxylate (Compound 2),
ethyl 6-amino-5-chloro-2-cyclopropyl-4-pyrimidinecarboxylate (Compound 3),
6-amino-5-bromo-2-cyclopropyl-4-pyrimidinecarboxylic acid (Compound 4),
methyl 6-amino-5-bromo-2-cyclopropyl-4-pyrimidinecarboxylate (Compound 5),
ethyl 6-amino-5-bromo-2-cyclopropyl-4-pyrimidinecarboxylate (Compound 6),
6-amino-5-chloro-2-(4-chlorophenyl)-4-pyrimidinecarboxylic acid (Compound 7),
methyl 6-amino-5-chloro-2-(4-chlorophenyl)-4-pyrimidinecarboxylate (Compound 8),
ethyl 6-amino-5-chloro-2-(4-chlorophenyl)-4-pyrimidinecarboxylate (Compound 9),
phenylmethyl 6-amino-5-bromo-2-cyclopropyl-4-pyrimidinecarboxylate (Compound 10),
6-amino-5-bromo-2-cyclopropyl-4-pyrimidinecarboxylic acid monosodium salt (Compound 11),
phenylmethyl 6-amino-5-chloro-2-cyclopropyl-4-pyrimidinecarboxylate (Compound 12),
6-amino-5-chloro-2-cyclopropyl-4-pyrimidinecarboxylic acid monosodium salt (Compound 13),
ethyl 6-amino-2-(4-bromophenyl)-5-chloro-4-pyrimidinecarboxylate (Compound 14),
methyl 6-amino-2-(4-bromophenyl)-5-chloro-4-pyrimidinecarboxylate (Compound 15),
6-amino-2-(4-bromophenyl)-5-chloro-4-pyrimidinecarboxylic acid (Compound 16),
1-methylethyl 6-amino-5-chloro-2-cyclopropyl-4-pyrimidinecarboxylate (Compound 17),
butyl 6-amino-5-chloro-2-cyclopropyl-4-pyrimidinecarboxylate (Compound 18),
3-hydroxypropyl 6-amino-5-chloro-2-cyclopropyl-4-pyrimidinecarboxylate (Compound 19),
propyl 6-amino-5-chloro-2-cyclopropyl-4-pyrimidinecarboxylate (Compound 20),
1-methylheptyl 6-amino-5-chloro-2-cyclopropyl-4-pyrimidinecarboxylate (Compound 21),
2-(2-methoxyethoxy)ethyl 6-amino-5-chloro-2-cyclopropyl-4-pyrimidinecarboxylate (Compound 22),
octyl 6-amino-5-chloro-2-cyclopropyl-4-pyrimidinecarboxylate (Compound 23),
2-butoxyethyl 6-amino-5-chloro-2-cyclopropyl-4-pyrimidinecarboxylate (Compound 24),
2-ethylhexyl 6-amino-5-chloro-2-cyclopropyl-4-pyrimidinecarboxylate (Compound 25), and
2-butoxy-1-methylethyl 6-amino-5-chloro-2-cyclopropyl-4-pyrimidinecarboxylate (Compound 26).

Of specific note are herbicidal mixtures comprising at least one of the compounds of Formula 1 listed immediately above and at least one compound (b) of Embodiments B1 through B78.

Further specific embodiments include a mixture wherein the herbicide compound of Formula 1 is selected from the group consisting of:
6-amino-5-chloro-2-cyclopropyl-4-pyrimidinecarboxylic acid (Compound 1), and
methyl 6-amino-5-chloro-2-cyclopropyl-4-pyrimidinecarboxylate (Compound 2).

Of specific note are herbicidal mixtures comprising at least one of the compounds of Formula 1 listed immediately above and at least one compound (b) of Embodiments B1 through B78.

This invention also relates to a method for controlling undesired vegetation comprising applying to the locus of the vegetation herbicidally effective amounts of the mixtures of the invention (e.g., as a composition described herein). Of note as embodiments relating to methods of use are those involving the mixtures of embodiments described above.

This invention also relates to a method for selectively controlling the growth of undesired vegetation in the environment of a crop plant comprising contacting the crop plant or seed with a phytotoxicity-reducing effective amount of a mixture of compound of Formula 1 and at least one compound selected from the group consisting of (b1) through (b12) wherein the crop plant is safened.

This invention further relates to a method for selectively controlling the growth of undesired vegetation in the environment of a crop plant comprising contacting the crop plant or seed from which the crop plant is grown with a phytotoxicity-reducing effective amount of at least one compound selected from the group consisting of (b1) through (b12), and contacting the undesired vegetation or the environment of the crop plant with a herbicidally effective amount (sufficient to elicit phytotoxicity in the crop plant in the absence of the herbicide safener) of a compound of Formula 1 wherein the crop plant is safened.

More particularly, the above mentioned safening methods include methods wherein compounds of Formula 1 include:
6-amino-5-chloro-2-cyclopropyl-4-pyrimidinecarboxylic acid,
methyl 6-amino-5-chloro-2-cyclopropyl-4-pyrimidinecarboxylate,
ethyl 6-amino-5-chloro-2-cyclopropyl-4-pyrimidinecarboxylate,
6-amino-5-bromo-2-cyclopropyl-4-pyrimidinecarboxylic acid,
methyl 6-amino-5-bromo-2-cyclopropyl-4-pyrimidinecarboxylate,
ethyl 6-amino-5-bromo-2-cyclopropyl-4-pyrimidinecarboxylate,
6-amino-5-chloro-2-(4-chlorophenyl)-4-pyrimidinecarboxylic acid,
methyl 6-amino-5-chloro-2-(4-chlorophenyl)-4-pyrimidinecarboxylate,
ethyl 6-amino-5-chloro-2-(4-chlorophenyl)-4-pyrimidinecarboxylate,
phenylmethyl 6-amino-5-bromo-2-cyclopropyl-4-pyrimidinecarboxylate,
6-amino-5-bromo-2-cyclopropyl-4-pyrimidinecarboxylic acid monosodium salt,
phenylmethyl 6-amino-5-chloro-2-cyclopropyl-4-pyrimidinecarboxylate,
6-amino-5-chloro-2-cyclopropyl-4-pyrimidinecarboxylic acid monosodium salt,
ethyl 6-amino-2-(4-bromophenyl)-5-chloro-4-pyrimidinecarboxylate,
methyl 6-amino-2-(4-bromophenyl)-5-chloro-4-pyrimidinecarboxylate,
6-amino-2-(4-bromophenyl)-5-chloro-4-pyrimidinecarboxylic acid,
1-methylethyl 6-amino-5-chloro-2-cyclopropyl-4-pyrimidinecarboxylate,
butyl 6-amino-5-chloro-2-cyclopropyl-4-pyrimidinecarboxylate,
3-hydroxypropyl 6-amino-5-chloro-2-cyclopropyl-4-pyrimidinecarboxylate,
propyl 6-amino-5-chloro-2-cyclopropyl-4-pyrimidinecarboxylate,
1-methylheptyl 6-amino-5-chloro-2-cyclopropyl-4-pyrimidinecarboxylate,
2-(2-methoxyethoxy)ethyl 6-amino-5-chloro-2-cyclopropyl-4-pyrimidinecarboxylate,
octyl 6-amino-5-chloro-2-cyclopropyl-4-pyrimidinecarboxylate,
2-butoxyethyl 6-amino-5-chloro-2-cyclopropyl-4-pyrimidinecarboxylate,
2-ethylhexyl 6-amino-5-chloro-2-cyclopropyl-4-pyrimidinecarboxylate, and
2-butoxy-1-methylethyl 6-amino-5-chloro-2-cyclopropyl-4-pyrimidinecarboxylate, or
6-amino-5-chloro-2-cyclopropyl-4-pyrimidinecarboxylic acid, and
methyl 6-amino-5-chloro-2-cyclopropyl-4-pyrimidinecarboxylate,
   and wherein at least one compound (b) selected from the group consisting of (b2), (b3), (b8), (b9), (b10) and (b12).

This invention even further relates to a method for selectively controlling the growth of undesired vegetation in the environment of a crop plant comprising contacting the crop plant or seed from which the crop plant is grown with a phytotoxicity-reducing effective amount of a herbicide safener (b12), and subsequently contacting the undesired vegetation or the environment of the crop plant with a herbicidally effective amount (sufficient to elicit phytotoxicity in the crop plant in the absence of the herbicide safener) of a compound of Formula 1 wherein the crop plant is safened.

Mixtures of the invention are particularly useful for selective control of weeds or safening of crops. These mixtures are particularly useful for selective control of weeds in corn (maize), wheat, barley, pasture, rangeland, rice, sorghum, sugarcane and plantation crops, and also for total vegetation management. Mixtures of the invention are also useful for safening of crops, particularly grass crops. Such grass crops include corn (maize), wheat, barley, pasture, rangeland, rice, sorghum and sugarcane. Of particular note is safening of crops such as corn (maize), wheat, barley, rice, sorghum and sugarcane. Of even further note is safening of crops such as corn (maize), wheat, barley, rice and sorghum.

Compounds of Formula 1 can be prepared by one or more of the methods and variations thereof as described in PCT Patent Publication WO 2005/063721, which is hereby incorporated by reference in its entirety. For example, compounds 1, 2, 5, 6, 7 and 9 as identified in Table A can be prepared by the method described in Example 2 (page 29), Example 3 (page 31), Example 1 (page 27), Example 1 (page 27), Example 4 (page 32), and Example 5 (page 33) of WO 2005/063721 respectively.

By the procedures described in pages 22-33 of PCT Patent Publication WO 2005/063721 together with methods known in the art, the following compounds in Tables A and B, which exemplify compounds of Formula 1 (including N-oxides and salts) in the present mixtures, can be prepared. The following abbreviations are used in the Tables which follow: t means tertiary, i means iso, Me means methyl, Et means ethyl, Pr means propyl, i-Pr means isopropyl, Bu means butyl, t-Bu means tent-butyl, “,” means negative formal charge, and “+” means positive formal charge. The compound numbers of Tables A and B refer to compounds listed as Specific Embodiments in the Details of the Invention.

TABLE A

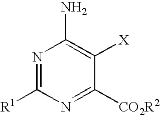

| Compd | | | |
|---|---|---|---|
| No. | R¹ | R² | X |
| 1 | cyclopropyl | H | Cl |
| 2 | cyclopropyl | Me | Cl |
| 3 | cyclopropyl | Et | Cl |
| 20 | cyclopropyl | Pr | Cl |
| 17 | cyclopropyl | i-Pr | Cl |
| | cyclopropyl | t-Bu | Cl |
| 12 | cyclopropyl | CH₂Ph | Cl |
| 18 | cyclopropyl | Bu | Cl |
| 19 | cyclopropyl | (HO)CH₂CH₂CH₂ | Cl |
| 21 | cyclopropyl | CH₃(CH₂)₅CHMe | Cl |
| 22 | cyclopropyl | CH₃O(CH₂)₂OCH₂CH₂ | Cl |
| 23 | cyclopropyl | CH₃(CH₂)₆CH₂ | Cl |
| 24 | cyclopropyl | CH₃(CH₂)₃OCH₂CH₂ | Cl |
| 25 | cyclopropyl | CH₃(CH₂)₃CH(Et)CH₂ | Cl |
| 26 | cyclopropyl | CH₃(CH₂)₃OCH₂CHMe | Cl |
| 4 | cyclopropyl | H | Br |
| 5 | cyclopropyl | Me | Br |
| 6 | cyclopropyl | Et | Br |
| | cyclopropyl | Pr | Br |
| | 4-Cl-Ph | (HO)CH₂CH₂CH₂ | Cl |
| | 4-Cl-Ph | CH₃(CH₂)₅CHMe | Cl |
| | 4-Cl-Ph | CH₃O(CH₂)₂OCH₂CH₂ | Cl |
| | 4-Cl-Ph | CH₃(CH₂)₆CH₂ | Cl |
| | 4-Cl-Ph | CH₃(CH₂)₃OCH₂CH₂ | Cl |
| | 4-Cl-Ph | CH₃(CH₂)₃CH(Et)CH₂ | Cl |
| | 4-Cl-Ph | CH₃(CH₂)₃OCH₂CHMe | Cl |
| | 4-Cl-Ph | H | Br |
| | 4-Cl-Ph | Me | Br |
| | 4-Cl-Ph | Et | Br |
| | 4-Cl-Ph | Pr | Br |
| | 4-Cl-Ph | i-Pr | Br |
| | 4-Cl-Ph | t-Bu | Br |
| | 4-Cl-Ph | CH₂Ph | Br |
| | 4-Cl-Ph | Bu | Br |
| | 4-Cl-Ph | (HO)CH₂CH₂CH₂ | Br |
| | 4-Cl-Ph | CH₃(CH₂)₅CHMe | Br |
| | 4-Cl-Ph | CH₃O(CH₂)₂OCH₂CH₂ | Br |
| | 4-Cl-Ph | CH₃(CH₂)₆CH2 | Br |
| | 4-Cl-Ph | CH₃(CH₂)₃OCH₂CH₂ | Br |
| | 4-Cl-Ph | CH₃(CH₂)₃CH(Et)CH₂ | Br |
| | 4-Cl-Ph | CH₃(CH₂)₃OCH₂CHMe | Br |
| 16 | 4-Br-Ph | H | Cl |
| 15 | 4-Br-Ph | Me | Cl |
| 14 | 4-Br-Ph | Et | Cl |
| | 4-Br-Ph | Pr | Cl |
| | cyclopropyl | i-Pr | Br |
| | cyclopropyl | t-Bu | Br |
| 10 | cyclopropyl | CH₂Ph | Br |
| | cyclopropyl | Bu | Br |
| | cyclopropyl | (HO)CH₂CH₂CH₂ | Br |
| | cyclopropyl | CH₃(CH₂)₅CHMe | Br |
| | cyclopropyl | CH₃O(CH₂)₂OCH₂CH₂ | Br |
| | cyclopropyl | CH₃(CH₂)₆CH₂ | Br |
| | cyclopropyl | CH₃(CH₂)₃OCH₂CH₂ | Br |
| | cyclopropyl | CH₃(CH₂)₃CH(Et)CH₂ | Br |
| | cyclopropyl | CH₃(CH₂)₃OCH₂CHMe | Br |
| 7 | 4-Cl-Ph | H | Cl |
| 8 | 4-Cl-Ph | Me | Cl |
| 9 | 4-Cl-Ph | Et | Cl |
| | 4-Cl-Ph | Pr | Cl |
| | 4-Cl-Ph | i-Pr | Cl |
| | 4-Cl-Ph | t-Bu | Cl |
| | 4-Cl-Ph | CH₂Ph | Cl |
| | 4-Cl-Ph | Bu | Cl |
| | 4-Br-Ph | i-Pr | Cl |
| | 4-Br-Ph | t-Bu | Cl |
| | 4-Br-Ph | CH₂Ph | Cl |
| | 4-Br-Ph | Bu | Cl |
| | 4-Br-Ph | (HO)CH₂CH₂CH₂ | Cl |
| | 4-Br-Ph | CH₃(CH₂)₅CHMe | Cl |
| | 4-Br-Ph | CH₃O(CH₂)₂OCH₂CH₂ | Cl |
| | 4-Br-Ph | CH₃(CH₂)₆CH₂ | Cl |
| | 4-Br-Ph | CH₃(CH₂)₃OCH₂CH₂ | Cl |
| | 4-Br-Ph | CH₃(CH₂)₃CH(Et)CH₂ | Cl |
| | 4-Br-Ph | CH₃(CH₂)₃OCH₂CHMe | Cl |
| | 4-Br-Ph | H | Br |
| | 4-Br-Ph | Me | Br |
| | 4-Br-Ph | Et | Br |
| | 4-Br-Ph | Pr | Br |
| | 4-Br-Ph | i-Pr | Br |
| | 4-Br-Ph | t-Bu | Br |
| | 4-Br-Ph | CH₂Ph | Br |
| | 4-Br-Ph | Bu | Br |
| | 4-Br-Ph | (HO)CH₂CH₂CH₂ | Br |
| | 4-Br-Ph | CH₃(CH₂)₅CHMe | Br |
| | 4-Br-Ph | CH₃O(CH₂)₂OCH₂CH₂ | Br |
| | 4-Br-Ph | CH₃(CH₂)₆CH₂ | Br |
| | 4-Br-Ph | CH₃(CH₂)₃OCH₂CH₂ | Br |
| | 4-Br-Ph | CH₃(CH₂)₃CH(Et)CH₂ | Br |
| | 4-Br-Ph | CH₃(CH₂)₃OCH₂CHMe | Br |

TABLE B

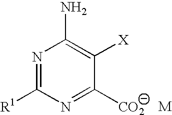

| Compd | | | |
|---|---|---|---|
| No. | R¹ | M | X |
| | cyclopropyl | H₃N⁺Me | Cl |
| | cyclopropyl | H₃N⁺i-Pr | Cl |
| | cyclopropyl | HN⁺(Et)₃ | Cl |
| | cyclopropyl | N⁺(Me)₄ | Cl |
| 13 | cyclopropyl | Na⁺ | Cl |
| | cyclopropyl | H₃N⁺Me | Br |
| | cyclopropyl | H₃N⁺i-Pr | Br |
| | cyclopropyl | HN⁺(Et)₃ | Br |
| | cyclopropyl | N⁺(Me)₄ | Br |
| 11 | cyclopropyl | Na⁺ | Br |
| | 4-Cl-Ph | H₃N⁺Me | Cl |
| | 4-Cl-Ph | H₃N⁺i-Pr | Cl |
| | 4-Cl-Ph | HN⁺(Et)₃ | Cl |
| | 4-Cl-Ph | N⁺⁽Me)₄ | Cl |
| | 4-Cl-Ph | Na⁺ | Cl |
| | 4-Cl-Ph | H₃N⁺Me | Br |
| | 4-Cl-Ph | H₃N⁺i-Pr | Br |
| | 4-Cl-Ph | HN⁺(Et)₃ | Br |
| | 4-Cl-Ph | N⁺(Me)₄ | Br |
| | 4-Cl-Ph | Na⁺ | Br |
| | 4-Br-Ph | H₃N⁺Me | Cl |
| | 4-Br-Ph | H₃N⁺i-Pr | Cl |
| | 4-Br-Ph | HN⁺(Et)₃ | Cl |
| | 4-Br-Ph | N⁺(Me)₄ | Cl |
| | 4-Br-Ph | Na⁺ | Cl |
| | 4-Br-Ph | H₃N⁺Me | Br |
| | 4-Br-Ph | H₃N⁺i-Pr | Br |
| | 4-Br-Ph | HN⁺(Et)₃ | Br |
| | 4-Br-Ph | N⁺(Me)₄ | Br |
| | 4-Br-Ph | Na⁺ | Br |

### Formulation/Utility

Mixtures of this invention will generally be used as a formulation or composition with an agriculturally suitable carrier comprising at least one of a humectant, a liquid diluent, a solid diluent or a surfactant. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films (including seed coatings), and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders. | | | |
| Suspensions, Emulsions, | 1-50 | 40-99 | 0-50 |
| Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, glycerol esters, poly-oxyethylene/polyoxypropylene block copolymers, and alkylpolyglycosides where the number of glucose units, referred to as degree of polymerization (D.P.), can range from 1 to 3 and the alkyl units can range from C₆ to C₁₄ (see Pure and Applied Chemistry 72, 1255-1264). Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, glycerine, triacetine, oils of olive, castor, linseed, tung, sesame, corn (maize), peanut, cotton-seed, soybean, rape-seed and coconut, fatty acid esters, ketones such as cyclohexanone, 2-heptanone, isophorone and 4-hydroxy-4-methyl-2-pentanone, acetates such as hexyl acetate, heptyl acetate and octyl acetate, and alcohols such as methanol, cyclohexanol, decanol, benzyl and tetrahydrofurfuryl alcohol.

Formulations of this invention may include humectants. The humectant increases the residency time of the mixture on the foliage of the plants. Examples of humectants include but are not limited to glycerol, propylene glycol and glyceryl triacetate.

Useful formulations of this invention may also contain materials well known to those skilled in the art as formulation aids such as antifoams, film formers and dyes. Antifoams can include water dispersible liquids comprising polyorganosiloxanes like Rhodorsil® 416. The film formers can include polyvinyl acetates, polyvinyl acetate copolymers, polyvinylpyrrolidone-vinyl acetate copolymer, polyvinyl alcohols, polyvinyl alcohol copolymers and waxes. Dyes can include water dispersible liquid colorant compositions like Pro-lzed® Colorant Red. One skilled in the art will appreciate that this is a non-exhaustive list of formulation aids. Suitable examples of formulation aids include those listed herein and those listed in McCutcheon's 2001, Volume 2: Functional Materials published by MC Publishing Company and PCT Publication WO 03/024222.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound numbers refer to compounds in Tables A and B. While specific compounds are exemplified in the formulation Examples below, the ordinarily skilled artisan recognizes that all compounds of the invention would be amenable to substantially similar formulations.

### Example A

High Strength Concentrate

| | |
|---|---|
| Compound 2 and atrazine | 98.5% |
| silica aerogel | 0.5% |
| synthetic amorphous fine silica | 1.0%. |

### Example B

Wettable Powder

| | |
|---|---|
| Compound 2 and nicosulfuron | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### Example C

Granule

| | |
|---|---|
| Compound 2 and atrazine | 10.0% |
| attapulgite granules (low volatile matter, | 90.0%. |
| 0.71/0.30 mm; U.S.S. No. 25-50 sieves) | |

### Example D

Aqueous Suspension

| | |
|---|---|
| Compound 2 and glyphosate | 25.0% |
| hydrated attapulgite | 3.0% |
| crude calcium ligninsulfonate | 10.0% |
| sodium dihydrogen phosphate | 0.5% |
| water | 61.5%. |

### Example E

Extruded Pellet

| | |
|---|---|
| Compound 1 and atrazine | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### Example F

Microemulsion

| | |
|---|---|
| Compound 6 and S-metolachlor | 1.0% |
| triacetine | 30.0% |
| C₈—C₁₀ alkylpolyglycoside | 30.0% |
| glyceryl monooleate | 19.0% |
| water | 20.0%. |

Test results indicate that the mixtures of the present invention are highly active preemergent and/or postemergent herbicides and/or plant growth regulants. Many of them have utility for broad-spectrum pre- and/or postemergence weed control in areas where complete control of all vegetation is desired such as around fuel storage tanks, industrial storage areas, parking lots, drive-in theaters, air fields, river banks, irrigation and other waterways, around billboards and highway and railroad structures. Many of the mixtures of this invention, by virtue of selective metabolism in crops versus weeds, or by selective activity at the locus of physiological inhibition in crops and weeds, or by selective placement on or within the environment of a mixture of crops and weeds, are useful for the selective control of grass and broadleaf weeds within a crop/weed mixture. One skilled in the art will recognize that the preferred combination of these selectivity factors within mixtures can readily be determined by performing routine biological and/or biochemical assays. Mixtures of this invention may show tolerance to important agronomic crops including, but not limited to, alfalfa, barley, cotton, wheat, rape, sugar beets, corn (maize), sorghum, soybeans, rice, oats, peanuts, vegetables, tomato, potato, perennial plantation crops including coffee, cocoa, oil palm, rubber, sugarcane, citrus, grapes, fruit trees, nut trees, banana, plantain, pineapple, hops, tea and forests such as eucalyptus and conifers (e.g., loblolly pine), and turf species (e.g., Kentucky bluegrass, St. Augustine grass, Kentucky fescue and Bermuda grass). Mixtures of this invention can be used in crops genetically transformed or bred to incorporate resistance to herbicides, express proteins toxic to invertebrate pests (such as Bacillus thuringiensis toxin), and/or express other useful traits. Those skilled in the art will appreciate that not all mixtures are equally effective against all weeds. Alternatively, the subject mixtures are useful to modify plant growth.

As the mixtures of the invention have preemergent and/or postemergent herbicidal activity, to control undesired vegetation by killing or injuring the vegetation or reducing its growth, the mixtures can be usefully applied by a variety of methods involving contacting a herbicidally effective amount of a mixture of the invention, or a composition comprising said mixture and at least one of a surfactant, a solid diluent or a liquid diluent, to the foliage or other part of the undesired vegetation or to the environment of the undesired vegetation such as the soil or water in which the undesired vegetation is growing or which surrounds the seed or other propagule of the undesired vegetation.

Acetyl-coenzyme A carboxylase (ACCase) inhibitors (b1) include compounds such as clodinafop, cyhalofop, diclofop, fenoxaprop, fluazifop, haloxyfop, propaquizafop, quizalofop, alloxydim, butroxydim, clethodim, cycloxydim, profoxydim, sethoxydim, tepraloxydim and tralkoxydim, including resolved forms such as fenoxaprop-P, fluazifop-P, haloxyfop-P and quizalofop-P and ester forms such as clodinafop-propargyl, cyhalofop-butyl, diclofop-methyl and fenoxaprop-P-ethyl.

Acetohydroxy acid synthase (AHAS) inhibitors (b2) include compounds such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl (including sodium salt), foramsulfuron, halosulfuron-methyl, imazosulfuron, iodosulfuron-methyl (including sodium salt), mesosulfuron-methyl, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron (including sodium salt), triflusulfuron-methyl, tritosulfuron, imazapic, imazamethabenz-methyl, imazamox, imazapyr, imazaquin, imazethapyr, cloransulam-methyl, diclosulam, florasulam, flumetsulam, metosulam, penoxsulam, bispyribac-sodium, pyribenzoxim, pyriftalid, pyrithiobac-sodium, pyriminobac-methyl, flucarbazone-sodium and propoxycarbazone-sodium.

Photosystem II inhibitors (b3) include compounds such as ametryn, atrazine, cyanazine, desmetryne, dimethametryn, prometon, prometryne, propazine, simazine, simetryn, terbumeton, terbuthylazine, terbutryne, trietazine, hexazinone, metamitron, metribuzin, amicarbazone, bromacil, lenacil, terbacil, chloridazon, desmedipham, phenmedipham, chlorobromuron, chlorotoluron, chloroxuron, dimefuron, diuron, ethidimuron, fenuron, fluometuron, isoproturon, isouron, linuron, methabenzthiazuron, metobromuron, metoxuron, monolinuron, neburon, siduron, tebuthiuron, propanil, pentanochlor, bromofenoxim, bromoxynil, ioxynil, bentazon, pyridate and pyridafol.

Photosystem I electron diverters (b4) include compounds such as diquat and paraquat.

Protoporphyrinogen oxidase (PPO) inhibitors (b5) include compounds such as acifluorfen-sodium, bifenox, chlomethoxyfen, fluoroglycofen-ethyl, fomesafen, halosafen, lactofen, oxyfluorfen, fluazolate, pyraflufen-ethyl, cinidon-ethyl, flumioxazin, flumiclorac-pentyl, fluthiacet-methyl, thidiazimin, oxadiazon, oxadiargyl, azafenidin, carfentrazone-ethyl, sulfentrazone, pentoxazone, benzfendizone, butafenacil, pyraclonil, profluazol and flufenpyr-ethyl.

5-Enol-pyruvylshikimate-3-phosphate (EPSP) synthase inhibitors (b6) include compounds such as glyphosate and sulfosate.

Glutamine synthetase (GS) inhibitors (b7) include compounds such as glufosinate, glufosinate-ammonium and bilanaphos.

Very long chain fatty acid (VLCFA) elongase inhibitors (b8) include compounds such as acetochlor, alachlor, butachlor, dimethachlor, dimethanamid, metazachlor, metolachlor, pethoxamid, pretilachlor, propachlor, propisochlor, thenylchlor, diphenamid, napropamide, naproanilide, flufenacet, indanofan, mefenacet, fentrazamide, anilofos, cafenstrole and piperophos, including resolved forms such as S-metolachlor.

Auxin mimics (b9) include compounds such as clomeprop, 2,4-D, 2,4-DB, dichlorprop, MCPA, MCPB, mecoprop, chloramben, dicamba, TBA, clopyralid, fluroxypyr, picloram, triclopyr, quinclorac, quinmerac and benazolin-ethyl.

Auxin transport inhibitors (b 10) include compounds such as naptalam and diflufenzopyr.

Other herbicides selected from the group consisting of (b11) include flamprop-M-methyl, flamprop-M-isopropyl, difenzoquat, DSMA, MSMA, bromobutide, flurenol, cinmethylin, cumyluron, dazomet, dymron, methyldymron, etobenzanid, fosamine-ammonium, isoxaflutole, asulam, clomazone, mesotrione, metam, oxaziclomefone, oleic acid, pelargonic acid and pyributicarb.

Herbicide safeners selected from the group consisting of (b12) include benoxacor, 1-bromo-4-[(chloromethyl)sulfonyl]benzene, cloquintocet-mexyl, cyometrinil, dichlormid, 2-(dichloromethyl)-2-methyl-1,3 -dioxolane, fenchlorazole-ethyl, fenclorim, flurazole, fluxofenim, furilazole, isoxadifen-ethyl, mefenpyr-diethyl, methoxyphenone, naphthalic anhydride and oxabetrinil.

A herbicidally effective amount of the mixtures of this invention is determined by a number of factors. These factors include: formulation selected, method of application, amount and type of vegetation present, growing conditions, etc. In general, a herbicidally effective amount of mixtures of this invention is about 0.001 to 50 kg/ha with a preferred range of about 0.001 to 20 kg/ha, and more preferred range of about 0.004 to 7 kg/ha. One skilled in the art can easily determine the herbicidally effective amount necessary for the desired level of weed control.

The weight ratios of these various mixing partners to the compounds of Formula 1 of this invention typically are between 20,000:1 and 1:500, preferably between 600:1 and 1:500, more preferably between 125:1 and 1:200, and most preferably between 75:1 and 1:125.

Specifically preferred mixtures (compound numbers refer to compounds in Tables A and B) are selected from the group: compound 4 and 2,4-D; compound 5 and 2,4-D; compound 6 and 2,4-D; compound 10 and 2,4-D; compound 11 and 2,4-D; compound 12 and 2,4-D; compound 13 and 2,4-D; compound 17 and 2,4-D; compound 18 and 2,4-D; compound 19 and 2,4-D; compound 20 and 2,4-D; compound 21 and 2,4-D; compound 22 and 2,4-D; compound 23 and 2,4-D; compound 24 and 2,4-D; compound 25 and 2,4-D; compound 26 and 2,4-D; compound 4 and 2,4-D; compound 5 and 2,4-D; compound 6 and 2,4-D; compound 10 and 2,4-D; compound 11 and 2,4-D; compound 12 and 2,4-D; compound 13 and 2,4-D; compound 17 and 2,4-D; compound 18 and 2,4-D; compound 19 and 2,4-D; compound 20 and 2,4-D; compound 21 and 2,4-D; compound 22 and 2,4-D; compound 23 and 2,4-D; compound 24 and 2,4-D; compound 25 and 2,4-D; compound 26 and 2,4-D; compound 4 and alachlor; compound 5 and alachlor; compound 6 and alachlor; compound 10 and alachlor; compound 11 and alachlor; compound 12 and alachlor; compound 13 and alachlor; compound 17 and alachlor; compound 18 and alachlor; compound 19 and alachlor; compound 20 and alachlor; compound 21 and alachlor; compound 22 and alachlor; compound 23 and alachlor; compound 24 and alachlor; compound 25 and alachlor; compound 26 and alachlor; compound 4 and ametryn; compound 5 and ametryn; compound 6 and ametryn; compound 10 and ametryn; compound 11 and ametryn; compound 12 and ametryn; compound 13 and ametryn; compound 17 and ametryn; compound 18 and ametryn; compound 19 and ametryn; compound 20 and ametryn; compound 21 and ametryn; compound 22 and ametryn; compound 23 and ametryn; compound 24 and ametryn; compound 25 and ametryn; compound 26 and ametryn; compound 4 and amicarbazone; compound 5 and amicarbazone; compound 6 and amicarbazone; compound 10 and amicarbazone; compound 11 and amicarbazone; compound 12 and amicarbazone; compound 13 and amicarbazone; compound 17 and amicarbazone; compound 18 and amicarbazone; compound 19 and amicarbazone; compound 20 and amicarbazone; compound 21 and amicarbazone; compound 22 and amicarbazone; compound 23 and amicarbazone; compound 24 and amicarbazone; compound 25 and amicarbazone; compound 26 and amicarbazone; compound 4 and aminopyralid; compound 5 and aminopyralid; compound 6 and aminopyralid; compound 10 and aminopyralid; compound 11 and aminopyralid; compound 12 and aminopyralid; compound 13 and aminopyralid; compound 17 and aminopyralid; compound 18 and aminopyralid; compound 19 and aminopyralid; compound 20 and aminopyralid; compound 21 and aminopyralid; compound 22 and aminopyralid; compound 23 and aminopyralid; compound 24 and aminopyralid; compound 25 and aminopyralid; compound 26 and aminopyralid; compound 4 and atrazine; compound 5 and atrazine; compound 6 and atrazine; compound 10 and atrazine; compound 11 and atrazine; compound 12 and atrazine; compound 13 and atrazine; compound 17 and atrazine; compound 18 and atrazine; compound 19 and atrazine; compound 20 and atrazine; compound 21 and atrazine; compound 22 and atrazine; compound 23 and atrazine; compound 24 and atrazine; compound 25 and atrazine; compound 26 and atrazine; compound 4 and bentazon; compound 5 and bentazon; compound 6 and bentazon; compound 10 and bentazon; compound 11 and bentazon; compound 12 and bentazon; compound 13 and bentazon; compound 17 and bentazon; compound 18 and bentazon; compound 19 and bentazon; compound 20 and bentazon; compound 21 and bentazon; compound 22 and bentazon; compound 23 and bentazon; compound 24 and bentazon; compound 25 and bentazon; compound 26 and bentazon; compound 4 and bromacil; compound 5 and bromacil; compound 6 and bromacil; compound 10 and bromacil; compound 11 and bromacil; compound 12 and bromacil; compound 13 and bromacil; compound 17 and bromacil; compound 18 and bromacil; compound 19 and bromacil; compound 20 and bromacil; compound 21 and bromacil; compound 22 and bromacil; compound 23 and bromacil; compound 24 and bromacil; compound 25 and bromacil; compound 26 and bromacil; compound 4 and bromoxynil; compound 5 and bromoxynil; compound 6 and bromoxynil; compound 10 and bromoxynil; compound 11 and bromoxynil; compound 12 and bromoxynil; compound 13 and bromoxynil; compound 17 and bromoxynil; compound 18 and bromoxynil; compound 19 and bromoxynil; compound 20 and bromoxynil; compound 21 and bromoxynil; compound 22 and bromoxynil; compound 23 and bromoxynil; compound 24 and bromoxynil; compound 25 and bromoxynil; compound 26 and bromoxynil; compound 4 and carfentrazone; compound 5 and carfentrazone; compound 6 and carfentrazone; compound 10 and carfentrazone; compound 11 and carfentrazone; compound 12 and carfentrazone; compound 13 and carfentrazone; compound 17 and carfentrazone; compound 18 and carfentrazone; compound 19 and carfentrazone; compound 20 and carfentrazone; compound 21 and carfentrazone; compound 22 and carfentrazone; compound 23 and carfentrazone; compound 24 and carfentrazone; compound 25 and carfentrazone; compound 26 and carfentrazone; compound 4 and clodinafop; compound 5 and clodinafop; compound 6 and clodinafop; compound 10 and clodinafop; compound 11 and clodinafop; compound 12 and clodinafop; compound 13 and clodinafop; compound 17 and clodinafop; compound 18 and clodinafop; compound 19 and clodinafop; compound 20 and clodinafop; compound 21 and clodinafop; compound 22 and clodinafop; compound 23 and clodinafop; compound 24 and clodinafop; compound 25 and clodinafop; compound 26 and clodinafop; compound 4 and clopyralid; compound 5 and clopyralid; compound 6 and clopyralid; compound 10 and clopyralid; compound 11 and clopyralid; compound 12 and clopyralid; compound 13 and clopyralid; compound 17 and clopyralid; compound 18 and clopyralid; compound 19 and clopyralid; compound 20 and clopyralid; compound 21 and clopyralid; compound 22 and clopyralid; compound 23 and clopyralid; compound 24 and clopyralid; compound 25 and clopyralid; compound 26 and clopyralid; compound 4 and dicamba; compound 5 and dicamba; compound 6 and dicamba; compound 10 and dicamba; compound 11 and dicamba; compound 12 and dicamba; compound 13 and dicamba; compound 17 and dicamba; compound 18 and dicamba; compound 19 and dicamba; compound 20 and dicamba; compound 21 and dicamba; compound 22 and dicamba; compound 23 and dicamba; compound 24 and dicamba; compound 25 and dicamba; compound 26 and dicamba; compound 4 and diflufenzopyr; compound 5 and diflufenzopyr; compound 6 and diflufenzopyr; compound 10 and diflufenzopyr; compound 11 and diflufenzopyr; compound 12 and diflufenzopyr; compound 13 and diflufenzopyr; compound 17 and diflufenzopyr; compound 18 and diflufenzopyr; compound 19 and diflufenzopyr; compound 20 and diflufenzopyr; compound 21 and diflufenzopyr; compound 22 and diflufenzopyr; compound 23 and diflufenzopyr; compound 24 and diflufenzopyr; compound 25 and diflufenzopyr; compound 26 and diflufenzopyr; compound 4 and diuron; compound 5 and diuron; compound 6 and diuron; compound 10 and diuron; compound 11 and diuron; compound 12 and diuron; compound 13 and diuron; compound 17 and diuron; compound 18 and diuron; compound 19 and diuron; compound 20 and diuron; compound 21 and diuron; compound 22 and diuron; compound 23 and diuron; compound 24 and diuron; compound 25 and diuron; compound 26 and diuron; compound 4 and fenoxaprop; compound 5 and fenoxaprop; compound 6 and fenoxaprop; compound 10 and fenoxaprop; compound 11 and fenoxaprop; compound 12 and fenoxaprop; compound 13 and fenoxaprop; compound 17 and fenoxaprop; compound 18 and fenoxaprop; compound 19 and fenoxaprop; compound 20 and fenoxaprop; compound 21 and fenoxaprop; compound 22 and fenoxaprop; compound 23 and fenoxaprop; compound 24 and fenoxaprop; compound 25 and fenoxaprop; compound 26 and fenoxaprop; compound 4 and flufenacet; compound 5 and flufenacet; compound 6 and flufenacet; compound 10 and flufenacet; compound 11 and flufenacet; compound 12 and flufenacet; compound 13 and flufenacet; compound 17 and flufenacet; compound 18 and flufenacet; compound 19 and flufenacet; compound 20 and flufenacet; compound 21 and flufenacet; compound 22 and flufenacet; compound 23 and flufenacet; compound 24 and flufenacet; compound 25 and flufenacet; compound 26 and flufenacet; compound 4 and fluroxypyr; compound 5 and fluroxypyr; compound 6 and fluroxypyr; compound 10 and fluroxypyr; compound 11 and fluroxypyr; compound 12 and fluroxypyr; compound 13 and fluroxypyr; compound 17 and fluroxypyr; compound 18 and fluroxypyr; compound 19 and fluroxypyr; compound 20 and fluroxypyr; compound 21 and fluroxypyr; compound 22 and fluroxypyr; compound 23 and fluroxypyr; compound 24 and fluroxypyr; compound 25 and fluroxypyr; compound 26 and fluroxypyr; compound 4 and fosamine-ammonium; compound 5 and fosamine-ammonium; compound 6 and fosamine-ammonium; compound 10 and fosamine-ammonium; compound 11 and fosamine-ammonium; compound 12 and fosamine-ammonium; compound 13 and fosamine-ammonium; compound 17 and fosamine-ammonium; compound 18 and fosamine-ammonium; compound 19 and fosamine-ammonium; compound 20 and fosamine-ammonium; compound 21 and fosamine-ammonium; compound 22 and fosamine-ammonium; compound 23 and fosamine-ammonium; compound 24 and fosamine-ammonium; compound 25 and fosamine-ammonium; compound 26 and fosamine-ammonium; compound 4 and glufosinate-ammonium; compound 5 and glufosinate-ammonium; compound 6 and glufosinate-ammonium; compound 10 and glufosinate-ammonium; compound 11 and glufosinate-ammonium; compound 12 and glufosinate-ammonium; compound 13 and glufosinate-ammonium; compound 17 and glufosinate-ammonium; compound 18 and glufosinate-ammonium; compound 19 and glufosinate-ammonium; compound 20 and glufosinate-ammonium; compound 21 and glufosinate-ammonium; compound 22 and glufosinate-ammonium; compound 23 and glufosinate-ammonium; compound 24 and glufosinate-ammonium; compound 25 and glufosinate-ammonium; compound 26 and glufosinate-ammonium; compound 4 and glufosinate; compound 5 and glufosinate; compound 6 and glufosinate; compound 10 and glufosinate; compound 11 and glufosinate; compound 12 and glufosinate; compound 13 and glufosinate; compound 17 and glufosinate; compound 18 and glufosinate; compound 19 and glufosinate; compound 20 and glufosinate; compound 21 and glufosinate; compound 22 and glufosinate; compound 23 and glufosinate; compound 24 and glufosinate; compound 25 and glufosinate; compound 26 and glufosinate; compound 4 and glyphosate; compound 5 and glyphosate; compound 6 and glyphosate; compound 10 and glyphosate; compound 11 and glyphosate; compound 12 and glyphosate; compound 13 and glyphosate; compound 17 and glyphosate; compound 18 and glyphosate; compound 19 and glyphosate; compound 20 and glyphosate; compound 21 and glyphosate; compound 22 and glyphosate; compound 23 and glyphosate; compound 24 and glyphosate; compound 25 and glyphosate; compound 26 and glyphosate; compound 4 and hexazinone; compound 5 and hexazinone; compound 6 and hexazinone; compound 10 and hexazinone; compound 11 and hexazinone; compound 12 and hexazinone; compound 13 and hexazinone; compound 17 and hexazinone; compound 18 and hexazinone; compound 19 and hexazinone; compound 20 and hexazinone; compound 21 and hexazinone; compound 22 and hexazinone; compound 23 and hexazinone; compound 24 and hexazinone; compound 25 and hexazinone; compound 26 and hexazinone; compound 4 and isoproturon; compound 5 and isoproturon; compound 6 and isoproturon; compound 10 and isoproturon; compound 11 and isoproturon; compound 12 and isoproturon; compound 13 and isoproturon; compound 17 and isoproturon; compound 18 and isoproturon; compound 19 and isoproturon; compound 20 and isoproturon; compound 21 and isoproturon; compound 22 and isoproturon; compound 23 and isoproturon; compound 24 and isoproturon; compound 25 and isoproturon; compound 26 and isoproturon; compound 4 and MCPA; compound 5 and MCPA; compound 6 and MCPA; compound 10 and MCPA; compound 11 and MCPA; compound 12 and MCPA; compound 13 and MCPA; compound 17 and MCPA; compound 18 and MCPA; compound 19 and MCPA; compound 20 and MCPA; compound 21 and MCPA; compound 22 and MCPA; compound 23 and MCPA; compound 24 and MCPA; compound 25 and MCPA; compound 26 and MCPA; compound 4 and MCPP; compound 5 and MCPP; compound 6 and MCPP; compound 10 and MCPP; compound 11 and MCPP; compound 12 and MCPP; compound 13 and MCPP; compound 17 and MCPP; compound 18 and MCPP; compound 19 and MCPP; compound 20 and MCPP; compound 21 and MCPP; compound 22 and MCPP; compound 23 and MCPP; compound 24 and MCPP; compound 25 and MCPP; compound 26 and MCPP; compound 4 and metribuzin; compound 5 and metribuzin; compound 6 and metribuzin; compound 10 and metribuzin; compound 11 and metribuzin; compound 12 and metribuzin; compound 13 and metribuzin; compound 17 and metribuzin; compound 18 and metribuzin; compound 19 and metribuzin; compound 20 and metribuzin; compound 21 and metribuzin; compound 22 and metribuzin; compound 23 and metribuzin; compound 24 and metribuzin; compound 25 and metribuzin; compound 26 and metribuzin; compound 4 and oxadiazon; compound 5 and oxadiazon; compound 6 and oxadiazon; compound 10 and oxadiazon; compound 11 and oxadiazon; compound 12 and oxadiazon; compound 13 and oxadiazon; compound 17 and oxadiazon; compound 18 and oxadiazon; compound 19 and oxadiazon; compound 20 and oxadiazon; compound 21 and oxadiazon; compound 22 and oxadiazon; compound 23 and oxadiazon; compound 24 and oxadiazon; compound 25 and oxadiazon; compound 26 and oxadiazon; compound 4 and oxyfluorfen; compound 5 and oxyfluorfen; compound 6 and oxyfluorfen; compound 10 and oxyfluorfen; compound 11 and oxyfluorfen; compound 12 and oxyfluorfen; compound 13 and oxyfluorfen; compound 17 and oxyfluorfen; compound 18 and oxyfluorfen; compound 19 and oxyfluorfen; compound 20 and oxyfluorfen; compound 21 and oxyfluorfen; compound 22 and oxyfluorfen; compound 23 and oxyfluorfen; compound 24 and oxyfluorfen; compound 25 and oxyfluorfen; compound 26 and oxyfluorfen; compound 4 and paraquat; compound 5 and paraquat; compound 6 and paraquat; compound 10 and paraquat; compound 11 and paraquat; compound 12 and paraquat; compound 13 and paraquat; compound 17 and paraquat; compound 18 and paraquat; compound 19 and paraquat; compound 20 and paraquat; compound 21 and paraquat; compound 22 and paraquat; compound 23 and paraquat; compound 24 and paraquat; compound 25 and paraquat; compound 26 and paraquat; compound 4 and picloram; compound 5 and picloram; compound 6 and picloram; compound 10 and picloram; compound 11 and picloram; compound 12 and picloram; compound 13 and picloram; compound 17 and picloram; compound 18 and picloram; compound 19 and picloram; compound 20 and picloram; compound 21 and picloram; compound 22 and picloram; compound 23 and picloram; compound 24 and picloram; compound 25 and picloram; compound 26 and picloram; compound 4 and pinoxaden; compound 5 and pinoxaden; compound 6 and pinoxaden; compound 10 and pinoxaden; compound 11 and pinoxaden; compound 12 and pinoxaden; compound 13 and pinoxaden; compound 17 and pinoxaden; compound 18 and pinoxaden; compound 19 and pinoxaden; compound 20 and pinoxaden; compound 21 and pinoxaden; compound 22 and pinoxaden; compound 23 and pinoxaden; compound 24 and pinoxaden; compound 25 and pinoxaden; compound 26 and pinoxaden; compound 4 and quizalofop; compound 5 and quizalofop; compound 6 and quizalofop; compound 10 and quizalofop; compound 11 and quizalofop; compound 12 and quizalofop; compound 13 and quizalofop; compound 17 and quizalofop; compound 18 and quizalofop; compound 19 and quizalofop; compound 20 and quizalofop; compound 21 and quizalofop; compound 22 and quizalofop; compound 23 and quizalofop; compound 24 and quizalofop; compound 25 and quizalofop; compound 26 and quizalofop; compound 4 and S-metolachlor; compound 5 and S-metolachlor; compound 6 and S-metolachlor; compound 10 and S-metolachlor; compound 11 and S-metolachlor; compound 12 and S-metolachlor; compound 13 and S-metolachlor; compound 17 and S-metolachlor; compound 18 and S-metolachlor; compound 19 and S-metolachlor; compound 20 and S-metolachlor; compound 21 and S-metolachlor; compound 22 and S-metolachlor; compound 23 and S-metolachlor; compound 24 and S-metolachlor; compound 25 and S-metolachlor; compound 26 and S-metolachlor; compound 4 and sulfentrazone; compound 5 and sulfentrazone; compound 6 and sulfentrazone; compound 10 and sulfentrazone; compound 11 and sulfentrazone; compound 12 and sulfentrazone; compound 13 and sulfentrazone; compound 17 and sulfentrazone; compound 18 and sulfentrazone; compound 19 and sulfentrazone; compound 20 and sulfentrazone; compound 21 and sulfentrazone; compound 22 and sulfentrazone; compound 23 and sulfentrazone; compound 24 and sulfentrazone; compound 25 and sulfentrazone; compound 26 and sulfentrazone; compound 4 and flumioxazin; compound 5 and flumioxazin; compound 6 and flumioxazin; compound 10 and flumioxazin; compound 11 and flumioxazin; compound 12 and flumioxazin; compound 13 and flumioxazin; compound 17 and flumioxazin; compound 18 and flumioxazin; compound 19 and flumioxazin; compound 20 and flumioxazin; compound 21 and flumioxazin; compound 22 and flumioxazin; compound 23 and flumioxazin; compound 24 and flumioxazin; compound 25 and flumioxazin; compound 26 and flumioxazin; compound 4 and isoxaflutole; compound 5 and isoxaflutole; compound 6 and isoxaflutole; compound 10 and isoxaflutole; compound 11 and isoxaflutole; compound 12 and isoxaflutole; compound 13 and isoxaflutole; compound 17 and isoxaflutole; compound 18 and isoxaflutole; compound 19 and isoxaflutole; compound 20 and isoxaflutole; compound 21 and isoxaflutole; compound 22 and isoxaflutole; compound 23 and isoxaflutole; compound 24 and isoxaflutole; compound 25 and isoxaflutole; compound 26 and isoxaflutole; compound 4 and sulfosate; compound 5 and sulfosate; compound 6 and sulfosate; compound 10 and sulfosate; compound 11 and sulfosate; compound 12 and sulfosate; compound 13 and sulfosate; compound 17 and sulfosate; compound 18 and sulfosate; compound 19 and sulfosate; compound 20 and sulfosate; compound 21 and sulfosate; compound 22 and sulfosate; compound 23 and sulfosate; compound 24 and sulfosate; compound 25 and sulfosate; compound 26 and sulfosate; compound 4 and tralkoxydim; compound 5 and tralkoxydim; compound 6 and tralkoxydim; compound 10 and tralkoxydim; compound 11 and tralkoxydim; compound 12 and tralkoxydim; compound 13 and tralkoxydim; compound 17 and tralkoxydim; compound 18 and tralkoxydim; compound 19 and tralkoxydim; compound 20 and tralkoxydim; compound 21 and tralkoxydim; compound 22 and tralkoxydim; compound 23 and tralkoxydim; compound 24 and tralkoxydim; compound 25 and tralkoxydim; compound 26 and tralkoxydim; compound 4 and triclopyr; compound 5 and triclopyr; compound 6 and triclopyr; compound 10 and triclopyr; compound 11 and triclopyr; compound 12 and triclopyr; compound 13 and triclopyr; compound 17 and triclopyr; compound 18 and triclopyr; compound 19 and triclopyr; compound 20 and triclopyr; compound 21 and triclopyr; compound 22 and triclopyr; compound 23 and triclopyr; compound 24 and triclopyr; compound 25 and triclopyr; compound 26 and triclopyr; compound 4 and amidosulfuron; compound 5 and amidosulfuron; compound 6 and amidosulfuron; compound 10 and amidosulfuron; compound 11 and amidosulfuron; compound 12 and amidosulfuron; compound 13 and amidosulfuron; compound 17 and amidosulfuron; compound 18 and amidosulfuron; compound 19 and amidosulfuron; compound 20 and amidosulfuron; compound 21 and amidosulfuron; compound 22 and amidosulfuron; compound 23 and amidosulfuron; compound 24 and amidosulfuron; compound 25 and amidosulfuron; compound 26 and amidosulfuron; compound 4 and azimsulfuron; compound 5 and azimsulfuron; compound 6 and azimsulfuron; compound 10 and azimsulfuron; compound 11 and azimsulfuron; compound 12 and azimsulfuron; compound 13 and azimsulfuron; compound 17 and azimsulfuron; compound 18 and azimsulfuron; compound 19 and azimsulfuron; compound 20 and azimsulfuron; compound 21 and azimsulfuron; compound 22 and azimsulfuron; compound 23 and azimsulfuron; compound 24 and azimsulfuron; compound 25 and azimsulfuron; compound 26 and azimsulfuron; compound 4 and bensulfuron-methyl; compound 5 and bensulfuron-methyl; compound 6 and bensulfuron-methyl; compound 10 and bensulfuron-methyl; compound 11 and bensulfuron-methyl; compound 12 and bensulfuron-methyl; compound 13 and bensulfuron-methyl; compound 17 and bensulfuron-methyl; compound 18 and bensulfuron-methyl; compound 19 and bensulfuron-methyl; compound 20 and bensulfuron-methyl; compound 21 and bensulfuron-methyl; compound 22 and bensulfuron-methyl; compound 23 and bensulfuron-methyl; compound 24 and bensulfuron-methyl; compound 25 and bensulfuron-methyl; compound 26 and bensulfuron-methyl; compound 4 and bispyribac; compound 5 and bispyribac; compound 6 and bispyribac; compound 10 and bispyribac; compound 11 and bispyribac; compound 12 and bispyribac; compound 13 and bispyribac; compound 17 and bispyribac; compound 18 and bispyribac; compound 19 and bispyribac; compound 20 and bispyribac; compound 21 and bispyribac; compound 22 and bispyribac; compound 23 and bispyribac; compound 24 and bispyribac; compound 25 and bispyribac; compound 26 and bispyribac; compound 4 and bispyribac-sodium; compound 5 and bispyribac-sodium; compound 6 and bispyribac-sodium; compound 10 and bispyribac-sodium; compound 11 and bispyribac-sodium; compound 12 and bispyribac-sodium; compound 13 and bispyribac-sodium; compound 17 and bispyribac-sodium; compound 18 and bispyribac-sodium; compound 19 and bispyribac-sodium; compound 20 and bispyribac-sodium; compound 21 and bispyribac-sodium; compound 22 and bispyribac-sodium; compound 23 and bispyribac-sodium; compound 24 and bispyribac-sodium; compound 25 and bispyribac-sodium; compound 26 and bispyribac-sodium; compound 4 and chlorimuron-ethyl; compound 5 and chlorimuron-ethyl; compound 6 and chlorimuron-ethyl; compound 10 and chlorimuron-ethyl; compound 11 and chlorimuron-ethyl; compound 12 and chlorimuron-ethyl; compound 13 and chlorimuron-ethyl; compound 17 and chlorimuron-ethyl; compound 18 and chlorimuron-ethyl; compound 19 and chlorimuron-ethyl; compound 20 and chlorimuron-ethyl; compound 21 and chlorimuron-ethyl; compound 22 and chlorimuron-ethyl; compound 23 and chlorimuron-ethyl; compound 24 and chlorimuron-ethyl; compound 25 and chlorimuron-ethyl; compound 26 and chlorimuron-ethyl; compound 4 and chlorsulfuron; compound 5 and chlorsulfuron; compound 6 and chlorsulfuron; compound 10 and chlorsulfuron; compound 11 and chlorsulfuron; compound 12 and chlorsulfuron; compound 13 and chlorsulfuron; compound 17 and chlorsulfuron; compound 18 and chlorsulfuron; compound 19 and chlorsulfuron; compound 20 and chlorsulfuron; compound 21 and chlorsulfuron; compound 22 and chlorsulfuron; compound 23 and chlorsulfuron; compound 24 and chlorsulfuron; compound 25 and chlorsulfuron; compound 26 and chlorsulfuron; compound 4 and cinosulfuron; compound 5 and cinosulfuron; compound 6 and cinosulfuron; compound 10 and cinosulfuron; compound 11 and cinosulfuron; compound 12 and cinosulfuron; compound 13 and cinosulfuron; compound 17 and cinosulfuron; compound 18 and cinosulfuron; compound 19 and cinosulfuron; compound 20 and cinosulfuron; compound 21 and cinosulfuron; compound 22 and cinosulfuron; compound 23 and cinosulfuron; compound 24 and cinosulfuron; compound 25 and cinosulfuron; compound 26 and cinosulfuron; compound 4 and cloransulam-methyl; compound 5 and cloransulam-methyl; compound 6 and cloransulam-methyl; compound 10 and cloransulam-methyl; compound 11 and cloransulam-methyl; compound 12 and cloransulam-methyl; compound 13 and cloransulam-methyl; compound 17 and cloransulam-methyl; compound 18 and cloransulam-methyl; compound 19 and cloransulam-methyl; compound 20 and cloransulam-methyl; compound 21 and cloransulam-methyl; compound 22 and cloransulam-methyl; compound 23 and cloransulam-methyl; compound 24 and cloransulam-methyl; compound 25 and cloransulam-methyl; compound 26 and cloransulam-methyl; compound 4 and cyclosulfamuron; compound 5 and cyclosulfamuron; compound 6 and cyclosulfamuron; compound 10 and cyclosulfamuron; compound 11 and cyclosulfamuron; compound 12 and cyclosulfamuron; compound 13 and cyclosulfamuron; compound 17 and cyclosulfamuron; compound 18 and cyclosulfamuron; compound 19 and cyclosulfamuron; compound 20 and cyclosulfamuron; compound 21 and cyclosulfamuron; compound 22 and cyclosulfamuron; compound 23 and cyclosulfamuron; compound 24 and cyclosulfamuron; compound 25 and cyclosulfamuron; compound 26 and cyclosulfamuron; compound 4 and diclosulam; compound 5 and diclosulam; compound 6 and diclosulam; compound 10 and diclosulam; compound 11 and diclosulam; compound 12 and diclosulam; compound 13 and diclosulam; compound 17 and diclosulam; compound 18 and diclosulam; compound 19 and diclosulam; compound 20 and diclosulam; compound 21 and diclosulam; compound 22 and diclosulam; compound 23 and diclosulam; compound 24 and diclosulam; compound 25 and diclosulam; compound 26 and diclosulam; compound 4 and ethametsulfuron-methyl; compound 5 and ethametsulfuron-methyl; compound 6 and ethametsulfuron-methyl; compound 10 and ethametsulfuron-methyl; compound 11 and ethametsulfuron-methyl; compound 12 and ethametsulfuron-methyl; compound 13 and ethametsulfuron-methyl; compound 17 and ethametsulfuron-methyl; compound 18 and ethametsulfuron-methyl; compound 19 and ethametsulfuron-methyl; compound 20 and ethametsulfuron-methyl; compound 21 and ethametsulfuron-methyl; compound 22 and ethametsulfuron-methyl; compound 23 and ethametsulfuron-methyl; compound 24 and ethametsulfuron-methyl; compound 25 and ethametsulfuron-methyl; compound 26 and ethametsulfuron-methyl; compound 4 and ethoxysulfuron; compound 5 and ethoxysulfuron; compound 6 and ethoxysulfuron; compound 10 and ethoxysulfuron; compound 11 and ethoxysulfuron; compound 12 and ethoxysulfuron; compound 13 and ethoxysulfuron; compound 17 and ethoxysulfuron; compound 18 and ethoxysulfuron; compound 19 and ethoxysulfuron; compound 20 and ethoxysulfuron; compound 21 and ethoxysulfuron; compound 22 and ethoxysulfuron; compound 23 and ethoxysulfuron; compound 24 and ethoxysulfuron; compound 25 and ethoxysulfuron; compound 26 and ethoxysulfuron; compound 4 and flazasulfuron; compound 5 and flazasulfuron; compound 6 and flazasulfuron; compound 10 and flazasulfuron; compound 11 and flazasulfuron; compound 12 and flazasulfuron; compound 13 and flazasulfuron; compound 17 and flazasulfuron; compound 18 and flazasulfuron; compound 19 and flazasulfuron; compound 20 and flazasulfuron; compound 21 and flazasulfuron; compound 22 and flazasulfuron; compound 23 and flazasulfuron; compound 24 and flazasulfuron; compound 25 and flazasulfuron; compound 26 and flazasulfuron; compound 4 and florasulam; compound 5 and florasulam; compound 6 and florasulam; compound 10 and florasulam; compound 11 and florasulam; compound 12 and florasulam; compound 13 and florasulam; compound 17 and florasulam; compound 18 and florasulam; compound 19 and florasulam; compound 20 and florasulam; compound 21 and florasulam; compound 22 and florasulam; compound 23 and florasulam; compound 24 and florasulam; compound 25 and florasulam; compound 26 and florasulam; compound 4 and flucarbazone; compound 5 and flucarbazone; compound 6 and flucarbazone; compound 10 and flucarbazone; compound 11 and flucarbazone; compound 12 and flucarbazone; compound 13 and flucarbazone; compound 17 and flucarbazone; compound 18 and flucarbazone; compound 19 and flucarbazone; compound 20 and flucarbazone; compound 21 and flucarbazone; compound 22 and flucarbazone; compound 23 and flucarbazone; compound 24 and flucarbazone; compound 25 and flucarbazone; compound 26 and flucarbazone; compound 4 and flucarbazone-sodium; compound 5 and flucarbazone-sodium; compound 6 and flucarbazone-sodium; compound 10 and flucarbazone-sodium; compound 11 and flucarbazone-sodium; compound 12 and flucarbazone-sodium; compound 13 and flucarbazone-sodium; compound 17 and flucarbazone-sodium; compound 18 and flucarbazone-sodium; compound 19 and flucarbazone-sodium; compound 20 and flucarbazone-sodium; compound 21 and flucarbazone-sodium; compound 22 and flucarbazone-sodium; compound 23 and flucarbazone-sodium; compound 24 and flucarbazone-sodium; compound 25 and flucarbazone-sodium; compound 26 and flucarbazone-sodium; compound 4 and flucetosulfuron; compound 5 and flucetosulfuron; compound 6 and flucetosulfuron; compound 10 and flucetosulfuron; compound 11 and flucetosulfuron; compound 12 and flucetosulfuron; compound 13 and flucetosulfuron; compound 17 and flucetosulfuron; compound 18 and flucetosulfuron; compound 19 and flucetosulfuron; compound 20 and flucetosulfuron; compound 21 and flucetosulfuron; compound 22 and flucetosulfuron; compound 23 and flucetosulfuron; compound 24 and flucetosulfuron; compound 25 and flucetosulfuron; compound 26 and flucetosulfuron; compound 4 and flumetsulam; compound 5 and flumetsulam; compound 6 and flumetsulam; compound 10 and flumetsulam; compound 11 and flumetsulam; compound 12 and flumetsulam; compound 13 and flumetsulam; compound 17 and flumetsulam; compound 18 and flumetsulam; compound 19 and flumetsulam; compound 20 and flumetsulam; compound 21 and flumetsulam; compound 22 and flumetsulam; compound 23 and flumetsulam; compound 24 and flumetsulam; compound 25 and flumetsulam; compound 26 and flumetsulam; compound 4 and flupyrsulfuron-methyl; compound 5 and flupyrsulfuron-methyl; compound 6 and flupyrsulfuron-methyl; compound 10 and flupyrsulfuron-methyl; compound 11 and flupyrsulfuron-methyl; compound 12 and flupyrsulfuron-methyl; compound 13 and flupyrsulfuron-methyl; compound 17 and flupyrsulfuron-methyl; compound 18 and flupyrsulfuron-methyl; compound 19 and flupyrsulfuron-methyl; compound 20 and flupyrsulfuron-methyl; compound 21 and flupyrsulfuron-methyl; compound 22 and flupyrsulfuron-methyl; compound 23 and flupyrsulfuron-methyl; compound 24 and flupyrsulfuron-methyl; compound 25 and flupyrsulfuron-methyl; compound 26 and flupyrsulfuron-methyl; compound 4 and foramsulfuron; compound 5 and foramsulfuron; compound 6 and foramsulfuron; compound 10 and foramsulfuron; compound 11 and foramsulfuron; compound 12 and foramsulfuron; compound 13 and foramsulfuron; compound 17 and foramsulfuron; compound 18 and foramsulfuron; compound 19 and foramsulfuron; compound 20 and foramsulfuron; compound 21 and foramsulfuron; compound 22 and foramsulfuron; compound 23 and foramsulfuron; compound 24 and foramsulfuron; compound 25 and foramsulfuron; compound 26 and foramsulfuron; compound 4 and halosulfuron-methyl; compound 5 and halosulfuron-methyl; compound 6 and halosulfuron-methyl; compound 10 and halosulfuron-methyl; compound 11 and halosulfuron-methyl; compound 12 and halosulfuron-methyl; compound 13 and halosulfuron-methyl; compound 17 and halosulfuron-methyl; compound 18 and halosulfuron-methyl; compound 19 and halosulfuron-methyl; compound 20 and halosulfuron-methyl; compound 21 and halosulfuron-methyl; compound 22 and halosulfuron-methyl; compound 23 and halosulfuron-methyl; compound 24 and halosulfuron-methyl; compound 25 and halosulfuron-methyl; compound 26 and halosulfuron-methyl; compound 4 and imazamethabenz-methyl; compound 5 and imazamethabenz-methyl; compound 6 and imazamethabenz-methyl; compound 10 and imazamethabenz-methyl; compound 11 and imazamethabenz-methyl; compound 12 and imazamethabenz-methyl; compound 13 and imazamethabenz-methyl; compound 17 and imazamethabenz-methyl; compound 18 and imazamethabenz-methyl; compound 19 and imazamethabenz-methyl; compound 20 and imazamethabenz-methyl; compound 21 and imazamethabenz-methyl; compound 22 and imazamethabenz-methyl; compound 23 and imazamethabenz-methyl; compound 24 and imazamethabenz-methyl; compound 25 and imazamethabenz-methyl; compound 26 and imazamethabenz-methyl; compound 4 and imazamox; compound 5 and imazamox; compound 6 and imazamox; compound 10 and imazamox; compound 11 and imazamox; compound 12 and imazamox; compound 13 and imazamox; compound 17 and imazamox; compound 18 and imazamox; compound 19 and imazamox; compound 20 and imazamox; compound 21 and imazamox; compound 22 and imazamox; compound 23 and imazamox; compound 24 and imazamox; compound 25 and imazamox; compound 26 and imazamox; compound 4 and imazapic; compound 5 and imazapic; compound 6 and imazapic; compound 10 and imazapic; compound 11 and imazapic; compound 12 and imazapic; compound 13 and imazapic; compound 17 and imazapic; compound 18 and imazapic; compound 19 and imazapic; compound 20 and imazapic; compound 21 and imazapic; compound 22 and imazapic; compound 23 and imazapic; compound 24 and imazapic; compound 25 and imazapic; compound 26 and imazapic; compound 4 and imazapyr; compound 5 and imazapyr; compound 6 and imazapyr; compound 10 and imazapyr; compound 11 and imazapyr; compound 12 and imazapyr; compound 13 and imazapyr; compound 17 and imazapyr; compound 18 and imazapyr; compound 19 and imazapyr; compound 20 and imazapyr; compound 21 and imazapyr; compound 22 and imazapyr; compound 23 and imazapyr; compound 24 and imazapyr; compound 25 and imazapyr; compound 26 and imazapyr; compound 4 and imazaquin; compound 5 and imazaquin; compound 6 and imazaquin; compound 10 and imazaquin; compound 11 and imazaquin; compound 12 and imazaquin; compound 13 and imazaquin; compound 17 and imazaquin; compound 18 and imazaquin; compound 19 and imazaquin; compound 20 and imazaquin; compound 21 and imazaquin; compound 22 and imazaquin; compound 23 and imazaquin; compound 24 and imazaquin; compound 25 and imazaquin; compound 26 and imazaquin; compound 4 and imazaquin-ammonium; compound 5 and imazaquin-ammonium; compound 6 and imazaquin-ammonium; compound 10 and imazaquin-ammonium; compound 11 and imazaquin-ammonium; compound 12 and imazaquin-ammonium; compound 13 and imazaquin-ammonium; compound 17 and imazaquin-ammonium; compound 18 and imazaquin-ammonium; compound 19 and imazaquin-ammonium; compound 20 and imazaquin-ammonium; compound 21 and imazaquin-ammonium; compound 22 and imazaquin-ammonium; compound 23 and imazaquin-ammonium; compound 24 and imazaquin-ammonium; compound 25 and imazaquin-ammonium; compound 26 and imazaquin-ammonium; compound 4 and imazethapyr; compound 5 and imazethapyr; compound 6 and imazethapyr; compound 10 and imazethapyr; compound 11 and imazethapyr; compound 12 and imazethapyr; compound 13 and imazethapyr; compound 17 and imazethapyr; compound 18 and imazethapyr; compound 19 and imazethapyr; compound 20 and imazethapyr; compound 21 and imazethapyr; compound 22 and imazethapyr; compound 23 and imazethapyr; compound 24 and imazethapyr; compound 25 and imazethapyr; compound 26 and imazethapyr; compound 4 and imazosulfuron; compound 5 and imazosulfuron; compound 6 and imazosulfuron; compound 10 and imazosulfuron; compound 11 and imazosulfuron; compound 12 and imazosulfuron; compound 13 and imazosulfuron; compound 17 and imazosulfuron; compound 18 and imazosulfuron; compound 19 and imazosulfuron; compound 20 and imazosulfuron; compound 21 and imazosulfuron; compound 22 and imazosulfuron; compound 23 and imazosulfuron; compound 24 and imazosulfuron; compound 25 and imazosulfuron; compound 26 and imazosulfuron; compound 4 and iodosulfuron-methyl; compound 5 and iodosulfuron-methyl; compound 6 and iodosulfuron-methyl; compound 10 and iodosulfuron-methyl; compound 11 and iodosulfuron-methyl; compound 12 and iodosulfuron-methyl; compound 13 and iodosulfuron-methyl; compound 17 and iodosulfuron-methyl; compound 18 and iodosulfuron-methyl; compound 19 and iodosulfuron-methyl; compound 20 and iodosulfuron-methyl; compound 21 and iodosulfuron-methyl; compound 22 and iodosulfuron-methyl; compound 23 and iodosulfuron-methyl; compound 24 and iodosulfuron-methyl; compound 25 and iodosulfuron-methyl; compound 26 and iodosulfuron-methyl; compound 4 and mesosulfuron-methyl; compound 5 and mesosulfuron-methyl; compound 6 and mesosulfuron-methyl; compound 10 and mesosulfuron-methyl; compound 11 and mesosulfuron-methyl; compound 12 and mesosulfuron-methyl; compound 13 and mesosulfuron-methyl; compound 17 and mesosulfuron-methyl; compound 18 and mesosulfuron-methyl; compound 19 and mesosulfuron-methyl; compound 20 and mesosulfuron-methyl; compound 21 and mesosulfuron-methyl; compound 22 and mesosulfuron-methyl; compound 23 and mesosulfuron-methyl; compound 24 and mesosulfuron-methyl; compound 25 and mesosulfuron-methyl; compound 26 and mesosulfuron-methyl; compound 4 and metosulam; compound 5 and metosulam; compound 6 and metosulam; compound 10 and metosulam; compound 11 and metosulam; compound 12 and metosulam; compound 13 and metosulam; compound 17 and metosulam; compound 18 and metosulam; compound 19 and metosulam; compound 20 and metosulam; compound 21 and metosulam; compound 22 and metosulam; compound 23 and metosulam; compound 24 and metosulam; compound 25 and metosulam; compound 26 and metosulam; compound 4 and metsulfuron-methyl; compound 5 and metsulfuron-methyl; compound 6 and metsulfuron-methyl; compound 10 and metsulfuron-methyl; compound 11 and metsulfuron-methyl; compound 12 and metsulfuron-methyl; compound 13 and metsulfuron-methyl; compound 17 and metsulfuron-methyl; compound 18 and metsulfuron-methyl; compound 19 and metsulfuron-methyl; compound 20 and metsulfuron-methyl; compound 21 and metsulfuron-methyl; compound 22 and metsulfuron-methyl; compound 23 and metsulfuron-methyl; compound 24 and metsulfuron-methyl; compound 25 and metsulfuron-methyl; compound 26 and metsulfuron-methyl; compound 4 and nicosulfuron; compound 5 and nicosulfuron; compound 6 and nicosulfuron; compound 10 and nicosulfuron; compound 11 and nicosulfuron; compound 12 and nicosulfuron; compound 13 and nicosulfuron; compound 17 and nicosulfuron; compound 18 and nicosulfuron; compound 19 and nicosulfuron; compound 20 and nicosulfuron; compound 21 and nicosulfuron; compound 22 and nicosulfuron; compound 23 and nicosulfuron; compound 24 and nicosulfuron; compound 25 and nicosulfuron; compound 26 and nicosulfuron; compound 4 and oxasulfuron; compound 5 and oxasulfuron; compound 6 and oxasulfuron; compound 10 and oxasulfuron; compound 11 and oxasulfuron; compound 12 and oxasulfuron; compound 13 and oxasulfuron; compound 17 and oxasulfuron; compound 18 and oxasulfuron; compound 19 and oxasulfuron; compound 20 and oxasulfuron; compound 21 and oxasulfuron; compound 22 and oxasulfuron; compound 23 and oxasulfuron; compound 24 and oxasulfuron; compound 25 and oxasulfuron; compound 26 and oxasulfuron; compound 4 and penoxsulam; compound 5 and penoxsulam; compound 6 and penoxsulam; compound 10 and penoxsulam; compound 11 and penoxsulam; compound 12 and penoxsulam; compound 13 and penoxsulam; compound 17 and penoxsulam; compound 18 and penoxsulam; compound 19 and penoxsulam; compound 20 and penoxsulam; compound 21 and penoxsulam; compound 22 and penoxsulam; compound 23 and penoxsulam; compound 24 and penoxsulam; compound 25 and penoxsulam; compound 26 and penoxsulam; compound 4 and primisulfuron-methyl; compound 5 and primisulfuron-methyl; compound 6 and primisulfuron-methyl; compound 10 and primisulfuron-methyl; compound 11 and primisulfuron-methyl; compound 12 and primisulfuron-methyl; compound 13 and primisulfuron-methyl; compound 17 and primisulfuron-methyl; compound 18 and primisulfuron-methyl; compound 19 and primisulfuron-methyl; compound 20 and primisulfuron-methyl; compound 21 and primisulfuron-methyl; compound 22 and primisulfuron-methyl; compound 23 and primisulfuron-methyl; compound 24 and primisulfuron-methyl; compound 25 and primisulfuron-methyl; compound 26 and primisulfuron-methyl; compound 4 and propoxycarbazone; compound 5 and propoxycarbazone; compound 6 and propoxycarbazone; compound 10 and propoxycarbazone; compound 11 and propoxycarbazone; compound 12 and propoxycarbazone; compound 13 and propoxycarbazone; compound 17 and propoxycarbazone; compound 18 and propoxycarbazone; compound 19 and propoxycarbazone; compound 20 and propoxycarbazone; compound 21 and propoxycarbazone; compound 22 and propoxycarbazone; compound 23 and propoxycarbazone; compound 24 and propoxycarbazone; compound 25 and propoxycarbazone; compound 26 and propoxycarbazone; compound 4 and propoxycarbazone-sodium; compound 5 and propoxycarbazone-sodium; compound 6 and propoxycarbazone-sodium; compound 10 and propoxycarbazone-sodium; compound 11 and propoxycarbazone-sodium; compound 12 and propoxycarbazone-sodium; compound 13 and propoxycarbazone-sodium; compound 17 and propoxycarbazone-sodium; compound 18 and propoxycarbazone-sodium; compound 19 and propoxycarbazone-sodium; compound 20 and propoxycarbazone-sodium; compound 21 and propoxycarbazone-sodium; compound 22 and propoxycarbazone-sodium; compound 23 and propoxycarbazone-sodium; compound 24 and propoxycarbazone-sodium; compound 25 and propoxycarbazone-sodium; compound 26 and propoxycarbazone-sodium; compound 4 and prosulfuron; compound 5 and prosulfuron; compound 6 and prosulfuron; compound 10 and prosulfuron; compound 11 and prosulfuron; compound 12 and prosulfuron; compound 13 and prosulfuron; compound 17 and prosulfuron; compound 18 and prosulfuron; compound 19 and prosulfuron; compound 20 and prosulfuron; compound 21 and prosulfuron; compound 22 and prosulfuron; compound 23 and prosulfuron; compound 24 and prosulfuron; compound 25 and prosulfuron; compound 26 and prosulfuron; compound 4 and pyrazosulfuron-ethyl; compound 5 and pyrazosulfuron-ethyl; compound 6 and pyrazosulfuron-ethyl; compound 10 and pyrazosulfuron-ethyl; compound 11 and pyrazosulfuron-ethyl; compound 12 and pyrazosulfuron-ethyl; compound 13 and pyrazosulfuron-ethyl; compound 17 and pyrazosulfuron-ethyl; compound 18 and pyrazosulfuron-ethyl; compound 19 and pyrazosulfuron-ethyl; compound 20 and pyrazosulfuron-ethyl; compound 21 and pyrazosulfuron-ethyl; compound 22 and pyrazosulfuron-ethyl; compound 23 and pyrazosulfuron-ethyl; compound 24 and pyrazosulfuron-ethyl; compound 25 and pyrazosulfuron-ethyl; compound 26 and pyrazosulfuron-ethyl; compound 4 and pyribenzoxim; compound 5 and pyribenzoxim; compound 6 and pyribenzoxim; compound 10 and pyribenzoxim; compound 11 and pyribenzoxim; compound 12 and pyribenzoxim; compound 13 and pyribenzoxim; compound 17 and pyribenzoxim; compound 18 and pyribenzoxim; compound 19 and pyribenzoxim; compound 20 and pyribenzoxim; compound 21 and pyribenzoxim; compound 22 and pyribenzoxim; compound 23 and pyribenzoxim; compound 24 and pyribenzoxim; compound 25 and pyribenzoxim; compound 26 and pyribenzoxim; compound 4 and pyriftalid; compound 5 and pyriftalid; compound 6 and pyriftalid; compound 10 and pyriftalid; compound 11 and pyriftalid; compound 12 and pyriftalid; compound 13 and pyriftalid; compound 17 and pyriftalid; compound 18 and pyriftalid; compound 19 and pyriftalid; compound 20 and pyriftalid; compound 21 and pyriftalid; compound 22 and pyriftalid; compound 23 and pyriftalid; compound 24 and pyriftalid; compound 25 and pyriftalid; compound 26 and pyriftalid; compound 4 and pyriminobac-methyl; compound 5 and pyriminobac-methyl; compound 6 and pyriminobac-methyl; compound 10 and pyriminobac-methyl; compound 11 and pyriminobac-methyl; compound 12 and pyriminobac-methyl; compound 13 and pyriminobac-methyl; compound 17 and pyriminobac-methyl; compound 18 and pyriminobac-methyl; compound 19 and pyriminobac-methyl; compound 20 and pyriminobac-methyl; compound 21 and pyriminobac-methyl; compound 22 and pyriminobac-methyl; compound 23 and pyriminobac-methyl; compound 24 and pyriminobac-methyl; compound 25 and pyriminobac-methyl; compound 26 and pyriminobac-methyl; compound 4 and pyrithiobac; compound 5 and pyrithiobac; compound 6 and pyrithiobac; compound 10 and pyrithiobac; compound 11 and pyrithiobac; compound 12 and pyrithiobac; compound 13 and pyrithiobac; compound 17 and pyrithiobac; compound 18 and pyrithiobac; compound 19 and pyrithiobac; compound 20 and pyrithiobac; compound 21 and pyrithiobac; compound 22 and pyrithiobac; compound 23 and pyrithiobac; compound 24 and pyrithiobac; compound 25 and pyrithiobac; compound 26 and pyrithiobac; compound 4 and pyrithiobac-sodium; compound 5 and pyrithiobac-sodium; compound 6 and pyrithiobac-sodium; compound 10 and pyrithiobac-sodium; compound 11 and pyrithiobac-sodium; compound 12 and pyrithiobac-sodium; compound 13 and pyrithiobac-sodium; compound 17 and pyrithiobac-sodium; compound 18 and pyrithiobac-sodium; compound 19 and pyrithiobac-sodium; compound 20 and pyrithiobac-sodium; compound 21 and pyrithiobac-sodium; compound 22 and pyrithiobac-sodium; compound 23 and pyrithiobac-sodium; compound 24 and pyrithiobac-sodium; compound 25 and pyrithiobac-sodium; compound 26 and pyrithiobac-sodium; compound 4 and rimsulfuron; compound 5 and rimsulfuron; compound 6 and rimsulfuron; compound 10 and rimsulfuron; compound 11 and rimsulfuron; compound 12 and rimsulfuron; compound 13 and rimsulfuron; compound 17 and rimsulfuron; compound 18 and rimsulfuron; compound 19 and rimsulfuron; compound 20 and rimsulfuron; compound 21 and rimsulfuron; compound 22 and rimsulfuron; compound 23 and rimsulfuron; compound 24 and rimsulfuron; compound 25 and rimsulfuron; compound 26 and rimsulfuron; compound 4 and sulfometuron-methyl; compound 5 and sulfometuron-methyl; compound 6 and sulfometuron-methyl; compound 10 and sulfometuron-methyl; compound 11 and sulfometuron-methyl; compound 12 and sulfometuron-methyl; compound 13 and sulfometuron-methyl; compound 17 and sulfometuron-methyl; compound 18 and sulfometuron-methyl; compound 19 and sulfometuron-methyl; compound 20 and sulfometuron-methyl; compound 21 and sulfometuron-methyl; compound 22 and sulfometuron-methyl; compound 23 and sulfometuron-methyl; compound 24 and sulfometuron-methyl; compound 25 and sulfometuron-methyl; compound 26 and sulfometuron-methyl; compound 4 and sulfosulfuron; compound 5 and sulfosulfuron; compound 6 and sulfosulfuron; compound 10 and sulfosulfuron; compound 11 and sulfosulfuron; compound 12 and sulfosulfuron; compound 13 and sulfosulfuron; compound 17 and sulfosulfuron; compound 18 and sulfosulfuron; compound 19 and sulfosulfuron; compound 20 and sulfosulfuron; compound 21 and sulfosulfuron; compound 22 and sulfosulfuron; compound 23 and sulfosulfuron; compound 24 and sulfosulfuron; compound 25 and sulfosulfuron; compound 26 and sulfosulfuron; compound 4 and thifensulfuron-methyl; compound 5 and thifensulfuron-methyl; compound 6 and thifensulfuron-methyl; compound 10 and thifensulfuron-methyl; compound 11 and thifensulfuron-methyl; compound 12 and thifensulfuron-methyl; compound 13 and thifensulfuron-methyl; compound 17 and thifensulfuron-methyl; compound 18 and thifensulfuron-methyl; compound 19 and thifensulfuron-methyl; compound 20 and thifensulfuron-methyl; compound 21 and thifensulfuron-methyl; compound 22 and thifensulfuron-methyl; compound 23 and thifensulfuron-methyl; compound 24 and thifensulfuron-methyl; compound 25 and thifensulfuron-methyl; compound 26 and thifensulfuron-methyl; compound 4 and triasulfuron; compound 5 and triasulfuron; compound 6 and triasulfuron; compound 10 and triasulfuron; compound 11 and triasulfuron; compound 12 and triasulfuron; compound 13 and triasulfuron; compound 17 and triasulfuron; compound 18 and triasulfuron; compound 19 and triasulfuron; compound 20 and triasulfuron; compound 21 and triasulfuron; compound 22 and triasulfuron; compound 23 and triasulfuron; compound 24 and triasulfuron; compound 25 and triasulfuron; compound 26 and triasulfuron; compound 4 and tribenuron-methyl; compound 5 and tribenuron-methyl; compound 6 and tribenuron-methyl; compound 10 and tribenuron-methyl; compound 11 and tribenuron-methyl; compound 12 and tribenuron-methyl; compound 13 and tribenuron-methyl; compound 17 and tribenuron-methyl; compound 18 and tribenuron-methyl; compound 19 and tribenuron-methyl; compound 20 and tribenuron-methyl; compound 21 and tribenuron-methyl; compound 22 and tribenuron-methyl; compound 23 and tribenuron-methyl; compound 24 and tribenuron-methyl; compound 25 and tribenuron-methyl; compound 26 and tribenuron-methyl; compound 4 and trifloxysulfuron; compound 5 and trifloxysulfuron; compound 6 and trifloxysulfuron; compound 10 and trifloxysulfuron; compound 11 and trifloxysulfuron; compound 12 and trifloxysulfuron; compound 13 and trifloxysulfuron; compound 17 and trifloxysulfuron; compound 18 and trifloxysulfuron; compound 19 and trifloxysulfuron; compound 20 and trifloxysulfuron; compound 21 and trifloxysulfuron; compound 22 and trifloxysulfuron; compound 23 and trifloxysulfuron; compound 24 and trifloxysulfuron; compound 25 and trifloxysulfuron; compound 26 and trifloxysulfuron; compound 4 and triflusulfuron-methyl; compound 5 and triflusulfuron-methyl; compound 6 and triflusulfuron-methyl; compound 10 and triflusulfuron-methyl; compound 11 and triflusulfuron-methyl; compound 12 and triflusulfuron-methyl; compound 13 and triflusulfuron-methyl; compound 17 and triflusulfuron-methyl; compound 18 and triflusulfuron-methyl; compound 19 and triflusulfuron-methyl; compound 20 and triflusulfuron-methyl; compound 21 and triflusulfuron-methyl; compound 22 and triflusulfuron-methyl; compound 23 and triflusulfuron-methyl; compound 24 and triflusulfuron-methyl; compound 25 and triflusulfuron-methyl; compound 26 and triflusulfuron-methyl; compound 4 and tritosulfuron; compound 5 and tritosulfuron; compound 6 and tritosulfuron; compound 10 and tritosulfuron; compound 11 and tritosulfuron; compound 12 and tritosulfuron; compound 13 and tritosulfuron; compound 17 and tritosulfuron; compound 18 and tritosulfuron; compound 19 and tritosulfuron; compound 20 and tritosulfuron; compound 21 and tritosulfuron; compound 22 and tritosulfuron; compound 23 and tritosulfuron; compound 24 and tritosulfuron; compound 25 and tritosulfuron; compound 26 and tritosulfuron; compound 1 and chlorotoluron; compound 2 and chlorotoluron; compound 3 and chlorotoluron; compound 4 and chlorotoluron; compound 5 and chlorotoluron; compound 6 and chlorotoluron; compound 7 and chlorotoluron; compound 8 and chlorotoluron; compound 9 and chlorotoluron; compound 10 and chlorotoluron; compound 11 and chlorotoluron; compound 12 and chlorotoluron; compound 13 and chlorotoluron; compound 14 and chlorotoluron; compound 15 and chlorotoluron; compound 16 and chlorotoluron; compound 17 and chlorotoluron; compound 18 and chlorotoluron; compound 19 and chlorotoluron; compound 20 and chlorotoluron; compound 21 and chlorotoluron; compound 22 and chlorotoluron; compound 23 and chlorotoluron; compound 24 and chlorotoluron; compound 25 and chlorotoluron; compound 26 and chlorotoluron; compound 1 and fluazifop; compound 2 and fluazifop; compound 3 and fluazifop; compound 4 and fluazifop; compound 5 and fluazifop; compound 6 and fluazifop; compound 7 and fluazifop; compound 8 and fluazifop; compound 9 and fluazifop; compound 10 and fluazifop; compound 11 and fluazifop; compound 12 and fluazifop; compound 13 and fluazifop; compound 14 and fluazifop; compound 15 and fluazifop; compound 16 and fluazifop; compound 17 and fluazifop; compound 18 and fluazifop; compound 19 and fluazifop; compound 20 and fluazifop; compound 21 and fluazifop; compound 22 and fluazifop; compound 23 and fluazifop; compound 24 and fluazifop; compound 25 and fluazifop; compound 26 and fluazifop; compound 1 and pyridate; compound 2 and pyridate; compound 3 and pyridate; compound 4 and pyridate; compound 5 and pyridate; compound 6 and pyridate; compound 7 and pyridate; compound 8 and pyridate; compound 9 and pyridate; compound 10 and pyridate; compound 11 and pyridate; compound 12 and pyridate; compound 13 and pyridate; compound 14 and pyridate; compound 15 and pyridate; compound 16 and pyridate; compound 17 and pyridate; compound 18 and pyridate; compound 19 and pyridate; compound 20 and pyridate; compound 21 and pyridate; compound 22 and pyridate; compound 23 and pyridate; compound 24 and pyridate; compound 25 and pyridate; compound 26 and pyridate; compound 1 and simazine; compound 2 and simazine; compound 3 and simazine; compound 4 and simazine; compound 5 and simazine; compound 6 and simazine; compound 7 and simazine; compound 8 and simazine; compound 9 and simazine; compound 10 and simazine; compound 11 and simazine; compound 12 and simazine; compound 13 and simazine; compound 14 and simazine; compound 15 and simazine; compound 16 and simazine; compound 17 and simazine; compound 18 and simazine; compound 19 and simazine; compound 20 and simazine; compound 21 and simazine; compound 22 and simazine; compound 23 and simazine; compound 24 and simazine; compound 25 and simazine; compound 26 and simazine; compound 1 and terbutryn; compound 2 and terbutryn; compound 3 and terbutryn; compound 4 and terbutryn; compound 5 and terbutryn; compound 6 and terbutryn; compound 7 and terbutryn; compound 8 and terbutryn; compound 9 and terbutryn; compound 10 and terbutryn; compound 11 and terbutryn; compound 12 and terbutryn; compound 13 and terbutryn; compound 14 and terbutryn; compound 15 and terbutryn; compound 16 and terbutryn; compound 17 and terbutryn; compound 18 and terbutryn; compound 19 and terbutryn; compound 20 and terbutryn; compound 21 and terbutryn; compound 22 and terbutryn; compound 23 and terbutryn; compound 24 and terbutryn; compound 25 and terbutryn; compound 26 and terbutryn; compound 1 and isoxadifen-ethyl; compound 2 and isoxadifen-ethyl; compound 3 and isoxadifen-ethyl; compound 4 and isoxadifen-ethyl; compound 5 and isoxadifen-ethyl; compound 6 and isoxadifen-ethyl; compound 7 and isoxadifen-ethyl; compound 8 and isoxadifen-ethyl; compound 9 and isoxadifen-ethyl; compound 10 and isoxadifen-ethyl; compound 11 and isoxadifen-ethyl; compound 12 and isoxadifen-ethyl; compound 13 and isoxadifen-ethyl; compound 14 and isoxadifen-ethyl; compound 15 and isoxadifen-ethyl; compound 16 and isoxadifen-ethyl; compound 17 and isoxadifen-ethyl; compound 18 and isoxadifen-ethyl; compound 19 and isoxadifen-ethyl; compound 20 and isoxadifen-ethyl; compound 21 and isoxadifen-ethyl; compound 22 and isoxadifen-ethyl; compound 23 and isoxadifen-ethyl; compound 24 and isoxadifen-ethyl; compound 25 and isoxadifen-ethyl; compound 26 and isoxadifen-ethyl; compound 1 and naphthalic anhydride; compound 2 and naphthalic anhydride; compound 3 and naphthalic anhydride; compound 4 and naphthalic anhydride; compound 5 and naphthalic anhydride; compound 6 and naphthalic anhydride; compound 7 and naphthalic anhydride; compound 8 and naphthalic anhydride; compound 9 and naphthalic anhydride; compound 10 and naphthalic anhydride; compound 11 and naphthalic anhydride; compound 12 and naphthalic anhydride; compound 13 and naphthalic anhydride; compound 14 and naphthalic anhydride; compound 15 and naphthalic anhydride; compound 16 and naphthalic anhydride; compound 17 and naphthalic anhydride; compound 18 and naphthalic anhydride; compound 19 and naphthalic anhydride; compound 20 and naphthalic anhydride; compound 21 and naphthalic anhydride; compound 22 and naphthalic anhydride; compound 23 and naphthalic anhydride; compound 24 and naphthalic anhydride; compound 25 and naphthalic anhydride; compound 26 and naphthalic anhydride; compound 1 and glycerol; compound 2 and glycerol; compound 3 and glycerol; compound 4 and glycerol; compound 5 and glycerol; compound 6 and glycerol; compound 7 and glycerol; compound 8 and glycerol; compound 9 and glycerol; compound 10 and glycerol; compound 11 and glycerol; compound 12 and glycerol; compound 13 and glycerol; compound 14 and glycerol; compound 15 and glycerol; compound 16 and glycerol; compound 17 and glycerol; compound 18 and glycerol; compound 19 and glycerol; compound 20 and glycerol; compound 21 and glycerol; compound 22 and glycerol; compound 23 and isoxadifen-ethyl; compound 24 and glycerol; compound 25 and glycerol; compound 26 and glycerol; compound 1 and a mixture of foramsulfuron and isoxadifen-ethyl; compound 2 and a mixture of foramsulfuron and isoxadifen-ethyl; compound 3 and a mixture of foramsulfuron and isoxadifen-ethyl; compound 4 and a mixture of foramsulfuron and isoxadifen-ethyl; compound 5 and a mixture of foramsulfuron and isoxadifen-ethyl; compound 6 and a mixture of foramsulfuron and isoxadifen-ethyl; compound 7 and a mixture of foramsulfuron and isoxadifen-ethyl; compound 8 and a mixture of foramsulfuron and isoxadifen-ethyl; compound 9 and a mixture of foramsulfuron and isoxadifen-ethyl; compound 10 and a mixture of foramsulfuron and isoxadifen-ethyl; compound 11 and a mixture of foramsulfuron and isoxadifen-ethyl; compound 12 and a mixture of foramsulfuron and isoxadifen-ethyl; compound 13 and a mixture of foramsulfuron and isoxadifen-ethyl; compound 14 and a mixture of foramsulfuron and isoxadifen-ethyl; compound 15 and a mixture of foramsulfuron and isoxadifen-ethyl; compound 16 and a mixture of foramsulfuron and isoxadifen-ethyl; compound 17 and a mixture of foramsulfuron and isoxadifen-ethyl; compound 18 and a mixture of foramsulfuron and isoxadifen-ethyl; compound 19 and a mixture of foramsulfuron and isoxadifen-ethyl; compound 20 and a mixture of foramsulfuron and isoxadifen-ethyl; compound 21 and a mixture of foramsulfuron and isoxadifen-ethyl; compound 22 and a mixture of foramsulfuron and isoxadifen-ethyl; compound 23 and a mixture of foramsulfuron and isoxadifen-ethyl; compound 24 and a mixture of foramsulfuron and isoxadifen-ethyl; compound 25 and a mixture of foramsulfuron and isoxadifen-ethyl; compound 26 and a mixture of foramsulfuron and isoxadifen-ethyl.

Mixtures of this invention can be mixed with one or more insecticides, fungicides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection. Examples of such agricultural protectants with which mixtures of this invention can be formulated are: insecticides such as abamectin, acephate, acetamiprid, amidoflumet (S-1955), avermectin, azadirachtin, azinphos-methyl, bifenthrin, bifenazate, buprofezin, carbofuran, cartap, chlorantraniliprole (DPX-E2Y45), chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, flpronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, metofluthrin, monocrotophos, methoxyfenozide, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulprofos, tebufenozide, teflubenzuron, tefluthrin, terbufos, tetrachlorvinphos, thiacloprid, thiamethoxam, thiodicarb, thiosultap-sodium, tralomethrin, triazamate, trichlorfon and triflumuron; fungicides such as acibenzolar, aldimorph, amisulbrom, anilazine, azaconazole, azoxystrobin, benalaxyl, benodanil, benomyl, benthiavalicarb, benthiavalicarb-isopropyl, binapacryl, biphenyl, bitertanol, bixafen, blasticidin-S, Bordeaux mixture (tribasic copper sulfate), boscalid/nicobifen, bromuconazole, bupirimate, buthiobate, carboxin, carpropamid, captafol, captan, carbendazim, chloroneb, chlorothalonil, 5-chloro-6-(2,4,6-trifluorophenyl)-7-(4-methylpiperidin-1-yl)[1,2,4]triazolo[1,5 -a]pyrimidine, chlozolinate, clotrimazole, copper oxychloride, copper salts such as copper sulfate and copper hydroxide, cyazofamid, cyflufenamid, cymoxanil, cyproconazole, cyprodinil, dichlofluanid, diclocymet, diclomezine, dicloran, diethofencarb, difenoconazole, diflumetorim, dimethirimol, N-[2-(1,3-dimethylbutyl)phenyl]-5-fluoro-1,3-dimethyl-1H-pyrazol-4-carboxamide, dimethomorph, dimoxystrobin, diniconazole, diniconazole-M, dinocap, discostrobin, dithianon, dodemorph, dodine, econazole, edifenphos, enestroburin, epoxiconazole, etaconazole, ethaboxam, ethirimol, ethridiazole, famoxadone, fenamidone, fenarimol, fenbuconazole, fencaramid, fenfuram, fenhexamide, fenoxanil, fenpiclonil, fenpropidin, fenpropimorph, fentin acetate, fentin chloride, fentin hydroxide, ferbam, ferfurazoate, ferimzone, fluazinam, fludioxonil, flumetover, flumorph, fluopicolide, fluopyram, fluoxastrobin, fluquinconazole, fluquinconazole, flusilazole, flusulfamide, flutolanil, flutriafol, folpet, fosetyl-aluminum, fuberidazole, furalaxyl, furametapyr, hexaconazole, hymexazole, guazatine, imazalil, imibenconazole, iminoctadine, iodicarb, ipconazole, iprobenfos, iprodione, iprovalicarb, isoconazole, isoprothiolane, isotianil, kasugamycin, kresoxim-methyl, mancozeb, mandipropamid, maneb, mapanipyrin, mefenoxam, mepronil, meptyldinocap, metalaxyl, metconazole, methasulfocarb, metiram, metominostrobin, mepanipyrim, metiram, metrafenone, miconazole, myclobutanil, naftifine, neo-asozin (ferric methanearsonate), nuarimol, octhilinone, ofurace, orysastrobin, oxadixyl, oxolinic acid, oxpoconazole, oxycarboxin, oxytetracycline, paclobutrazol, penconazole, pencycuron, penthiopyrad, perfurazoate, phosphonic acid, phthalide, picobenzamid, picoxystrobin, piperalin, polyoxin, probenazole, prochloraz, procymidone, propamocarb, propamocarb-hydrochloride, propiconazole, propineb, proquinazid, prothiocarb, prothioconazole, pyraclostrobin, pryazophos, pyribencarb, pyrifenox, pyrimethanil, pyrifenox, pyrolnitrine, pyroquilon, quinconazole, quinoxyfen, quintozene, silthiofam, simeconazole, spiroxamine, streptomycin, sulfur, tebuconazole, techrazene, tecloftalam, tecnazene, terbinafine, tetraconazole, thiabendazole, thifluzamide, thiophanate, thiophanate-methyl, thiram, tiadinil, tolclofos-methyl, tolyfluanid, triadimefon, triadimenol, triarimol, triazoxide, tricyclazole, tridemorph, triflumizole, trimoprhamide tricyclazole, trifloxystrobin, triforine, triticonazole, uniconazole, validamycin, vinclozolin, zineb, ziram and zoxamide; nematocides such as aldicarb, aldoxycarb, fenamiphos, imicyafos and oxamyl; bactericides such as streptomycin; acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis, Bacillus thuringiensis delta endotoxin, baculovirus, and entomopathogenic bacteria, virus and fungi.

Mixtures of this invention can also be used in combination with herbicide safeners such as benoxacor, BCS (1-bromo-4-[(chloromethyl)sulfonyl]benzene), cloquintocet-mexyl, cyometrinil, dichlormid, 2-(dichloromethyl)-2-methyl-1,3 -dioxolane (MG 191), fenchlorazole-ethyl, fenclorim, flurazole, fluxofenim, furilazole, glycerol, isoxadifen-ethyl, mefenpyr-diethyl, methoxyphenone((4-methoxy-3 -methylphenyl)(3 -methylphenyl)-methanone), naphthalic anhydride(1,8-naphthalic anhydride) and oxabetrinil to increase safety to certain crops. Antidotally effective amounts of the herbicide safeners can be applied at the same time as the mixtures of this invention, or applied as seed treatments. Therefore an aspect of the present invention relates to a herbicidal mixture comprising a mixture of this invention and an antidotally effective amount of a herbicide safener. Seed treatment is particularly useful for selective weed control, because it physically restricts antidoting to the crop plants. Therefore a particularly useful embodiment of the present invention is a method for selectively controlling the growth of undesired vegetation in a crop comprising contacting the locus of the crop with a herbicidally effective amount of a mixture of this invention wherein seed from which the crop is grown is treated with an antidotally effective amount of safener. Antidotally effective amounts of safeners can be easily determined by one skilled in the art through simple experimentation.

Mixtures of this invention can also be used in combination with plant growth regulators such as aviglycine, N-(phenylmethyl)-1H-purin-6-amine, epocholeone, gibberellic acid, gibberellin A₄ and A₇, harpin protein, mepiquat chloride, prohexadione calcium, prohydrojasmon, sodium nitrophenolate and trinexapac-methyl, and plant growth modifying organisms such as Bacillus cereus strain BP01.

Mixtures of this invention typically provide a broader spectrum of control of undesired vegetation than provided by each active herbicide ingredient separately. Furthermore mixtures of herbicides having a similar spectrum of control but different sites of action can be particularly advantageous in certain situations for preventing the development of resistant weed populations. Particularly surprisingly, many of the mixtures of this invention have been discovered to provide a greater-than-additive (i.e. synergistic) effect on weeds and/or a less-than-additive (i.e. safening) effect on crops or other desirable plants compared to the control expected based on the effects of the individual components. Herbicidally effective amounts of the herbicidal active ingredients in the mixtures of this invention, including amounts to achieve synergism (i.e. synergistically effective amounts) or safening (i.e. safening effective amounts), to achieve the desired spectrum of weed control and safety to desired vegetation can be easily determined by one skilled in the art through simple experimentation.

The following Tests demonstrate the control efficacy of the mixtures of this invention against specific weeds and/or on crops including other desirable plants. These controls afforded by the mixtures are not limited, however, to these species.

### BIOLOGICAL EXAMPLES OF THE INVENTION

Results of Tests 1 to 32 are given in Tables 1 through 32, respectively. Columns labeled “Obs” contain the observed effects, and the values are the means of the replicates in the test. Columns labeled “Exp” contain the values for the expected additive effects of treatment mixtures calculated from Colby's Equation. “DAA” is the days after application on which the observations were taken. A dash (−) response means no test results in the case of columns labeled “Obs” or no compound in the case of columns under the “Application Rate” heading. In Tables 1 through 13, 15 through 24 and 26 through 32, the results are based on visual comparison of treated plants to control plants for response to treatments using a scale of 0 to 100 where 0 is no effect and 100 is complete control. Observed effects for weeds that are greater than the expected effect are indicated with an asterisk (*). Observed effects for crops that are less than the expected effect are indicated with the pound sign (#). Tests 14 and 25 include 3-way mixtures that require an alternative form of the Colby equation to generate the expected responses. Results in Tables 14 and 25 are explained in detail in the description of Test 14.

### Test 1

A field trial was conducted to evaluate the effects of mixtures of Compound 2 with commercial herbicides on corn (ZEAMD, Zea mays ssp. indentata) and several weed species. Corn seeds (hybrid ‘Pioneer 34N43’) were planted in mid spring season, 3.8 cm deep in a silt loam soil having 4.6% organic matter and a pH of 6. Plots were 10.7 m long by 1.5 m wide with rows spaced 76 cm apart. Seeds were spaced 18 cm apart within the rows. The field was managed using conventional tillage practices. The plots were arranged in a randomized complete block design with each treatment being replicated three times. Treatments were applied preemergence on the day after planting using a backpack sprayer delivering a spray volume of 140 L/ha using a pressure of 152 kPa. Treatments consisted of Compound 2 and the commercial herbicides atrazine, a photosystem II inhibitor, or S-metolachlor, a VLCFA elongase inhibitor, alone and in combination, dissolved or suspended in water. Weed species present in the experimental plots in sufficient quantity to be evaluated included velvetleaf (ABUTH, Abutilon theophrasti Medik.), redroot pigweed (AMARE, Amaranthus retroflexus L.), common lambsquarters (CHEAL, Chenopodium album L.), Pennsylvania smartweed (POLPY, Polygonum pensylvanicum L.), giant foxtail (SETFA, Setaria faberi Herrm.), yellow foxtail (SETLU, Setaria glauca (L.) P. Beauv.), and field pennycress (THLAR, Thlaspi arvense L.). The effects on the treated plants and untreated controls were recorded 28 and 56 days after application, except yellow foxtail was only evaluated 56 days after application and field pennycress was only evaluated 28 days after application. Plants were visually evaluated compared to controls for response to the treatments using a scale of 0 to 100 where 0 is no effect and 100 is complete control. Results are summarized in Table 1 and are the means of the three replicates. Colby's Equation was used to determine the herbicidal effects expected from the mixtures. Colby's Equation (Colby, S. R. “Calculating Synergistic and Antagonistic Responses of Herbicide Combinations,” Weeds, 15(1), pp 20-22 (1967)) calculates the expected additive effect of herbicidal mixtures, and for two active ingredients is of the form:

P_{a+b}=Pₐ+P_{b}−(PₐP_{b}/100)
wherein P_{a+b} is the percentage effect of the mixture expected from additive contribution of the individual components,
   Pₐ is the observed percentage effect of the first active ingredient at the same use rate as in the mixture, and
   P_{b} is the observed percentage effect of the second active ingredient at the same use rate as in the mixture.
      The results and additive effects expected from Colby's Equation are listed in Table 1.

TABLE 1
Observed and Expected Results from Compound 2 Alone and in Combination with
Atrazine or S-Metolachlor

| | Application Rate (g a.i./ha) | | | ZEAMD | | ABUTH | | AMARE | | CHEAL | |
|---|---|---|---|---|---|---|---|---|---|---|---|
| DAA | Cpd 2 | Atrazine | S-Metolachlor | Obs | Exp | Obs | Exp | Obs | Exp | Obs | Exp |
| 28 | 50 | — | — | 0 | | 0 | | 0 | | 0 | |
| | 100 | — | — | 0 | | 0 | | 7 | | 7 | |
| | 150 | — | — | 0 | | 0 | | 58 | | 7 | |
| | — | 1680 | — | 0 | | 75 | | 100 | | 100 | |
| | — | — | 1870 | 0 | | 33 | | 100 | | 95 | |
| | 100 | 1680 | — | 0 | 0 | 80* | 75 | 100 | 100 | 100 | 100 |
| | 50 | — | 1870 | 0 | 0 | 10 | 33 | 100 | 100 | 83 | 95 |
| | 100 | — | 1870 | 0 | 0 | 43* | 33 | 100 | 100 | 87 | 95 |
| | 150 | — | 1870 | 0 | 0 | 28 | 33 | 100 | 100 | 87 | 95 |
| 56 | 50 | — | — | 0 | | 0 | | 7 | | 7 | |
| | 100 | — | — | 0 | | 0 | | 55 | | 55 | |
| | 150 | — | — | 0 | | 10 | | 100 | | 100 | |
| | — | 1680 | — | 0 | | 0 | | 93 | | 100 | |
| | — | — | 1870 | 0 | | 0 | | 80 | | 23 | |
| | 100 | 1680 | — | 0 | 0 | 0 | 0 | 100* | 97 | 100 | 100 |
| | 50 | — | 1870 | 0 | 0 | 0 | 0 | 70 | 81 | 43* | 28 |
| | 100 | — | 1870 | 0 | 0 | 0 | 0 | 100* | 91 | 53 | 66 |
| | 150 | — | 1870 | 0 | 0 | 0 | 10 | 100 | 100 | 63 | 100 |
| | Application Rate (g a.i./ha) | | | POLPY | | SETFA | | SETLU | | THLAR | |
| DAA | Cpd 2 | Atrazine | S-Metolachlor | Obs | Exp | Obs | Exp | Obs | Exp | Obs | Exp |
| 28 | 50 | — | — | 0 | | 0 | | — | | 0 | |
| | 100 | — | — | 0 | | 0 | | — | | 0 | |
| | 150 | — | — | 0 | | 0 | | — | | 7 | |
| | — | 1680 | — | 93 | | 93 | | — | | 93 | |
| | — | — | 1870 | 57 | | 57 | | — | | 58 | |
| | 100 | 1680 | — | 90 | 93 | 90 | 93 | — | | 100* | 93 |
| | 50 | — | 1870 | 23 | 57 | 23 | 57 | — | | 23 | 58 |
| | 100 | — | 1870 | 47 | 57 | 47 | 57 | — | | 27 | 58 |
| | 150 | — | 1870 | 68* | 57 | 68* | 57 | — | | 67* | 61 |
| 56 | 50 | — | — | 0 | | 0 | | 0 | | — | |
| | 100 | — | — | 0 | | 0 | | 0 | | — | |
| | 150 | — | — | 0 | | 0 | | 0 | | — | |
| | — | 1680 | — | 100 | | 0 | | 0 | | — | |
| | — | — | 1870 | 20 | | 100 | | 100 | | — | |
| | 100 | 1680 | — | 95 | 100 | 23* | 0 | 23* | 0 | — | |
| | 50 | — | 1870 | 20 | 20 | 100 | 100 | 100 | 100 | — | |
| | 100 | — | 1870 | 20 | 20 | 100 | 100 | 100 | 100 | — | |
| | 150 | — | 1870 | 33* | 20 | 100 | 100 | 100 | 100 | — | |

As can be seen from the results in Table 1, many of the observed results for the mixture treatments on weeds were greater than expected from the Colby Equation which indicates synergistic activity of the mixtures.

### Test 2

A field trial was conducted to evaluate the effects of mixtures of Compound 2 with a commercial herbicide on corn (ZEAMD, Zea mays ssp. indentata) and several weed species. Corn seeds (hybrid ‘Pioneer 31G96’) were planted in mid spring season, 3.8 cm deep in a clay loam soil having 2% organic matter and a pH of 6.6. Plots were 6.1 m long by 3.0 m wide with rows spaced 76 cm apart. Seeds were spaced 15 cm apart within the rows. The field was managed using conventional tillage practices. The plots were arranged in a randomized complete block design with each treatment being replicated three times. Treatments were applied preemergence on the day after planting using a backpack sprayer delivering a spray volume of 224 L/ha using a pressure of 207 kPa. Treatments consisted of Compound 2 and the commercial herbicide atrazine, a photosystem II inhibitor, alone and in combination, dissolved or suspended in water. Weed species present in the experimental plots in sufficient quantity to be evaluated included velvetleaf (ABUTH, Abutilon theophrasti Medik.), redroot pigweed (AMARE, Amaranthus retroflexus L.), common ragweed (AMBEL, Ambrosia artemisiifolia L.), giant ragweed (AMBTR, Ambrosia trifida L.), common lambsquarters (CHEAL, Chenopodium album L.), yellow nutsedge (CYPES, Cyperus esculentus L.), and giant foxtail (SETFA, Setaria faberi Herrm.). The effects on the treated plants and untreated controls were recorded 18, 28 and 55 days after application. A few of the weed species could not be evaluated at every timing. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 2.

TABLE 2
Observed and Expected Results from Compound 2 Alone and in Combination with
Atrazine

| | Application Rate | | | | | | | | | |
|---|---|---|---|---|---|---|---|---|---|---|
| | (g a.i./ha) | | ZEAMD | | ABUTH | | AMARE | | AMBEL | |
| DAA | Cpd 2 | Atrazine | Obs | Exp | Obs | Exp | Obs | Exp | Obs | Exp |
| 18 | 25 | — | 0 | | 13 | | — | | 18 | |
| | 50 | — | 3 | | 28 | | — | | 27 | |
| | 75 | — | 12 | | 45 | | — | | 53 | |
| | 100 | — | 5 | | 45 | | — | | 70 | |
| | 150 | — | 17 | | 52 | | — | | 70 | |
| | — | 250 | 8 | | 15 | | — | | 20 | |
| | — | 500 | 5 | | 45 | | — | | 43 | |
| | — | 750 | 15 | | 55 | | — | | 57 | |
| | — | 1000 | 7 | | 62 | | — | | 40 | |
| | — | 1500 | 5 | | 64 | | — | | 48 | |
| | 25 | 250 | 8 | 8 | 40* | 26 | — | | 40* | 35 |
| | 50 | 500 | 7 | 8 | 40 | 60 | — | | 53 | 58 |
| | 75 | 750 | 8 | 25 | 48 | 75 | — | | 80 | 80 |
| | 100 | 1000 | 13 | 11 | 94* | 79 | — | | 90* | 82 |
| | 150 | 1500 | 10 | 21 | 85* | 83 | — | | 88* | 85 |
| 28 | 25 | — | 0 | | 13 | | 30 | | 10 | |
| | 50 | — | 2 | | 18 | | 90 | | 48 | |
| | 75 | — | 5 | | 65 | | 98 | | 70 | |
| | 100 | — | 7 | | 63 | | 93 | | 88 | |
| | 150 | — | 12 | | 73 | | 82 | | 97 | |
| | — | 250 | 2 | | 37 | | 72 | | 18 | |
| | — | 500 | 7 | | 78 | | 97 | | 69 | |
| | — | 750 | 12 | | 85 | | 90 | | 83 | |
| | — | 1000 | 8 | | 98 | | 100 | | 86 | |
| | — | 1500 | 3 | | 99 | | 100 | | 98 | |
| | 25 | 250 | 7 | 2 | 63* | 45 | 78 | 80 | 63* | 27 |
| | 50 | 500 | 15 | 8 | 85* | 82 | 97 | 100 | 87* | 84 |
| | 75 | 750 | 18 | 16 | 97* | 95 | 100 | 100 | 94 | 95 |
| | 100 | 1000 | 20 | 14 | 99 | 99 | 100 | 100 | 100* | 98 |
| | 150 | 1500 | 22 | 15 | 98 | 100 | 100 | 100 | 100 | 100 |
| 55 | 25 | — | 0 | | 38 | | 100 | | 10 | |
| | 50 | — | 0 | | 55 | | 100 | | 33 | |
| | 75 | — | 0 | | 63 | | 100 | | 42 | |
| | 100 | — | 0 | | 68 | | 100 | | 77 | |
| | 150 | — | 0 | | 78 | | 100 | | 93 | |
| | — | 250 | 0 | | 68 | | 95 | | 12 | |
| | — | 500 | 0 | | 63 | | 99 | | 22 | |
| | — | 750 | 0 | | 87 | | 100 | | 63 | |
| | — | 1000 | 0 | | 100 | | 100 | | 72 | |
| | — | 1500 | 0 | | 99 | | 100 | | 90 | |
| | 25 | 250 | 0 | 0 | 58 | 80 | 100 | 100 | 7 | 21 |
| | 50 | 500 | 0 | 0 | 72 | 84 | 100 | 100 | 50* | 48 |
| | 75 | 750 | 0 | 0 | 93 | 95 | 100 | 100 | 78 | 79 |
| | 100 | 1000 | 0 | 0 | 98 | 100 | 100 | 100 | 100* | 93 |
| | 150 | 1500 | 0 | 0 | 97 | 100 | 100 | 100 | 98 | 99 |
| | Application Rate | | | | | | | | | |
| | (g a.i./ha) | | AMBTR | | CHEAL | | CYPES | | SETFA | |
| DAA | Cpd 2 | Atrazine | Obs | Exp | Obs | Exp | Obs | Exp | Obs | Exp |
| 18 | 25 | — | 10 | | — | | 12 | | 13 | |
| | 50 | — | 30 | | — | | 18 | | 22 | |
| | 75 | — | 10 | | — | | 22 | | 32 | |
| | 100 | — | 45 | | — | | 25 | | 35 | |
| | 150 | — | 65 | | — | | 30 | | 43 | |
| | — | 250 | 0 | | — | | 13 | | 20 | |
| | — | 500 | 30 | | — | | 18 | | 25 | |
| | — | 750 | 75 | | — | | 40 | | 40 | |
| | — | 1000 | 20 | | — | | 28 | | 43 | |
| | — | 1500 | — | | — | | 27 | | 38 | |
| | 25 | 250 | 20* | 10 | — | | 22 | 23 | 37* | 31 |
| | 50 | 500 | 45 | 51 | — | | 35* | 33 | 38 | 41 |
| | 75 | 750 | 85* | 78 | — | | 30 | 53 | 55 | 59 |
| | 100 | 1000 | 70* | 56 | — | | 48* | 46 | 67* | 63 |
| | 150 | 1500 | — | | — | | 55* | 49 | 62 | 65 |
| 28 | 25 | — | 35 | | 90 | | 0 | | 5 | |
| | 50 | — | 30 | | 100 | | 0 | | 10 | |
| | 75 | — | 75 | | 100 | | 0 | | 30 | |
| | 100 | — | 70 | | 100 | | 0 | | 23 | |
| | 150 | — | — | | 100 | | 0 | | 65 | |
| | — | 250 | 10 | | 100 | | 0 | | 37 | |
| | — | 500 | 5 | | 100 | | 5 | | 67 | |
| | — | 750 | 65 | | 100 | | 0 | | 83 | |
| | — | 1000 | — | | 100 | | 2 | | 87 | |
| | — | 1500 | — | | 100 | | 0 | | 88 | |
| | 25 | 250 | 15 | 42 | 100 | 100 | 8* | 0 | 58* | 40 |
| | 50 | 500 | 25 | 34 | 100 | 100 | 0 | 5 | 67 | 70 |
| | 75 | 750 | 98* | 91 | 100 | 100 | 3* | 0 | 82 | 88 |
| | 100 | 1000 | — | | 100 | 100 | 13* | 2 | 93* | 90 |
| | 150 | 1500 | — | | 100 | 100 | 40* | 0 | 92 | 96 |
| 55 | 25 | — | — | | — | | 0 | | — | |
| | 50 | — | — | | — | | 0 | | — | |
| | 75 | — | — | | — | | 0 | | — | |
| | 100 | — | — | | — | | 0 | | — | |
| | 150 | — | — | | — | | 10 | | — | |
| | — | 250 | — | | — | | 10 | | 35 | |
| | — | 500 | — | | — | | 13 | | 60 | |
| | — | 750 | — | | — | | 0 | | 58 | |
| | — | 1000 | — | | — | | 62 | | 65 | |
| | — | 1500 | — | | — | | 60 | | 80 | |
| | 25 | 250 | — | | — | | 0 | 10 | — | |
| | 50 | 500 | — | | — | | 10 | 13 | 48 | |
| | 75 | 750 | — | | — | | 55* | 0 | 68 | |
| 55 | 100 | 1000 | — | | — | | 63 | 62 | 83 | |
| | 150 | 1500 | — | | — | | 68* | 64 | 82 | |

As can be seen from the results in Table 2, many of the observed results for the mixture treatments on weeds were greater than expected from the Colby Equation which indicates synergistic activity of the mixtures. Synergy was particularly apparent in velvetleaf, common ragweed, yellow nutsedge and giant foxtail. In test species where a greater than additive response was less apparent, it was typically because the expected effect was already near 100% at the rates tested.

### Test 3

A field trial was conducted to evaluate the effects of mixtures of Compound 2 with commercial herbicides on corn (ZEAMD, Zea mays ssp. indentata) and several weed species. Corn seeds (hybrid ‘Pioneer 33J56’) were planted in early spring season, 3.8 cm deep in a silt loam soil having 2.4% organic matter and a pH of 6. Plots were 6.1 m long by 2.7 m wide with rows spaced 91.4 cm apart. The field was managed using no-till practices. The plots were arranged in a randomized complete block design with each treatment being replicated three times. Treatments were applied to emerged weeds 9 days before corn planting using a backpack sprayer delivering a spray volume of 140 L/ha using a pressure of 241 kPa. Treatments consisted of Compound 2 and the commercial herbicides glyphosate, an EPSP synthase inhibitor, or paraquat, a photosystem I electron diverter, alone and in combination, dissolved or suspended in water. Compound 2 and paraquat treatments, alone and in combination, also included a surfactant. Glyphosate, alone and with Compound 2, included ammonium sulfate in the treatment mixture. Weed species present in the experimental plots in sufficient quantity to be evaluated included common lambsquarters (CHEAL, Chenopodium album L.), red deadnettle (LAMPU, Lamium purpureum L.), Virginia pepperweed (LEPVI, Lepidium virginicum L.), curly dock (RUMCR, Rumex crispus L.), giant foxtail (SETFA, Setaria faberi Herrm.), and common chickweed (STEME, Stellaria media (L.) Vill.). The effects on the weeds in the treated plots and untreated control plots were recorded 30, 42, 46 and 68 days after application. Most of the weed species could not be evaluated at every timing. Corn response was not evaluated because the growth was highly variable depending on the efficacy of the weed control treatments. Weeds were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 3.

TABLE 3
Observed and Expected Results from Compound 2 Alone and in Combination with
Glyphosate or Paraquat

| | Application Rate (g a.i./ha) | | | CHEAL | | LAMPU | | LEPVI | |
|---|---|---|---|---|---|---|---|---|---|
| DAA | Cpd 2 | Glyphosate | Paraquat | Obs | Exp | Obs | Exp | Obs | Exp |
| 30 | 100 | — | — | — | | 87 | | 69 | |
| | — | 1540 | — | — | | 70 | | 98 | |
| | — | — | 1150 | — | | 100 | | 100 | |
| | 100 | 1540 | — | — | | 100* | 96 | 100 | 99 |
| | 100 | — | 1150 | — | | 98 | 100 | 100 | 100 |
| 42 | 100 | — | — | — | | 35 | | 18 | |
| | — | 1540 | — | — | | 52 | | 82 | |
| | — | — | 1150 | — | | 98 | | 96 | |
| | 100 | 1540 | — | — | | 59 | 69 | 87* | 85 |
| | 100 | — | 1150 | — | | 88 | 99 | 90 | 97 |
| 46 | 100 | — | — | — | | 100 | | 23 | |
| | — | 1540 | — | — | | 97 | | 98 | |
| | — | — | 1150 | — | | 100 | | 100 | |
| | 100 | 1540 | — | — | | 100 | 100 | 100 | 99 |
| | 100 | — | 1150 | — | | 100 | 100 | 100 | 100 |
| 68 | 100 | — | — | 100 | | — | | — | |
| | — | 1540 | — | 0 | | — | | — | |
| | — | — | 1150 | 0 | | — | | — | |
| | 100 | 1540 | — | 100 | 100 | — | | — | |
| | 100 | — | 1150 | 100 | 100 | — | | — | |
| | Application Rate (g a.i./ha) | | | RUMCR | | SETFA | | STEME | |
| DAA | Cpd 2 | Glyphosate | Paraquat | Obs | Exp | Obs | Exp | Obs | Exp |
| 30 | 100 | — | — | 62 | | — | | 62 | |
| | — | 1540 | — | 75 | | — | | 100 | |
| | — | — | 1150 | 58 | | — | | 96 | |
| | 100 | 1540 | — | 97* | 90 | — | | 100 | 100 |
| | 100 | — | 1150 | 62 | 84 | — | | 97 | 98 |
| 42 | 100 | — | — | 37 | | — | | 37 | |
| | — | 1540 | — | 61 | | — | | 88 | |
| | — | — | 1150 | 58 | | — | | 97 | |
| | 100 | 1540 | — | 71 | 75 | — | | 97* | 93 |
| | 100 | — | 1150 | 63 | 73 | — | | 97 | 98 |
| 46 | 100 | — | — | 54 | | — | | 30 | |
| | — | 1540 | — | 82 | | — | | 100 | |
| | — | — | 1150 | 13 | | — | | 88 | |
| | 100 | 1540 | — | 100* | 92 | — | | 100 | 100 |
| | 100 | — | 1150 | 22 | 60 | — | | 100* | 92 |
| 68 | 100 | — | — | 67 | | 40 | | — | |
| | — | 1540 | — | 93 | | 0 | | — | |
| | — | — | 1150 | 15 | | 0 | | — | |
| | 100 | 1540 | — | 100* | 98 | 45* | 40 | — | |
| | 100 | — | 1150 | 27 | 72 | 17 | 40 | — | |

As can be seen from the results in Table 3, many of the observed results for the mixture treatments on weeds were greater than expected from the Colby Equation, which indicates synergistic activity of the mixtures. Synergy was particularly apparent in curly dock and common chickweed. In test species where a greater than additive response was less apparent, it was typically because the expected effect was already near 100% at the rates tested.

### Test 4

A field trial was conducted to evaluate the effects of mixtures of Compound 2 with commercial herbicides on spring wheat (TRZAS, Triticum aestivum L.) and several weed species. Wheat seeds (cv. ‘AC Intrepid’) were planted in late spring season, 3.8 cm deep in a loam soil having 2.7% organic matter and a pH of 7. Plots were 6 m long by 2.5 m wide. The field was managed using no-till practices. The plots were arranged in a randomized complete block design with each treatment being replicated four times. Treatments were applied postemergence 25 days after planting using a backpack sprayer delivering a spray volume of 55 L/ha using a pressure of 276 kPa. Treatments consisted of Compound 2 and the commercial herbicides clodinafop and fenoxaprop, ACCase inhibitors, alone and in combination, dissolved or suspended in water. Compound 2 and clodinafop treatments, alone and in combination, also included a surfactant. Weed species present in the experimental plots in sufficient quantity to be evaluated included wild oat (AVEFA, Avena fatua L.), common lambsquarters (CHEAL, Chenopodium album L.), kochia (KCHSC, Kochia scoparia (L.) Schrad.), wild buckwheat (POLCO, Polygonum convolvulus L.), Russian thistle (SASKR, Salsola kali L. ssp. ruthenica (Iljin) Soo), and field pennycress (THLAR, Thlaspi arvense L.). The effects on the treated plants and untreated controls were recorded 14, 35 and 55 days after application. Only wheat and wild oats could be evaluated at every timing. Common lambsquarters was evaluated only at 14 days after application. Plants were visually evaluated compared to controls for response to the treatments using a scale of 0 to 100 where 0 is no effect and 100 is complete control. Results are the means of the four replicates. Colby's Equation was used to determine the herbicidal effects expected from the mixtures. The results and additive effects expected from Colby's Equation are listed in Table 4.

TABLE 4
Observed and Expected Results from Compound 2 Alone and in Combination with
Clodinafop or Fenoxaprop

| | Application Rate (g a.i./ha) | | | TRZAS | | AVEFA | | CHEAL | | KCHSC | |
|---|---|---|---|---|---|---|---|---|---|---|---|
| DAA | Cpd 2 | Clodinafop | Fenoxaprop | Obs | Exp | Obs | Exp | Obs | Exp | Obs | Exp |
| 14 | 60 | — | — | 0 | | 0 | | 92 | | — | |
| | 30 | — | — | 0 | | 0 | | 83 | | 95 | |
| | — | 56 | — | 0 | | 97 | | 0 | | 0 | |
| | — | — | 90 | 0 | | 96 | | 0 | | — | |
| | 60 | 56 | — | 1 | 0 | 98 | 97 | 95* | 92 | 95 | |
| | 30 | 56 | — | 0 | 0 | 98 | 97 | 80 | 83 | 95 | 95 |
| | 60 | — | 90 | 12 | 0 | 98* | 96 | 93 | 92 | — | |
| | 30 | — | 90 | 1 | 0 | 97 | 96 | 95* | 83 | 95 | |
| 35 | 60 | — | — | 6 | | 0 | | — | | 96 | |
| | 30 | — | — | 2 | | 0 | | — | | 99 | |
| | — | 56 | — | 0 | | 99 | | 0 | | 0 | |
| | — | — | 90 | 0 | | 96 | | 0 | | — | |
| | 60 | 56 | — | 11 | 6 | 99 | 99 | — | | — | |
| | 30 | 56 | — | 4 | 2 | 99 | 99 | — | | 92 | 99 |
| | 60 | — | 90 | 38 | 6 | 98* | 96 | — | | — | |
| | 30 | — | 90 | 8 | 2 | 98* | 96 | — | | 97 | |
| 55 | 60 | — | — | 11 | | 0 | | — | | — | |
| | 30 | — | — | 3 | | 0 | | — | | — | |
| | — | 56 | — | 0 | | 98 | | — | | — | |
| | — | — | 90 | 0 | | 98 | | — | | — | |
| | 60 | 56 | — | 18 | 11 | 98 | 98 | — | | — | |
| | 30 | 56 | — | 7 | 3 | 97 | 98 | — | | — | |
| | 60 | — | 90 | 35 | 11 | 88 | 98 | — | | — | |
| | 30 | — | 90 | 12 | 3 | 87 | 98 | — | | — | |

| | Application Rate (g a.i./ha) | | | POLCO | | SASKR | | THLAR | |
|---|---|---|---|---|---|---|---|---|---|
| DAA | Cpd 2 | Clodinafop | Fenoxaprop | Obs | Exp | Obs | Exp | Obs | Exp |
| 14 | 60 | — | — | 63 | | 91 | | 0 | |
| | 30 | — | — | 61 | | 88 | | 0 | |
| | — | 56 | — | 0 | | 0 | | 0 | |
| | — | — | 90 | 0 | | 0 | | 0 | |
| | 60 | 56 | — | 72* | 63 | 93* | 91 | 0 | 0 |
| | 30 | 56 | — | 59 | 61 | 85 | 88 | — | |
| | 60 | — | 90 | 78* | 63 | 92 | 91 | 0 | 0 |
| | 30 | — | 90 | 68* | 61 | 93* | 88 | 0 | 0 |
| 35 | 60 | — | — | 55 | | 95 | | 8 | |
| | 30 | — | — | 51 | | 99 | | 0 | |
| | — | 56 | — | 0 | | 0 | | 0 | |
| | — | — | 90 | 0 | | 0 | | 0 | |
| | 60 | 56 | — | 65* | 55 | — | | — | |
| | 30 | 56 | — | 62* | 51 | 95 | 99 | 0 | 0 |
| | 60 | — | 90 | 48 | 55 | — | | 0 | 8 |
| | 30 | — | 90 | 33 | 51 | 99 | 99 | 0 | 0 |
| 55 | 60 | — | — | — | | — | | — | |
| | 30 | — | — | — | | — | | — | |
| | — | 56 | — | — | | — | | — | |
| | — | — | 90 | — | | — | | — | |
| | 60 | 56 | — | — | | — | | — | |
| | 30 | 56 | — | — | | — | | — | |
| | 60 | — | 90 | — | | — | | — | |
| | 30 | — | 90 | — | | — | | — | |

As can be seen from the results in Table 4, many of the observed results for the mixture treatments of Compound 2 with these two ACCase inhibitors on weeds were greater than expected from the Colby Equation, which indicates synergistic activity of the mixtures. Synergy was particularly apparent in wild oats and wild buckwheat.

### Test 5

A field trial was conducted to evaluate the effects of mixtures of Compound 2 with commercial herbicides on corn (ZEAMD, Zea mays ssp. indentata) and several weed species. Corn seeds (hybrid ‘Pioneer 38H69’) were planted in mid spring season, 5.1 cm deep in a silty clay loam soil having 3% organic matter and a pH of 6.5. Plots were 9.1 m long by 3.0 m wide with rows spaced 76 cm apart. The field was managed using conventional tillage practices. The plots were arranged in a randomized complete block design with each treatment being replicated three times. Treatments were applied postemergence 60 days after planting using a backpack sprayer delivering a spray volume of 187 L/ha using a pressure of 152 kPa. Treatments consisted of Compound 2 and the commercial herbicides atrazine, a photosystem II inhibitor, glufosinate, a glutamine synthetase inhibitor, or glyphosate, an EPSP synthase inhibitor, alone and in combination, dissolved or suspended in water. All treatments included a surfactant except glufosinate treatments, both alone and in combination. Weed species present in the experimental plots in sufficient quantity to be evaluated included velvetleaf (ABUTH, Abutilon theophrasti Medik.), common ragweed (AMBEL, Ambrosia artemisiifolia L.), shepherd's purse (CAPBP, Capsella bursa-pastoris (L.) Medik.), common lambsquarters (CHEAL, Chenopodium album L.), large crabgrass (DIGSA, Digitaria sanguinalis (L.) Scop.), giant foxtail (SETFA, Setaria faberi Herrm.), yellow foxtail (SETLU, Setaria glauca (L.) P. Beauv.), and field pennycress (THLAR, Thlaspi arvense L.). The effects on the treated plants and untreated controls were recorded 16 and 31 days after application. Plants were visually evaluated compared to controls for response to the treatments using a scale of 0 to 100 where 0 is no effect and 100 is complete control. Results are summarized in Table 5 and are the means of the three replicates. Colby's Equation was used to determine the herbicidal effects expected from the mixtures. The results and additive effects expected from Colby's Equation are listed in Table 5.

TABLE 5
Observed and Expected Results from Compound 2 Alone and in Combination with
Atrazine, Glufosinate or Glyphosate

| | Application Rate (g a.i./ha) | | | | ZEAMD | | ABUTH | |
|---|---|---|---|---|---|---|---|---|
| DAA | Cpd 2 | Atrazine | Glufosinate | Glyphosate | Obs | Exp | Obs | Exp |
| 16 | 30 | — | — | — | 0 | | 76 | |
| | 60 | — | — | — | 0 | | 81 | |
| | — | 1120 | — | — | 0 | | 40 | |
| | — | — | 470 | — | 0 | | 33 | |
| | — | — | — | 1120 | 0 | | 84 | |
| | 60 | 1120 | — | — | 0 | 0 | 95* | 89 |
| | 30 | — | 470 | — | 0 | 0 | 91* | 84 |
| | 60 | — | 470 | — | 0 | 0 | 97* | 88 |
| | 30 | — | — | 1120 | 0 | 0 | 87 | 96 |
| | 60 | — | — | 1120 | 0 | 0 | 99* | 97 |
| 31 | 30 | — | — | — | 0 | | 77 | |
| | 60 | — | — | — | 0 | | 82 | |
| | — | 1120 | — | — | 0 | | 13 | |
| | — | — | 470 | — | 0 | | 27 | |
| | — | — | — | 1120 | 0 | | 84 | |
| | 60 | 1120 | — | — | 0 | 0 | 97* | 85 |
| | 30 | — | 470 | — | 0 | 0 | 87* | 83 |
| | 60 | — | 470 | — | 0 | 0 | 93* | 87 |
| | 30 | — | — | 1120 | 0 | 0 | 89 | 96 |
| | 60 | — | — | 1120 | 0 | 0 | 100* | 97 |
| | Application Rate (g a.i./ha) | | | | AMBEL | | CAPBP | |
| DAA | Cpd 2 | Atrazine | Glufosinate | Glyphosate | Obs | Exp | Obs | Exp |
| 16 | 30 | — | — | — | 85 | | 25 | |
| | 60 | — | — | — | 95 | | 28 | |
| | — | 1120 | — | — | 45 | | 95 | |
| | — | — | 470 | — | 100 | | 100 | |
| | — | — | — | 1120 | 84 | | 98 | |
| | 60 | 1120 | — | — | 94 | 97 | 89 | 96 |
| | 30 | — | 470 | — | 98 | 100 | 100 | 100 |
| | 60 | — | 470 | — | 100 | 100 | 100 | 100 |
| | 30 | — | — | 1120 | 98 | 98 | 100 | 99 |
| | 60 | — | — | 1120 | 96 | 99 | 99 | 99 |
| 31 | 30 | — | — | — | 83 | | 0 | |
| | 60 | — | — | — | 99 | | 2 | |
| | — | 1120 | — | — | 30 | | 100 | |
| | — | — | 470 | — | 100 | | 100 | |
| | — | — | — | 1120 | 100 | | 100 | |
| | 60 | 1120 | — | — | 100 | 99 | 100 | 100 |
| | 30 | — | 470 | — | 100 | 100 | 100 | 100 |
| | 60 | — | 470 | — | 67 | 100 | 100 | 100 |
| | 30 | — | — | 1120 | 99 | 100 | 100 | 100 |
| | 60 | — | — | 1120 | 100 | 100 | 100 | 100 |
| | Application Rate (g a.i./ha) | | | | CHEAL | | DIGSA | |
| DAA | Cpd 2 | Atrazine | Glufosinate | Glyphosate | Obs | Exp | Obs | Exp |
| 16 | 30 | — | — | — | 83 | | 0 | |
| | 60 | — | — | — | 87 | | 0 | |
| | — | 1120 | — | — | 79 | | 0 | |
| | — | — | 470 | — | 87 | | 99 | |
| | — | — | — | 1120 | 100 | | 98 | |
| | 60 | 1120 | — | — | 98 | 97 | 0 | 0 |
| | 30 | — | 470 | — | 99 | 98 | 96 | 99 |
| | 60 | — | 470 | — | 100* | 98 | 100 | 99 |
| | 30 | — | — | 1120 | 100 | 100 | 100* | 98 |
| | 60 | — | — | 1120 | 100 | 100 | 99 | 98 |
| 31 | 30 | — | — | — | 82 | | 0 | |
| | 60 | — | — | — | 99 | | 2 | |
| | — | 1120 | — | — | 70 | | 0 | |
| | — | — | 470 | — | 79 | | 94 | |
| | — | — | — | 1120 | 97 | | 95 | |
| | 60 | 1120 | — | — | 100 | 100 | 8* | 2 |
| | 30 | — | 470 | — | 99* | 96 | 93 | 94 |
| | 60 | — | 470 | — | 100 | 100 | 97* | 94 |
| | 30 | — | — | 1120 | 100 | 99 | 95 | 95 |
| | 60 | — | — | 1120 | 100 | 100 | 98* | 95 |

| | Application Rate (g a.i./ha) | | | | SETFA | | SETLU | | THLAR | |
|---|---|---|---|---|---|---|---|---|---|---|
| DAA | Cpd 2 | Atrazine | Glufosinate | Glyphosate | Obs | Exp | Obs | Exp | Obs | Exp |
| 16 | 30 | — | — | — | 0 | | 2 | | 37 | |
| | 60 | — | — | — | 0 | | 0 | | 42 | |
| | — | 1120 | — | — | 0 | | 0 | | 95 | |
| | — | — | 470 | — | 100 | | 98 | | 100 | |
| | — | — | — | 1120 | 100 | | 100 | | 98 | |
| | 60 | 1120 | — | — | 0 | 0 | 0 | 0 | 87 | 97 |
| | 30 | — | 470 | — | 100 | 100 | 98 | 98 | 100 | 100 |
| | 60 | — | 470 | — | 100 | 100 | 98 | 98 | 100 | 100 |
| | 30 | — | — | 1120 | 100 | 100 | 100 | 100 | 100 | 99 |
| | 60 | — | — | 1120 | 99 | 100 | 98 | 100 | 99 | 99 |
| 31 | 30 | — | — | — | 0 | | 0 | | 0 | |
| | 60 | — | — | — | 2 | | 2 | | 2 | |
| | — | 1120 | — | — | 0 | | 0 | | 100 | |
| | — | — | 470 | — | 99 | | 90 | | 100 | |
| | — | — | — | 1120 | 98 | | 98 | | 100 | |
| | 60 | 1120 | — | — | 0 | 2 | 0 | 2 | 100 | 100 |
| | 30 | — | 470 | — | 98 | 99 | 92* | 90 | 100 | 100 |
| | 60 | — | 470 | — | 98 | 99 | 92* | 90 | 100 | 100 |
| | 30 | — | — | 1120 | 99 | 98 | 96 | 98 | 100 | 100 |
| | 60 | — | — | 1120 | 99 | 98 | 99 | 98 | 100 | 100 |

As can be seen from the results in Table 5, a number of the observed results for the mixture treatments on weeds were greater than expected from the Colby Equation, which indicates synergistic activity of the mixtures. Synergy was particularly apparent in velvetleaf and large crabgrass. In test species where a greater than additive response was less apparent, it was typically because the expected effect was already near 100% at the rates tested.

### Test 6

A field trial was conducted to evaluate the effects of mixtures of Compound 2 with commercial herbicides on corn (ZEAMD, Zea mays ssp. indentata) and several weed species.

Corn seeds (hybrid ‘Pioneer 35Y62’) were planted in mid spring season, 3.8 cm deep in a silt loam soil having 4% organic matter and a pH of 5.8. Plots were 10.7 m long by 1.5 m wide with rows spaced 76 cm apart. Seeds were spaced 18 cm apart within the rows. The field was managed using conventional tillage practices. The plots were arranged in a randomized complete block design with each treatment being replicated three times. Treatments were applied postemergence about 60 days after planting using a backpack sprayer delivering a spray volume of 140 L/ha using a pressure of 152 kPa. Treatments consisted of Compound 2 and the commercial herbicides atrazine, a photosystem II inhibitor, glufosinate, a glutamine synthetase inhibitor, or glyphosate, an EPSP synthase inhibitor, alone and in combination, dissolved or suspended in water. All treatments included a surfactant except glufosinate treatments, both alone and in combination. Weed species present in the experimental plots in sufficient quantity to be evaluated included velvetleaf (ABUTH, Abutilon theophrasti Medik.), redroot pigweed (AMARE, Amaranthus retroflexus L.), common lambsquarters (CHEAL, Chenopodium album L.), Pennsylvania smartweed (POLPY, Polygonum pensylvanicum L.), giant foxtail (SETFA, Setaria faberi Herrm.), and yellow foxtail (SETLU, Setaria glauca (L.) P. Beauv.). The effects on the treated plants and untreated controls were recorded 14 and 28 days after application. Plants were visually evaluated compared to controls for response to the treatments using a scale of 0 to 100 where 0 is no effect and 100 is complete control. Results are summarized in Table 6 and are the means of the three replicates. Colby's Equation was used to determine the herbicidal effects expected from the mixtures. The results and additive effects expected from Colby's Equation are listed in Table 6.

TABLE 6
Observed and Expected Results from Compound 2 Alone and in Combination
with Atrazine, Glufosinate or Glyphosate

| | Application Rate (g a.i./ha) | | | | ZEAMD | | ABUTH | | AMARE | | CHEAL | |
|---|---|---|---|---|---|---|---|---|---|---|---|---|
| DAA | Cpd 2 | Atrazine | Glufosinate | Glyphosate | Obs | Exp | Obs | Exp | Obs | Exp | Obs | Exp |
| 14 | 30 | — | — | — | 0 | | 0 | | 100 | | 100 | |
| | 60 | — | — | — | 0 | | 0 | | 98 | | 100 | |
| | — | 1120 | — | — | 0 | | 0 | | 100 | | 100 | |
| | — | — | 470 | — | 0 | | 0 | | 100 | | 100 | |
| | — | — | — | 1120 | 0 | | 99 | | 100 | | 100 | |
| | 60 | 1120 | — | — | 0 | 0 | 100* | 0 | 100 | 100 | 100 | 100 |
| | 30 | — | 470 | — | 0 | 0 | 0 | 0 | 97 | 100 | 100 | 100 |
| | 60 | — | 470 | — | 0 | 0 | 35* | 0 | 100 | 100 | 100 | 100 |
| | 30 | — | — | 1120 | 0 | 0 | 99 | 99 | 100 | 100 | 100 | 100 |
| | 60 | — | — | 1120 | 0 | 0 | 100 | 99 | 100 | 100 | 100 | 100 |
| 28 | 30 | — | — | — | 0 | | 0 | | 100 | | 100 | |
| | 60 | — | — | — | 0 | | 0 | | 98 | | 100 | |
| | — | 1120 | — | — | 0 | | 0 | | 100 | | 100 | |
| | — | — | 470 | — | 0 | | 0 | | 100 | | 100 | |
| | — | — | — | 1120 | 0 | | 100 | | 100 | | 100 | |
| | 60 | 1120 | — | — | 0 | 0 | 100* | 0 | 100 | 100 | 100 | 100 |
| | 30 | — | 470 | — | 0 | 0 | 0 | 0 | 97 | 100 | 100 | 100 |
| | 60 | — | 470 | — | 0 | 0 | 35* | 0 | 100 | 100 | 100 | 100 |
| | 30 | — | — | 1120 | 0 | 0 | 99 | 100 | 100 | 100 | 100 | 100 |
| | 60 | — | — | 1120 | 0 | 0 | 100 | 100 | 100 | 100 | 100 | 100 |

| | Application Rate (g a.i./ha) | | | | POLPY | | SETFA | | SETLU | |
|---|---|---|---|---|---|---|---|---|---|---|
| DAA | Cpd 2 | Atrazine | Glufosinate | Glyphosate | Obs | Exp | Obs | Exp | Obs | Exp |
| 14 | 30 | — | — | — | 20 | | 0 | | 0 | |
| | 60 | — | — | — | 40 | | 0 | | 0 | |
| | — | 1120 | — | — | 73 | | 0 | | 0 | |
| | — | — | 470 | — | 98 | | 99 | | 95 | |
| | — | — | — | 1120 | 84 | | 100 | | 97 | |
| | 60 | 1120 | — | — | 100* | 84 | 0 | 0 | 0 | 0 |
| | 30 | — | 470 | — | 88 | 98 | 98 | 99 | 83 | 95 |
| | 60 | — | 470 | — | 92 | 99 | 93 | 99 | 87 | 95 |
| | 30 | — | — | 1120 | 70 | 87 | 100 | 100 | 100* | 97 |
| | 60 | — | — | 1120 | 72 | 91 | 100 | 100 | 100* | 97 |
| 28 | 30 | — | — | — | 20 | | 0 | | 0 | |
| | 60 | — | — | — | 40 | | 0 | | 0 | |
| | — | 1120 | — | — | 83 | | 0 | | 0 | |
| | — | — | 470 | — | 98 | | 99 | | 63 | |
| | — | — | — | 1120 | 91 | | 100 | | 96 | |
| | 60 | 1120 | — | — | 100* | 90 | 0 | 0 | 0 | 0 |
| | 30 | — | 470 | — | 95 | 98 | 97 | 99 | 73* | 63 |
| | 60 | — | 470 | — | 92 | 99 | 93 | 99 | 50 | 63 |
| | 30 | — | — | 1120 | 98* | 93 | 100 | 100 | 97 | 96 |
| | 60 | — | — | 1120 | 92 | 95 | 100 | 100 | 100* | 96 |

As can be seen from the results in Table 6, a number of the observed results for the mixture treatments on weeds were greater than expected from the Colby Equation, which indicates synergistic activity of the mixtures. Synergy was particularly apparent in velvetleaf, Pennsylvania smartweed, and yellow crabgrass. In test species where a greater than additive response was less apparent, it was typically because the expected effect was already near 100% at the rates tested.

### Test 7

A field trial was conducted to evaluate the effects of mixtures of Compound 2 or Compound 6 with a commercial herbicide on corn (ZEAMD, Zea mays ssp. indentata) and several weed species. Corn seeds (hybrid ‘Pioneer 36B10’) were planted in late spring season, 3.8 cm deep in a clay loam soil having 2% organic matter and a pH of 6.6. Plots were 7.6 m long by 3.0 m wide with rows spaced 76 cm apart. Seeds were spaced 15 cm apart within the rows. The field was managed using conventional tillage practices. The plots were arranged in a randomized complete block design with each treatment being replicated three times. Treatments were applied preemergence on the day after planting using a backpack sprayer delivering a spray volume of 224 L/ha using a pressure of 207 kPa. Treatments consisted of Compound 2 or Compound 6 and the commercial herbicide S-metolachlor, a VLCFA inhibitor, alone and in combination, dissolved or suspended in water. Weed species present in the experimental plots in sufficient quantity to be evaluated included redroot pigweed (AMARE, Amaranthus retroflexus L.), jimsonweed (DATST, Datura stramonium L.), annual grasses (GGGAN, Gramineae), morningglory (IPOSS, Ipomoea L. spp.), Pennsylvania smartweed (POLPY, Polygonum pensylvanicum L.), and wild radish (RAPRA, Raphanus raphanistrum L.). The effects on the treated plants and untreated controls were recorded 14, 28 and 62 days after application. Wild radish was evaluated 14 and 28 days after application. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 7.

TABLE 7
Observed and Expected Results from Compound 2 or Compound 6 Alone and in
Combination with S-Metolachlor

| | Application Rate (g a.i./ha) | | | ZEAMD | | AMARE | | DATST | | GGGAN | |
|---|---|---|---|---|---|---|---|---|---|---|---|
| DAA | Cpd 2 | Cpd 6 | S-Metolachlor | Obs | Exp | Obs | Exp | Obs | Exp | Obs | Exp |
| 14 | 125 | — | — | 10 | | 97 | | 98 | | 33 | |
| | 250 | — | — | 35 | | 100 | | 98 | | 65 | |
| | 500 | — | — | 60 | | 100 | | 100 | | 67 | |
| | — | 125 | — | 2 | | 87 | | 87 | | 7 | |
| | — | 250 | — | 15 | | 98 | | 100 | | 53 | |
| | — | 500 | — | 27 | | 98 | | 95 | | 63 | |
| | — | — | 1000 | 10 | | 97 | | 65 | | 97 | |
| | 125 | — | 1000 | 17# | 19 | 100 | 100 | 98 | 99 | 98 | 98 |
| | 250 | — | 1000 | 42 | 42 | 100 | 100 | 100 | 99 | 100 | 99 |
| | 500 | — | 1000 | 67 | 64 | 100 | 100 | 100 | 100 | 100 | 99 |
| | — | 125 | 1000 | 8# | 12 | 100 | 100 | 95 | 95 | 100* | 97 |
| | — | 250 | 1000 | 22# | 24 | 100 | 100 | 100 | 100 | 97 | 98 |
| | — | 500 | 1000 | 43 | 34 | 100 | 100 | 100* | 98 | 100 | 99 |
| 28 | 125 | — | — | 5 | | 92 | | 98 | | 33 | |
| | 250 | — | — | 22 | | 100 | | 98 | | 48 | |
| | 500 | — | — | 57 | | 100 | | 100 | | 52 | |
| | — | 125 | — | 0 | | 82 | | 90 | | 2 | |
| | — | 250 | — | 8 | | 97 | | 100 | | 35 | |
| | — | 500 | — | 8 | | 98 | | 100 | | 52 | |
| | — | — | 1000 | 8 | | 78 | | 57 | | 93 | |
| | 125 | — | 1000 | 15 | 13 | 97 | 98 | 97 | 99 | 95 | 96 |
| | 250 | — | 1000 | 27 | 28 | 98 | 100 | 98 | 99 | 95 | 97 |
| | 500 | — | 1000 | 55# | 60 | 100 | 100 | 98 | 100 | 95 | 97 |
| | — | 125 | 1000 | 7 | 8 | 95 | 96 | 93 | 96 | 92 | 93 |
| | — | 250 | 1000 | 17 | 16 | 95 | 99 | 95 | 100 | 95 | 96 |
| | — | 500 | 1000 | 25 | 16 | 97 | 100 | 98 | 100 | 95 | 97 |
| 62 | 125 | — | — | 0 | | 80 | | 100 | | 0 | |
| | 250 | — | — | 0 | | — | | — | | 0 | |
| | 500 | — | — | 0 | | 100 | | 100 | | 0 | |
| | — | 125 | — | 0 | | 80 | | 75 | | 90 | |
| | — | 250 | — | 0 | | 70 | | 100 | | 0 | |
| | — | 500 | — | 0 | | 100 | | 90 | | 0 | |
| | — | — | 1000 | 0 | | 15 | | 0 | | 75 | |
| | 125 | — | 1000 | 0 | 0 | 90* | 83 | 100 | 100 | 90* | 75 |
| | 250 | — | 1000 | 0 | 0 | 95 | — | 95 | — | 88* | 75 |
| | 500 | — | 1000 | 13 | 0 | 100 | 100 | 93 | 100 | 93* | 75 |
| | — | 125 | 1000 | 0 | 0 | 88* | 83 | 63 | 75 | 70 | 98 |
| | — | 250 | 1000 | 0 | 0 | 88* | 75 | 65 | 100 | 75 | 75 |
| | — | 500 | 1000 | 0 | 0 | 100 | 100 | 95* | 90 | 90* | 75 |

| | Application Rate (g a.i./ha) | | | IPOSS | | POLPY | | RAPRA | |
|---|---|---|---|---|---|---|---|---|---|
| DAA | Cpd 2 | Cpd 6 | S-Metolachlor | Obs | Exp | Obs | Exp | Obs | Exp |
| 14 | 125 | — | — | 100 | | 77 | | 35 | |
| | 250 | — | — | 100 | | 95 | | 53 | |
| | 500 | — | — | 100 | | 97 | | 73 | |
| | — | 125 | — | 93 | | 40 | | 25 | |
| | — | 250 | — | 100 | | 83 | | 40 | |
| | — | 500 | — | 100 | | 93 | | 43 | |
| | — | — | 1000 | 48 | | 60 | | 40 | |
| | 125 | — | 1000 | 100 | 100 | 95* | 91 | 100* | 61 |
| | 250 | — | 1000 | 100 | 100 | 100* | 98 | 98* | 72 |
| | 500 | — | 1000 | 100 | 100 | 100 | 99 | 98* | 84 |
| | — | 125 | 1000 | 100* | 97 | 97* | 76 | 60* | 55 |
| | — | 250 | 1000 | 100 | 100 | 100* | 93 | 83* | 64 |
| | — | 500 | 1000 | 100 | 100 | 98 | 97 | 90* | 66 |
| 28 | 125 | — | — | 100 | | 70 | | — | |
| | 250 | — | — | 100 | | 93 | | 38 | |
| | 500 | — | — | 100 | | 97 | | 58 | |
| | — | 125 | — | 93 | | 45 | | 35 | |
| | — | 250 | — | 100 | | 80 | | 30 | |
| | — | 500 | — | 100 | | 88 | | 30 | |
| | — | — | 1000 | 50 | | 45 | | 15 | |
| | 125 | — | 1000 | 100 | 100 | 75 | 84 | 90 | — |
| | 250 | — | 1000 | 100 | 100 | 87 | 96 | 95* | 47 |
| | 500 | — | 1000 | 100 | 100 | 95 | 98 | 88* | 64 |
| | — | 125 | 1000 | 100* | 97 | 72* | 70 | 58* | 45 |
| | — | 250 | 1000 | 100 | 100 | 77 | 89 | 68* | 41 |
| | — | 500 | 1000 | 100 | 100 | 87 | 94 | 73* | 41 |
| 62 | 125 | — | — | 100 | | 40 | | — | |
| | 250 | — | — | — | | — | | — | |
| | 500 | — | — | 100 | | 100 | | — | |
| | — | 125 | — | 100 | | 75 | | — | |
| | — | 250 | — | 100 | | 55 | | — | |
| | — | 500 | — | 100 | | 100 | | — | |
| | — | — | 1000 | 13 | | 10 | | — | |
| | 125 | — | 1000 | 100 | 100 | 63* | 46 | — | |
| | 250 | — | 1000 | 100 | — | 88 | — | — | |
| | 500 | — | 1000 | 100 | 100 | 95 | 100 | — | |
| | — | 125 | 1000 | 100 | 100 | 75 | 78 | — | |
| | — | 250 | 1000 | 100 | 100 | 83* | 60 | — | |
| | — | 500 | 1000 | 100 | 100 | 95 | 100 | — | |

As can be seen from the results in Table 7, a number of the observed results for the mixture treatments on weeds were greater than expected from the Colby Equation, which indicates synergistic activity of the mixtures. Synergy was particularly apparent in redroot pigweed, Pennsylvania smartweed, wild radish and the annual grasses. In test species where a greater than additive response was less apparent, it was typically because the expected effect was already near 100% at the rates tested. In addition, a number of the observed results for the mixtures on corn were less than expected from the Colby Equation, which indicates safening activity of these mixtures. Less than additive responses occurred for both Compound 2 and Compound 6 with S-metolachlor.

### Test 8

A field trial was conducted to evaluate the effects of mixtures of Compound 2 with commercial herbicides on corn (ZEAMD, Zea mays ssp. indentata) and several weed species. Corn seeds (hybrid ‘Pioneer 31G96’) were planted in mid spring season, 3.8 cm deep in a clay loam soil having 2% organic matter and a pH of 6.6. Plots were 6.1 m long by 3.0 m wide with rows spaced 76 cm apart. Seeds were spaced 15 cm apart within the rows. The field was managed using conventional tillage practices. The plots were arranged in a randomized complete block design with each treatment being replicated three times. Treatments were applied preemergence on the day of planting using a backpack sprayer delivering a spray volume of 224 L/ha using a pressure of 207 kPa. Treatments consisted of Compound 2 and the commercial herbicides atrazine, a photosystem II inhibitor or S-metolachlor, a VLCFA inhibitor, alone and in combination, dissolved or suspended in water. Weed species present in the experimental plots in sufficient quantity to be evaluated included velvetleaf (ABUTH, Abutilon theophrasti Medik.), redroot pigweed (AMARE, Amaranthus retroflexus L.), common ragweed (AMBEL, Ambrosia artemisiifolia L.), common lambsquarters (CHEAL, Chenopodium album L.), jimsonweed (DATST, Datura stramonium L.), ivyleaf morningglory (IPOHE, Ipomoea hederacea (L.) Jacquin), Pennsylvania smartweed (POLPY, Polygonum pensylvanicum L.), and giant foxtail (SETFA, Setaria faberi Herrm.). The effects on the treated plants and untreated controls were recorded 19, 29 and 56 days after application. A few of the weed species could not be evaluated at every timing. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 8.

TABLE 8
Observed and Expected Results from Compound 2 Alone and in Combination with
Atrazine or S-Metolachlor

| | Application Rate (g a.i./ha) | | | ZEAMD | | ABUTH | | AMARE | | AMBEL | |
|---|---|---|---|---|---|---|---|---|---|---|---|
| DAA | Cpd 2 | Atrazine | S-Metolachlor | Obs | Exp | Obs | Exp | Obs | Exp | Obs | Exp |
| 19 | 50 | — | — | 2 | | 28 | | — | | 36 | |
| | 100 | — | — | 5 | | 45 | | — | | 73 | |
| | 150 | — | — | 8 | | 58 | | — | | 83 | |
| | — | 1680 | — | 5 | | 87 | | — | | 83 | |
| | — | — | 1870 | 0 | | 28 | | — | | 32 | |
| | 100 | 1680 | — | 7# | 10 | 96* | 93 | — | | 100* | 96 |
| | 50 | — | 1870 | 8 | 2 | 55* | 49 | — | | 77* | 56 |
| | 100 | — | 1870 | 13 | 5 | 72* | 61 | — | | 80 | 82 |
| | 150 | — | 1870 | 3# | 8 | 68 | 70 | — | | 92* | 89 |
| 29 | 50 | — | — | 5 | | 43 | | — | | 65 | |
| | 100 | — | — | 8 | | 68 | | — | | 88 | |
| | 150 | — | — | 13 | | 90 | | — | | 96 | |
| | — | 1680 | — | 2 | | 99 | | — | | 98 | |
| | — | — | 1870 | 3 | | 42 | | — | | 23 | |
| | 100 | 1680 | — | 7# | 10 | 100 | 100 | — | | 100 | 100 |
| | 50 | — | 1870 | 3# | 8 | 78* | 67 | — | | 86* | 73 |
| | 100 | — | 1870 | 13 | 11 | 87* | 82 | — | | 99* | 91 |
| | 150 | — | 1870 | 10# | 16 | 91 | 94 | — | | 99* | 97 |
| 56 | 50 | — | — | 0 | | 18 | | 45 | | 52 | |
| | 100 | — | — | 0 | | 60 | | 100 | | 90 | |
| | 150 | — | — | 0 | | 85 | | 100 | | 97 | |
| | — | 1680 | — | 3 | | 98 | | 100 | | 100 | |
| | — | — | 1870 | 5 | | 18 | | 100 | | 23 | |
| | 100 | 1680 | — | 3 | 3 | 99 | 99 | 100 | 100 | 100 | 100 |
| | 50 | — | 1870 | 2# | 5 | 32 | 33 | 100 | 100 | 62 | 63 |
| | 100 | — | 1870 | 10 | 5 | 57 | 67 | 100 | 100 | 93 | 92 |
| | 150 | — | 1870 | 0# | 5 | 62 | 88 | 100 | 100 | 92 | 97 |

| | Application Rate (g a.i./ha) | | | CHEAL | | DATST | | IPOHE | | POLPY | | SETFA | |
|---|---|---|---|---|---|---|---|---|---|---|---|---|---|
| DAA | Cpd 2 | Atrazine | S-Metolachlor | Obs | Exp | Obs | Exp | Obs | Exp | Obs | Exp | Obs | Exp |
| 19 | 50 | — | — | 75 | | 33 | | 58 | | 28 | | 33 | |
| | 100 | — | — | 100 | | 52 | | 78 | | 60 | | 40 | |
| | 150 | — | — | 100 | | 65 | | 83 | | 65 | | 43 | |
| | — | 1680 | — | 100 | | 53 | | 45 | | — | | 60 | |
| | — | — | 1870 | 45 | | 40 | | 10 | | — | | 93 | |
| | 100 | 1680 | — | 100 | 100 | 98* | 77 | 100* | 88 | — | | 63 | 76 |
| | 50 | — | 1870 | 90* | 86 | 83* | 60 | 88* | 63 | — | | 97 | 96 |
| | 100 | — | 1870 | — | | 100* | 71 | 97* | 81 | — | | 98* | 96 |
| | 150 | — | 1870 | 100 | 100 | 100* | 79 | 100* | 85 | — | | 100* | 96 |
| 29 | 50 | — | — | — | | 45 | | 72 | | 30 | | 32 | |
| | 100 | — | — | — | | 63 | | 97 | | 50 | | 42 | |
| | 150 | — | — | — | | 85 | | 96 | | 70 | | 47 | |
| | — | 1680 | — | — | | 100 | | 100 | | 100 | | 88 | |
| | — | — | 1870 | — | | 38 | | 25 | | 100 | | 100 | |
| | 100 | 1680 | — | — | | 100 | 100 | 100 | 100 | 100 | 100 | 87 | 93 |
| | 50 | — | 1870 | — | | 78* | 66 | 97* | 79 | 98 | 100 | 99 | 100 |
| | 100 | — | 1870 | — | | 97* | 77 | 100* | 98 | 100 | 100 | 100 | 100 |
| | 150 | — | 1870 | — | | 98* | 91 | 100* | 97 | 100 | 100 | 100 | 100 |
| 56 | 50 | — | — | 68 | | 65 | | 82 | | 55 | | 8 | |
| | 100 | — | — | 100 | | 90 | | 100 | | 75 | | 7 | |
| | 150 | — | — | 100 | | 100 | | 100 | | 95 | | 17 | |
| | — | 1680 | — | 100 | | 100 | | 95 | | 100 | | 67 | |
| | — | — | 1870 | 23 | | 52 | | 3 | | — | | 94 | |
| | 100 | 1680 | — | 100 | 100 | 100 | 100 | 100 | 100 | — | | 70 | 69 |
| | 50 | — | 1870 | 68 | 76 | 73 | 83 | 67 | 82 | — | | 95 | 95 |
| | 100 | — | 1870 | 100 | 100 | 96 | 95 | 100 | 100 | — | | 97* | 95 |
| | 150 | — | 1870 | 99 | 100 | 93 | 100 | 100 | 100 | — | | 99* | 95 |

As can be seen from the results in Table 8, a number of the observed results for the mixture treatments on weeds were greater than expected from the Colby Equation, which indicates synergistic activity of the mixtures. Synergy was particularly apparent in velvetleaf, common ragweed, jimsonweed, and ivyleaf morningglory. In test species where a greater than additive response was less apparent, it was typically because the expected effect was already near 100% at the rates tested. In addition, a number of the observed results for the mixtures on corn were less than expected from the Colby Equation, which indicates safening activity of these mixtures. Less than additive responses occurred for Compound 2 with both atrazine and S-metolachlor.

Test 9

A field trial was conducted to evaluate the effects of mixtures of Compound 2 with commercial herbicides on corn (ZEAMD, Zea mays ssp. indentata) and several weed species. Corn seeds (hybrid ‘Pioneer 34M91 RR’) were planted in mid spring season, about 3.8 cm deep in a silty clay loam soil having a pH of 6.7. Plots were 9.1 m long by 3.0 m. The field was managed using no-till practices. The plots were arranged in a randomized complete block design with each treatment being replicated three times. Treatments were applied to emerged weeds 24 days before corn planting using a backpack sprayer delivering a spray volume of 187 L/ha using a pressure of 158 kPa. Treatments consisted of Compound 2 and the commercial herbicides glyphosate, an EPSP synthase inhibitor, or paraquat, a photosystem I electron diverter, alone and in combination, dissolved or suspended in water. Compound 2 and paraquat treatments, alone and in combination, also included a surfactant. Glyphosate, alone and with Compound 2, included ammonium sulfate in the treatment mixture. Weed species present in the experimental plots in sufficient quantity to be evaluated included giant ragweed (AMBTR, Ambrosia trifida L.), shepherd's purse (CAPBP, Capsella bursa-pastoris (L.) Medik.), common lambsquarters (CHEAL, Chenopodium album L.), Canada horseweed (ERICA, Erigeron canadensis L.), bushy wallflower (ERYRE, Erysimum repandum L.), prickly lettuce (LACSE, Lactuca serriola L.), henbit deadnettle (LAMAM, Lamium amplexicaule L.), red deadnettle (LAMPU, Lamium purpureum L.), smallflower buttercup (RANAB, Ranunculus abortivus L.), common chickweed (STEME, Stellaria media (L.) Vill), and common dandelion (TAROF, Taraxacum officinale Weber ex Wiggers). The effects on the weeds in the treated plots and untreated control plots were recorded 7, 14, 23, 30 and 57 days after application. Most of the weed species could not be evaluated at every timing. Corn response was only evaluated 57 days after application. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 9.

TABLE 9
Observed and Expected Results from Compound 2 Alone and in Combination with
Glyphosate or Paraquat

| | Application Rate (g a.i./ha) | | | ZEAMD | | AMBTR | | CAPBP | | CHEAL | |
|---|---|---|---|---|---|---|---|---|---|---|---|
| DAA | Cpd 2 | Glyphosate | Paraquat | Obs | Exp | Obs | Exp | Obs | Exp | Obs | Exp |
| 7 | 100 | — | — | — | | 85 | | 23 | | | |
| | — | 1540 | — | — | | 25 | | 52 | | | |
| | — | — | 1150 | — | | 100 | | 89 | | | |
| | 100 | 1540 | — | — | | — | | 63 | 63 | | |
| | 100 | — | 1150 | — | | 100 | 100 | 89 | 92 | | |
| 14 | 100 | — | — | — | | 83 | | 17 | | | |
| | — | 1540 | — | — | | 77 | | 73 | | | |
| | — | — | 1150 | — | | 100 | | 85 | | | |
| | 100 | 1540 | — | — | | — | | 81* | 77 | | |
| | 100 | — | 1150 | — | | 98 | 100 | 95* | 87 | | |
| 23 | 100 | — | — | — | | — | | 7 | | | |
| | — | 1540 | — | — | | — | | 88 | | | |
| | — | — | 1150 | — | | — | | 77 | | | |
| | 100 | 1540 | — | — | | — | | 90 | 89 | | |
| | 100 | — | 1150 | — | | — | | 93* | 79 | | |
| 30 | 100 | — | — | — | | — | | 0 | | | |
| | — | 1540 | — | — | | — | | 98 | | | |
| | — | — | 1150 | — | | — | | 72 | | | |
| | 100 | 1540 | — | — | | — | | 100* | 98 | | |
| | 100 | — | 1150 | — | | — | | 93* | 72 | | |
| 57 | 100 | — | — | 0 | | 89 | | 0 | | 95 | |
| | — | 1540 | — | 0 | | 85 | | 100 | | 0 | |
| | — | — | 1150 | 0 | | 70 | | 93 | | 0 | |
| | 100 | 1540 | — | 0 | 0 | 80 | 98 | 100 | 100 | 98* | 95 |
| | 100 | — | 1150 | 0 | 0 | 97 | 97 | 99* | 93 | 95 | 95 |
| | Application Rate (g a.i./ha) | | | ERICA | | ERYRE | | LACSE | | LAMAM | |
| DAA | Cpd 2 | Glyphosate | Paraquat | Obs | Exp | Obs | Exp | Obs | Exp | Obs | Exp |
| 7 | 100 | — | — | 62 | | 20 | | 58 | | 22 | |
| | — | 1540 | — | 45 | | 63 | | 45 | | 25 | |
| | — | — | 1150 | 95 | | 98 | | 97 | | 93 | |
| | 100 | 1540 | — | 57 | 79 | 65 | 70 | 48 | 77 | 27 | 41 |
| | 100 | — | 1150 | 96 | 98 | 99 | 98 | 95 | 99 | 87 | 94 |
| 14 | 100 | — | — | 68 | | 3 | | 63 | | 27 | |
| | — | 1540 | — | 76 | | 74 | | 87 | | 37 | |
| | — | — | 1150 | 96 | | 94 | | 95 | | 84 | |
| | 100 | 1540 | — | 85 | 92 | 81* | 75 | 85 | 95 | 43 | 54 |
| | 100 | — | 1150 | 99 | 99 | 98* | 95 | 99 | 98 | 89 | 88 |
| 23 | 100 | — | — | 75 | | 3 | | 70 | | 50 | |
| | — | 1540 | — | 98 | | 89 | | 99 | | 79 | |
| | — | — | 1150 | 99 | | 98 | | 100 | | 85 | |
| | 100 | 1540 | — | 100 | 100 | 94* | 89 | 100 | 100 | 84 | 89 |
| | 100 | — | 1150 | 100 | 100 | 100* | 98 | 100 | 100 | 97* | 93 |
| 30 | 100 | — | — | 83 | | 0 | | 88 | | 65 | |
| | — | 1540 | — | 100 | | 100 | | 100 | | 95 | |
| | — | — | 1150 | 100 | | 100 | | 100 | | 73 | |
| | 100 | 1540 | — | 100 | 100 | 100 | 100 | 100 | 100 | 99 | 98 |
| | 100 | — | 1150 | 100 | 100 | 100 | 100 | 100 | 100 | 96* | 91 |
| 57 | 100 | — | — | 100 | | 0 | | 98 | | 89 | |
| | — | 1540 | — | 84 | | 100 | | 100 | | 66 | |
| | — | — | 1150 | 81 | | 80 | | 100 | | 81 | |
| | 100 | 1540 | — | 100 | 100 | 100 | 100 | 100 | 100 | 100* | 96 |
| | 100 | — | 1150 | 100 | 100 | 93* | 80 | 100 | 100 | 100* | 98 |
| | Application Rate (g a.i./ha) | | | LAMPU | | RANAB | | STEME | | TAROF | |
| DAA | Cpd 2 | Glyphosate | Paraquat | Obs | Exp | Obs | Exp | Obs | Exp | Obs | Exp |
| 7 | 100 | — | — | 45 | | 45 | | 22 | | 37 | |
| | — | 1540 | — | 55 | | 50 | | 42 | | 37 | |
| | — | — | 1150 | 79 | | 98 | | 99 | | 79 | |
| | 100 | 1540 | — | — | | 65 | 73 | 33 | 54 | 50 | 60 |
| | 100 | — | 1150 | 90* | 88 | — | | 99 | 99 | 82 | 87 |
| 14 | 100 | — | — | 23 | | 40 | | 13 | | 38 | |
| | — | 1540 | — | 60 | | 80 | | 84 | | 62 | |
| | — | — | 1150 | 80 | | 100 | | 99 | | 69 | |
| | 100 | 1540 | — | — | | 94* | 88 | 78 | 86 | 72 | 76 |
| | 100 | — | 1150 | 90* | 85 | 98 | 100 | 100 | 99 | 78 | 81 |
| 23 | 100 | — | — | 58 | | 60 | | 3 | | 60 | |
| | — | 1540 | — | 77 | | 95 | | 93 | | 83 | |
| | — | — | 1150 | 81 | | 100 | | 100 | | 61 | |
| | 100 | 1540 | — | — | | 100* | 98 | 94 | 94 | 84 | 93 |
| | 100 | — | 1150 | 97* | 92 | 100 | 100 | 100 | 100 | 89* | 84 |
| 30 | 100 | — | — | 65 | | 65 | | 0 | | 65 | |
| | — | 1540 | — | 79 | | 100 | | 100 | | 90 | |
| | — | — | 1150 | 70 | | 100 | | 100 | | 33 | |
| | 100 | 1540 | — | — | | 100 | 100 | 100 | 100 | 97 | 97 |
| | 100 | — | 1150 | 88 | 90 | 100 | 100 | 100 | 100 | 85* | 77 |
| 57 | 100 | — | — | — | | — | | 0 | | 84 | |
| | — | 1540 | — | 95 | | — | | 99 | | 88 | |
| | — | — | 1150 | — | | — | | 98 | | 0 | |
| | 100 | 1540 | — | — | | — | | 100 | 99 | 97 | 98 |
| | 100 | — | 1150 | 100 | | — | | 99 | 98 | 87* | 84 |

As can be seen from the results in Table 9, a number of the observed results for the mixture treatments on weeds were greater than expected from the Colby Equation, which indicates synergistic activity of the mixtures. Synergy was particularly apparent in shepherd's purse, bushy wallflower, and henbit deadnettle. In test species where a greater than additive response was less apparent, it was typically because the expected effect was already near 100% at the rates tested, especially at the later observation timings.

### Test 10

A field trial was conducted to evaluate the effects of mixtures of Compound 2 with commercial herbicides on corn (ZEAMD, Zea mays ssp. indentata) and several weed species. Corn seeds (hybrid ‘Pioneer 33P65 RR’) were planted in mid spring season, 2.5 cm deep in a silt loam soil. Plots were 9.1 m long by 3.0 m wide with rows spaced 76 cm apart. The field was managed using conventional tillage practices. The plots were arranged in a randomized complete block design with each treatment being replicated three times. Treatments were applied preemergence on the day after planting using a backpack sprayer delivering a spray volume of 168 L/ha using a pressure of 276 kPa. Treatments consisted of Compound 2 and the commercial herbicides atrazine, a photosystem II inhibitor, or S-metolachlor, a VLCFA inhibitor, alone and in combination, dissolved or suspended in water. Weed species present in the experimental plots in sufficient quantity to be evaluated included velvetleaf (ABUTH, Abutilon theophrasti Medik.), common waterhemp (AMATA, Amaranthus tamariscinus Nutt.), common ragweed (AMBEL, Ambrosia artemisiifolia L.), ivyleaf morningglory (IPOHE, Ipomoea hederacea (L.) Jacquin), giant foxtail (SETFA, Setaria faberi Herrm.), and common cocklebur (XANST, Xanthium strumarium ssp. strumarium L.). The effects on the treated plants and untreated controls were recorded 28 days after application. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 10.

TABLE 10
Observed and Expected Results from Compound 2 Alone and in Combination
with Atrazine or S-Metolachlor

| | Application Rate (g a.i./ha) | | | ZEAMD | | ABUTH | | AMATA | | AMBEL | |
|---|---|---|---|---|---|---|---|---|---|---|---|
| DAA | Cpd 2 | Atrazine | S-Metolachlor | Obs | Exp | Obs | Exp | Obs | Exp | Obs | Exp |
| 28 | 50 | — | — | 0 | | 7 | | 20 | | 5 | |
| | 100 | — | — | 0 | | 7 | | 10 | | 5 | |
| | 150 | — | — | 0 | | 13 | | 23 | | 20 | |
| | — | 1680 | — | 0 | | 55 | | 83 | | 95 | |
| | — | — | 1870 | 0 | | 37 | | 70 | | 20 | |
| | 100 | 1680 | — | 0 | 0 | 20 | 58 | 30 | 85 | 60 | 95 |
| | 50 | — | 1870 | 0 | 0 | 20 | 41 | 57 | 76 | 35* | 24 |
| | 100 | — | 1870 | 0 | 0 | 33 | 41 | 92* | 73 | 65* | 24 |
| | 150 | — | 1870 | 0 | 0 | 30 | 45 | 63 | 77 | 55* | 36 |

| | Application Rate (g a.i./ha) | | | IPOHE | | SETFA | | XANST | |
|---|---|---|---|---|---|---|---|---|---|
| DAA | Cpd 2 | Atrazine | S-Metolachlor | Obs | Exp | Obs | Exp | Obs | Exp |
| 28 | 50 | — | — | 13 | | 13 | | 10 | |
| | 100 | — | — | 5 | | 7 | | 7 | |
| | 150 | — | — | 20 | | 20 | | 27 | |
| | — | 1680 | — | 37 | | 23 | | 40 | |
| | — | — | 1870 | 23 | | 63 | | 30 | |
| | 100 | 1680 | — | 23 | 40 | 27 | 28 | 27 | 44 |
| | 50 | — | 1870 | 27 | 34 | 60 | 68 | 27 | 37 |
| | 100 | — | 1870 | 67* | 27 | 63 | 66 | 40* | 35 |
| | 150 | — | 1870 | 47* | 39 | 73* | 71 | 37 | 49 |

As can be seen from the results in Table 10, a number of the observed results for the mixtures of Compound 2 with S-metolachlor on weeds were greater than expected from the Colby Equation, which indicates synergistic activity of this mixture. Synergy was particularly apparent in common ragweed and ivyleaf morningglory.

### Test 11

A field trial was conducted to evaluate the effects of mixtures of Compound 2 or Compound 1 with commercial herbicides on flint corn (ZEAMI, Zea mays L. ssp. indurata) and several weed species. Corn seeds (hybrid ‘Pioneer 3041’) were planted in mid spring season, 5 cm deep in a clay soil having 2.6% organic matter and a pH of 5.6. Plots were 8 m long by 1.5 m wide with rows spaced 80 cm apart. Seeds were spaced 15 cm apart within the rows. The field was managed using conventional tillage practices. The plots were arranged in a randomized complete block design in an unreplicated test. Treatments were applied preemergence on the day of planting using a backpack sprayer delivering a spray volume of 250 L/ha using a pressure of 207 kPa. Treatments consisted of Compound 2 or

Compound 1 and the commercial herbicides atrazine, a photosystem II inhibitor, or metolachlor, a VLCFA inhibitor, alone and in combination, dissolved or suspended in water. Weed species present in the experimental plots in sufficient quantity to be evaluated included common blackjack (BIDPI, Bidens pilosa L.), Surinam grass (BRADC, Brachiaria decumbens Stapf.), alexandergrass (BRAPL, Brachiaria plantaginea (Link) Hitchc.), southern sandbur (CCHEC, Cenchrus echinatus L.), tropical spiderwort (COMBE, Commelina benghalensis L.), Brazilian crabgrass (DIGHO, Digitaria horizontalis Willd.), goosegrass (ELEIN, Eleusine indica (L.) Gaertn.), Ipomoea grandiflora (IPOGF, Ipomoea grandiflora Lam./Roem. & Schult.), and arrowleaf sida (SIDRH, Sida rhombifolia L.). The effects on the treated plants and untreated controls were recorded 16, 30, 44, 62 and 91 days after application. Goosegrass was not evaluated 16 or 91 days after application. Plants were visually evaluated compared to controls for response to the treatments using a scale of 0 to 100 where 0 is no effect and 100 is complete control. Colby's Equation was used to determine the herbicidal effects expected from the mixtures. The results and additive effects expected from Colby's Equation are listed in Table 11.

TABLE 11
Observed and Expected Results from Compound 2 or Compound 1 Alone and in
Combination with Atrazine or Metolachlor

| | Application Rate (g a.i./ha) | | | | ZEAMI | | BIDPI | | BRADC | | BRAPL | |
|---|---|---|---|---|---|---|---|---|---|---|---|---|
| DAA | Cpd 2 | Cpd 1 | Atrazine | Metolachlor | Obs | Exp | Obs | Exp | Obs | Exp | Obs | Exp |
| 16 | 62 | — | — | — | 5 | | 20 | | 40 | | 40 | |
| | 125 | — | — | — | 10 | | 60 | | 60 | | 70 | |
| | — | — | 1500 | — | 0 | | 100 | | 40 | | 75 | |
| | — | — | — | 2500 | 30 | | 40 | | 97 | | 97 | |
| | 125 | — | 1500 | — | 10 | 10 | 100 | 100 | 50 | 76 | 60 | 93 |
| | 62 | — | — | 2500 | 15# | 34 | 70* | 52 | 100* | 98 | 100* | 98 |
| | 125 | — | — | 2500 | 25# | 37 | 80* | 76 | 100 | 99 | 100 | 99 |
| | — | 62 | — | — | 10 | | 60 | | 20 | | 40 | |
| | — | 125 | — | — | 15 | | 80 | | 40 | | 40 | |
| | — | 62 | 1500 | — | 15 | 10 | 100 | 100 | 40 | 52 | 60 | 85 |
| | — | 125 | 1500 | — | 15 | 15 | 90 | 100 | 50 | 64 | 60 | 85 |
| | — | 62 | — | 2500 | 40 | 37 | 75 | 76 | 97 | 98 | 95 | 98 |
| | — | 125 | — | 2500 | 35# | 41 | 80 | 88 | 100* | 98 | 97 | 98 |
| 30 | 62 | — | — | — | 0 | | 20 | | 40 | | 0 | |
| | 125 | — | — | — | 10 | | 40 | | 70 | | 75 | |
| | — | — | 1500 | — | 0 | | 97 | | 20 | | 50 | |
| | — | — | — | 2500 | 20 | | 40 | | 95 | | 90 | |
| | 125 | — | 1500 | — | 5# | 10 | 100* | 98 | 40 | 76 | 40 | 88 |
| | 62 | — | — | 2500 | 20 | 20 | 60* | 52 | 99* | 97 | 95* | 90 |
| | 125 | — | — | 2500 | 20# | 28 | 60 | 64 | 97 | 99 | 97 | 98 |
| | — | 62 | — | — | 0 | | 60 | | 20 | | 20 | |
| | — | 125 | — | — | 30 | | 80 | | 50 | | 60 | |
| | — | 62 | 1500 | — | 10 | 0 | 95 | 99 | 20 | 36 | 40 | 60 |
| | — | 125 | 1500 | — | 20# | 30 | 90 | 99 | 75* | 60 | 40 | 80 |
| | — | 62 | — | 2500 | 25 | 20 | 60 | 76 | 97 | 96 | 90 | 92 |
| | — | 125 | — | 2500 | 30# | 44 | 85 | 88 | 97 | 98 | 95 | 96 |
| 44 | 62 | — | — | — | 0 | | 20 | | 0 | | 0 | |
| | 125 | — | — | — | 20 | | 60 | | 60 | | 60 | |
| | — | — | 1500 | — | 0 | | 80 | | 0 | | 50 | |
| | — | — | — | 2500 | 25 | | 40 | | 90 | | 90 | |
| | 125 | — | 1500 | — | 20 | 20 | 100* | 92 | 40 | 60 | 40 | 80 |
| | 62 | — | — | 2500 | 25 | 25 | 60* | 52 | 90 | 90 | 80 | 90 |
| | 125 | — | — | 2500 | 30# | 40 | 60 | 76 | 90 | 96 | 80 | 96 |
| | — | 62 | — | — | 0 | | 40 | | 0 | | 0 | |
| | — | 125 | — | — | 25 | | 80 | | 40 | | 40 | |
| | — | 62 | 1500 | — | 0 | 0 | 90* | 88 | 0 | 0 | 40 | 50 |
| | — | 125 | 1500 | — | 20# | 25 | 80 | 96 | 50* | 40 | 40 | 70 |
| | — | 62 | — | 2500 | 20# | 25 | 40 | 64 | 90 | 90 | 80 | 90 |
| | — | 125 | — | 2500 | 25# | 44 | 75 | 88 | 90 | 94 | 80 | 94 |
| 62 | 62 | — | — | — | 0 | | 0 | | 0 | | 0 | |
| | 125 | — | — | — | 10 | | 40 | | 0 | | 0 | |
| | — | — | 1500 | — | 0 | | 70 | | 0 | | 0 | |
| | — | — | — | 2500 | 20 | | 0 | | 60 | | 60 | |
| | 125 | — | 1500 | — | 10 | 10 | 90* | 82 | 0 | 0 | 0 | 0 |
| | 62 | — | — | 2500 | 13# | 20 | 40* | 0 | 85* | 60 | 65* | 60 |
| | 125 | — | — | 2500 | 20# | 28 | 40 | 40 | 90* | 60 | 70* | 60 |
| | — | 62 | — | — | 0 | | 40 | | 0 | | 0 | |
| | — | 125 | — | — | 15 | | 60 | | 0 | | 0 | |
| | — | 62 | 1500 | — | 10 | 0 | 60 | 82 | 0 | 0 | 0 | 0 |
| | — | 125 | 1500 | — | 10# | 15 | 60 | 88 | 0 | 0 | 0 | 0 |
| | — | 62 | — | 2500 | 15# | 20 | 20 | 40 | 95* | 60 | 80* | 60 |
| | — | 125 | — | 2500 | 20# | 32 | 50 | 60 | 90* | 60 | 90* | 60 |
| 91 | 62 | — | — | — | 0 | | 0 | | 0 | | 0 | |
| | 125 | — | — | — | 10 | | 40 | | 0 | | 0 | |
| | — | — | 1500 | — | 0 | | 40 | | 0 | | 0 | |
| | — | — | — | 2500 | 20 | | 0 | | 40 | | 40 | |
| | 125 | — | 1500 | — | 0# | 10 | 95* | 64 | 0 | 0 | 0 | 0 |
| | 62 | — | — | 2500 | 10# | 20 | 0 | 0 | 75* | 40 | 50* | 40 |
| | 125 | — | — | 2500 | 30 | 28 | 40 | 40 | 90* | 40 | 50* | 40 |
| | — | 62 | — | — | 0 | | 0 | | 0 | | 0 | |
| | — | 125 | — | — | 15 | | 70 | | 0 | | 0 | |
| | — | 62 | 1500 | — | 0 | 0 | 60* | 40 | 0 | 0 | 0 | 0 |
| | — | 125 | 1500 | — | 0# | 15 | 60 | 82 | 0 | 0 | 0 | 0 |
| | — | 62 | — | 2500 | 0# | 20 | 0 | 0 | 40 | 40 | 40 | 40 |
| | — | 125 | — | 2500 | 15# | 32 | 40 | 70 | 40 | 40 | 40 | 40 |

| | Application Rate (g a.i./ha) | | | | CCHEC | | COMBE | | DIGHO | |
|---|---|---|---|---|---|---|---|---|---|---|
| DAA | Cpd 2 | Cpd 1 | Atrazine | Metolachlor | Obs | Exp | Obs | Exp | Obs | Exp |
| 16 | 62 | — | — | — | 0 | | 40 | | 0 | |
| | 125 | — | — | — | 40 | | 60 | | 40 | |
| | — | — | 1500 | — | 60 | | 99 | | 60 | |
| | — | — | — | 2500 | 95 | | 100 | | 100 | |
| | 125 | — | 1500 | — | 60 | 76 | 100 | 100 | 60 | 76 |
| | 62 | — | — | 2500 | 100* | 95 | 100 | 100 | 100 | 100 |
| | 125 | — | — | 2500 | 100* | 97 | 100 | 100 | 100 | 100 |
| | — | 62 | — | — | 40 | | 40 | | 0 | |
| | — | 125 | — | — | 40 | | 60 | | 0 | |
| | — | 62 | 1500 | — | 50 | 76 | 100 | 99 | 60 | 60 |
| | — | 125 | 1500 | — | 50 | 76 | 100 | 100 | 50 | 60 |
| | — | 62 | — | 2500 | 95 | 97 | 100 | 100 | 100 | 100 |
| | — | 125 | — | 2500 | 95 | 97 | 100 | 100 | 100 | 100 |
| 30 | 62 | — | — | — | 0 | | 40 | | 0 | |
| | 125 | — | — | — | 40 | | 60 | | 40 | |
| | — | — | 1500 | — | 40 | | 100 | | 40 | |
| | — | — | — | 2500 | 97 | | 100 | | 100 | |
| | 125 | — | 1500 | — | 40 | 64 | 100 | 100 | 40 | 64 |
| | 62 | — | — | 2500 | 99* | 97 | 100 | 100 | 100 | 100 |
| | 125 | — | — | 2500 | 95 | 98 | 100 | 100 | 100 | 100 |
| | — | 62 | — | — | 20 | | 60 | | 0 | |
| | — | 125 | — | — | 20 | | 95 | | 20 | |
| | — | 62 | 1500 | — | 40 | 52 | 100 | 100 | 0 | 40 |
| | — | 125 | 1500 | — | 40 | 52 | 100 | 100 | 0 | 52 |
| | — | 62 | — | 2500 | 97 | 98 | 100 | 100 | 100 | 100 |
| | — | 125 | — | 2500 | 97 | 98 | 100 | 100 | 100 | 100 |
| 44 | 62 | — | — | — | 0 | | 40 | | 0 | |
| | 125 | — | — | — | 0 | | 60 | | 0 | |
| | — | — | 1500 | — | 40 | | 100 | | 20 | |
| | — | — | — | 2500 | 97 | | 100 | | 100 | |
| | 125 | — | 1500 | — | 40 | 40 | 100 | 100 | 40* | 20 |
| | 62 | — | — | 2500 | 80 | 97 | 100 | 100 | 100 | 100 |
| | 125 | — | — | 2500 | 80 | 97 | 100 | 100 | 100 | 100 |
| | — | 62 | — | — | 0 | | 60 | | 0 | |
| | — | 125 | — | — | 40 | | 95 | | 20 | |
| | — | 62 | 1500 | — | 40 | 40 | 100 | 100 | 20 | 20 |
| | — | 125 | 1500 | — | 40 | 64 | 100 | 100 | 20 | 36 |
| | — | 62 | — | 2500 | 90 | 97 | 100 | 100 | 100 | 100 |
| | — | 125 | — | 2500 | 90 | 98 | 100 | 100 | 100 | 100 |
| 62 | 62 | — | — | — | 0 | | 0 | | 0 | |
| | 125 | — | — | — | 0 | | 40 | | 0 | |
| | — | — | 1500 | — | 0 | | 97 | | 0 | |
| | — | — | — | 2500 | 80 | | 100 | | 100 | |
| | 125 | — | 1500 | — | 0 | 0 | 100* | 98 | 0 | 0 |
| | 62 | — | — | 2500 | 75 | 80 | 100 | 100 | 100 | 100 |
| | 125 | — | — | 2500 | 75 | 80 | 100 | 100 | 100 | 100 |
| | — | 62 | — | — | 0 | | 40 | | 0 | |
| | — | 125 | — | — | 0 | | 60 | | 0 | |
| | — | 62 | 1500 | — | 40* | 0 | 100* | 98 | 40* | 0 |
| | — | 125 | 1500 | — | 40* | 0 | 97 | 99 | 40* | 0 |
| | — | 62 | — | 2500 | 70 | 80 | 100 | 100 | 100 | 100 |
| | — | 125 | — | 2500 | 70 | 80 | 100 | 100 | 100 | 100 |
| 91 | 62 | — | — | — | 0 | | 0 | | 0 | |
| | 125 | — | — | — | 0 | | 40 | | 0 | |
| | — | — | 1500 | — | 0 | | 95 | | 0 | |
| | — | — | — | 2500 | 100 | | 100 | | 95 | |
| | 125 | — | 1500 | — | 40* | 0 | 100* | 97 | 0 | 0 |
| | 62 | — | — | 2500 | 40 | 100 | 100 | 100 | 97* | 95 |
| | 125 | — | — | 2500 | 40 | 100 | 100 | 100 | 97* | 95 |
| | — | 62 | — | — | 0 | | 0 | | 0 | |
| | — | 125 | — | — | 0 | | 70 | | 0 | |
| | — | 62 | 1500 | — | 0 | 0 | 100* | 95 | 0 | 0 |
| | — | 125 | 1500 | — | 0 | 0 | 95 | 99 | 0 | 0 |
| | — | 62 | — | 2500 | 60 | 100 | 100 | 100 | 90 | 95 |
| | — | 125 | — | 2500 | 60 | 100 | 100 | 100 | 95 | 95 |

| | Application Rate (g a.i./ha) | | | | ELEIN | | IPOGF | | SIDRH | |
|---|---|---|---|---|---|---|---|---|---|---|
| DAA | Cpd 2 | Cpd 1 | Atrazine | Metolachlor | Obs | Exp | Obs | Exp | Obs | Exp |
| 16 | 62 | — | — | — | — | | 0 | | 20 | |
| | 125 | — | — | — | — | | 40 | | 40 | |
| | — | — | 1500 | — | — | | 97 | | 97 | |
| | — | — | — | 2500 | — | | 70 | | 90 | |
| | 125 | — | 1500 | — | — | | 97 | 98 | 97 | 98 |
| | 62 | — | — | 2500 | — | | 75* | 70 | 95* | 92 |
| | 125 | — | — | 2500 | — | | 75 | 82 | 95 | 94 |
| | — | 62 | — | — | — | | 20 | | 40 | |
| | — | 125 | — | — | — | | 40 | | 75 | |
| | — | 62 | 1500 | — | — | | 100* | 98 | 97 | 98 |
| | — | 125 | 1500 | — | — | | 97 | 98 | 90 | 99 |
| | — | 62 | — | 2500 | — | | 80* | 76 | 80 | 94 |
| | — | 125 | — | 2500 | — | | 95* | 82 | 90 | 98 |
| 30 | 62 | — | — | — | 0 | | 40 | | 40 | |
| | 125 | — | — | — | 20 | | 60 | | 70 | |
| | — | — | 1500 | — | 95 | | 97 | | 100 | |
| | — | — | — | 2500 | 100 | | 60 | | 80 | |
| | 125 | — | 1500 | — | 100* | 96 | 95 | 99 | 100 | 100 |
| | 62 | — | — | 2500 | 100 | 100 | 70 | 76 | 95* | 88 |
| | 125 | — | — | 2500 | 100 | 100 | 75 | 84 | 97* | 94 |
| | — | 62 | — | — | 0 | | 40 | | 60 | |
| | — | 125 | — | — | 20 | | 80 | | 65 | |
| | — | 62 | 1500 | — | 100* | 95 | 95 | 98 | 100 | 100 |
| | — | 125 | 1500 | — | 100* | 96 | 95 | 99 | 100 | 100 |
| | — | 62 | — | 2500 | 100 | 100 | 70 | 76 | 90 | 92 |
| | — | 125 | — | 2500 | 100 | 100 | 97* | 92 | 100* | 93 |
| 44 | 62 | — | — | — | 0 | | 0 | | 40 | |
| | 125 | — | — | — | 0 | | 50 | | 75 | |
| | — | — | 1500 | — | 100 | | 70 | | 95 | |
| | — | — | — | 2500 | 100 | | 40 | | 60 | |
| | 125 | — | 1500 | — | 100 | 100 | 80 | 85 | 97 | 99 |
| | 62 | — | — | 2500 | 100 | 100 | 60* | 40 | 96* | 76 |
| | 125 | — | — | 2500 | 100 | 100 | 60 | 70 | 97* | 90 |
| | — | 62 | — | — | 0 | | 60 | | 75 | |
| | — | 125 | — | — | 0 | | 80 | | 95 | |
| | — | 62 | 1500 | — | 100 | 100 | 80 | 88 | 95 | 99 |
| | — | 125 | 1500 | — | 100 | 100 | 80 | 94 | 95 | 100 |
| | — | 62 | — | 2500 | 100 | 100 | 60 | 76 | 60 | 90 |
| | — | 125 | — | 2500 | 100 | 100 | 95* | 88 | 99 | 98 |
| 62 | 62 | — | — | — | 0 | | 0 | | 0 | |
| | 125 | — | — | — | 0 | | 0 | | 40 | |
| | — | — | 1500 | — | 100 | | 50 | | 80 | |
| | — | — | — | 2500 | 100 | | 40 | | 70 | |
| | 125 | — | 1500 | — | 100 | 100 | 40 | 50 | 90* | 88 |
| | 62 | — | — | 2500 | 100 | 100 | 40 | 40 | 75* | 70 |
| | 125 | — | — | 2500 | 100 | 100 | 40 | 40 | 80 | 82 |
| | — | 62 | — | — | 0 | | 0 | | 40 | |
| | — | 125 | — | — | 0 | | 75 | | 95 | |
| | — | 62 | 1500 | — | 100 | 100 | 60* | 50 | 85 | 88 |
| | — | 125 | 1500 | — | 100 | 100 | 60 | 88 | 80 | 99 |
| | — | 62 | — | 2500 | 100 | 100 | 60* | 40 | 75 | 82 |
| | — | 125 | — | 2500 | 100 | 100 | 95* | 85 | 100 | 99 |
| 91 | 62 | — | — | — | — | | 0 | | 0 | |
| | 125 | — | — | — | — | | 0 | | 40 | |
| | — | — | 1500 | — | — | | 40 | | 90 | |
| | — | — | — | 2500 | — | | 40 | | 90 | |
| | 125 | — | 1500 | — | — | | 40 | 40 | 90 | 94 |
| | 62 | — | — | 2500 | — | | 40 | 40 | 85 | 90 |
| | 125 | — | — | 2500 | — | | 40 | 40 | 90 | 94 |
| | — | 62 | — | — | — | | 0 | | 0 | |
| | — | 125 | — | — | — | | 60 | | 100 | |
| | — | 62 | 1500 | — | — | | 40 | 40 | 75 | 90 |
| | — | 125 | 1500 | — | — | | 40 | 76 | 75 | 100 |
| | — | 62 | — | 2500 | — | | 40 | 40 | 80 | 90 |
| | — | 125 | — | 2500 | — | | 90* | 76 | 100 | 100 |

As can be seen from the results in Table 11, a number of the observed results for the mixtures on weeds were greater than expected from the Colby Equation, which indicates synergistic activity of these mixtures. Synergy was apparent with both atrazine and metolachlor, particularly with Compound 2, but also with Compound 1 especially at the 62 DAA evaluation. In test species where a greater than additive response was less apparent, it was typically because the expected effect was already near 100% at the rates tested. In addition, a number of the observed results for the mixtures on corn were less than expected from the Colby Equation, which indicates safening activity of these mixtures. Less than additive responses occurred for Compound 2 and Compound 1 with both atrazine and metolachlor.

### Test 12

A field trial was conducted to evaluate the effects of mixtures of Compound 2 or Compound 1 with a commercial herbicide on flint corn (ZEAMI, Zea mays L. ssp. indurata), common sugarcane (SACOF, Saccharum officinarum L.) and several weed species. In early-mid spring season, corn seeds (hybrid ‘Pioneer 3041’) were planted 5 cm deep and sugarcane nodes (variety RB-72.454) were planted 10 cm deep in separate plots in a clay soil having 2.6% organic matter and a pH of 5.6. Plots were 24 m long by 1.5 m wide with rows spaced 80 cm (corn) or 140 cm (sugarcane) apart. Corn seeds were spaced 15 cm apart and sugarcane nodes were spaced 10 cm apart within the rows. At the same time, weed seeds were broadcast over the surface of separate plots without a crop, one weed species per plot. The weed plots were rotary tilled to incorporate the weed seeds to a variety of depths. The field was managed using conventional tillage practices. The plots were arranged in a randomized complete block design in an unreplicated test. Treatments were applied preemergence on the day of planting using a backpack sprayer delivering a spray volume of 250 L/ha using a pressure of 207 kPa. Treatments consisted of Compound 2 or Compound 1 and the commercial herbicide diuron, a photosystem II inhibitor, alone and in combination, dissolved or suspended in water. Weed species present in the experimental plots in sufficient quantity to be evaluated included slender amaranth (AMAVI, Amaranthus viridis L.), common blackjack (BIDPI, Bidens pilosa L.), broadleaf buttonweed (BOILF, Borreria latifolia Schumacher), sicklepod (CASOB, Cassia obtusifolia L.), tropical spiderwort (COMBE, Commelina benghalensis L.), Florida beggarweed (DEDTO, Desmodium tortuosum (Sweet) DC.), wild poinsettia (EPHHL, Euphorbia heterophylla L.), wild spikenard (HPYSU, Hyptis suaveolens (L.) Poit.), Ipomoea grandiflora (IPOGF, Ipomoea grandiflora Lam./Roem. & Schult.), common purslane (POROL, Portulaca oleracea L.), arrowleaf sida (SIDRH, Sida rhombifolia L.), and Italian cocklebur (XANSI, Xanthium strumarium ssp. italicum (Mor.) D. Loeve). The effects on the treated plants and untreated controls were recorded 15, 29, 48 and 61 days after application. Plants were visually evaluated compared to controls for response to the treatments using a scale of 0 to 100 where 0 is no effect and 100 is complete control. Colby's Equation was used to determine the herbicidal effects expected from the mixtures. The results and additive effects expected from Colby's Equation are listed in Table 12.

TABLE 12
Observed and Expected Results from Compound 2 or Compound 1 Alone and in
Combination with Diuron

| | Application Rate | | | | | | | | | | |
|---|---|---|---|---|---|---|---|---|---|---|---|
| | (g a.i./ha) | | | SACOF | | ZEAMI | | AMAVI | | BIDPI | |
| DAA | Cpd 2 | Cpd 1 | Diuron | Obs | Exp | Obs | Exp | Obs | Exp | Obs | Exp |
| 15 | 62 | — | — | 0 | | 15 | | 90 | | 60 | |
| | — | 62 | — | 0 | | 0 | | 90 | | 70 | |
| | — | — | 2000 | 0 | | 20 | | 100 | | 100 | |
| | 62 | — | 2000 | 0 | 0 | 10# | 32 | 100 | 100 | 100 | 100 |
| | — | 62 | 2000 | 0 | 0 | 10# | 20 | 100 | 100 | 100 | 100 |
| 29 | 62 | — | — | 0 | | 10 | | 60 | | 80 | |
| | — | 62 | — | 0 | | 10 | | 60 | | 80 | |
| | — | — | 2000 | 0 | | 20 | | 100 | | 100 | |
| | 62 | — | 2000 | 10 | 0 | 25# | 28 | 100 | 100 | 100 | 100 |
| | — | 62 | 2000 | 0 | 0 | 25# | 28 | 100 | 100 | 100 | 100 |
| 48 | 62 | — | — | 0 | | 0 | | 40 | | 80 | |
| | — | 62 | — | 0 | | 20 | | 40 | | 80 | |
| | — | — | 2000 | 0 | | 20 | | 100 | | 100 | |
| | 62 | — | 2000 | 0 | 0 | 30 | 20 | 100 | 100 | 100 | 100 |
| | — | 62 | 2000 | 0 | 0 | 20# | 36 | 100 | 100 | 100 | 100 |
| 61 | 62 | — | — | 5 | | 15 | | 0 | | 70 | |
| | — | 62 | — | 5 | | 15 | | 40 | | 60 | |
| | — | — | 2000 | 5 | | 25 | | 100 | | 100 | |
| | 62 | — | 2000 | 0# | 10 | 20# | 36 | 100 | 100 | 100 | 100 |
| | — | 62 | 2000 | 5# | 10 | 25# | 36 | 100 | 100 | 100 | 100 |
| | Application Rate | | | | | | | | | | |
| | (g a.i./ha) | | | BOILF | | CASOB | | COMBE | | DEDTO | |
| DAA | Cpd 2 | Cpd 1 | Diuron | Obs | Exp | Obs | Exp | Obs | Exp | Obs | Exp |
| 15 | 62 | — | — | 70 | | 60 | | 50 | | 100 | |
| | — | 62 | — | 70 | | 60 | | 60 | | 95 | |
| | — | — | 2000 | 99 | | 90 | | 99 | | 100 | |
| | 62 | — | 2000 | 100 | 100 | 90 | 96 | 97 | 100 | 100 | 100 |
| | — | 62 | 2000 | 100 | 100 | 97 | 96 | 100 | 100 | 100 | 100 |
| 29 | 62 | — | — | 60 | | 80 | | 40 | | 70 | |
| | — | 62 | — | 60 | | 70 | | 40 | | 75 | |
| | — | — | 2000 | 100 | | 90 | | 100 | | 100 | |
| | 62 | — | 2000 | 100 | 100 | 95 | 98 | 100 | 100 | 100 | 100 |
| | — | 62 | 2000 | 100 | 100 | 100* | 97 | 100 | 100 | 100 | 100 |
| 48 | 62 | — | — | 95 | | 60 | | 40 | | 80 | |
| | — | 62 | — | 95 | | 90 | | 40 | | 60 | |
| | — | — | 2000 | 100 | | 60 | | 100 | | 100 | |
| | 62 | — | 2000 | 100 | 100 | 70 | 84 | 100 | 100 | 95 | 100 |
| | — | 62 | 2000 | 100 | 100 | 97 | 96 | 100 | 100 | 95 | 100 |
| 61 | 62 | — | — | 100 | | 50 | | 40 | | 60 | |
| | — | 62 | — | 95 | | 90 | | 0 | | 60 | |
| | — | — | 2000 | 95 | | 40 | | 100 | | 95 | |
| | 62 | — | 2000 | 100 | 100 | 75* | 70 | 100 | 100 | 70 | 98 |
| | — | 62 | 2000 | 99 | 100 | 95 | 94 | 100 | 100 | 90 | 98 |

| | Application Rate | | | | | | | | |
|---|---|---|---|---|---|---|---|---|---|
| | (g a.i./ha) | | | EPHHL | | HPYSU | | IPOGF | |
| DAA | Cpd 2 | Cpd 1 | Diuron | Obs | Exp | Obs | Exp | Obs | Exp |
| 15 | 62 | — | — | 40 | | 60 | | 50 | |
| | — | 62 | — | 40 | | 60 | | 60 | |
| | — | — | 2000 | 60 | | 75 | | 80 | |
| | 62 | — | 2000 | 60 | 76 | 90 | 90 | 90 | 90 |
| | — | 62 | 2000 | 60 | 76 | 97* | 90 | 80 | 92 |
| 29 | 62 | — | — | 60 | | 60 | | 60 | |
| | — | 62 | — | 70 | | 60 | | 70 | |
| | — | — | 2000 | 40 | | 60 | | 80 | |
| | 62 | — | 2000 | 80* | 76 | 97* | 84 | 97* | 92 |
| | — | 62 | 2000 | 60 | 82 | 95* | 84 | 90 | 94 |
| 48 | 62 | — | — | 40 | | 50 | | 40 | |
| | — | 62 | — | 50 | | 70 | | 60 | |
| | — | — | 2000 | 20 | | 40 | | 40 | |
| | 62 | — | 2000 | 50 | 52 | 90* | 70 | 75* | 64 |
| | — | 62 | 2000 | 60 | 60 | 90* | 82 | 60 | 76 |
| 61 | 62 | — | — | 40 | | 40 | | 40 | |
| | — | 62 | — | 40 | | 50 | | 40 | |
| | — | — | 2000 | 40 | | 20 | | 40 | |
| | 62 | — | 2000 | 50 | 64 | 70* | 52 | 50 | 64 |
| | — | 62 | 2000 | 50 | 64 | 80* | 60 | 60 | 64 |
| | Application Rate | | | | | | | | |
| | (g a.i./ha) | | | POROL | | SIDRH | | XANSI | |
| DAA | Cpd 2 | Cpd 1 | Diuron | Obs | Exp | Obs | Exp | Obs | Exp |
| 15 | 62 | — | — | 60 | | 40 | | 0 | |
| | — | 62 | — | 90 | | 60 | | 40 | |
| | — | — | 2000 | 100 | | 100 | | 60 | |
| | 62 | — | 2000 | 100 | 100 | 97 | 100 | 60 | 60 |
| | — | 62 | 2000 | 100 | 100 | 100 | 100 | 60 | 76 |
| 29 | 62 | — | — | 75 | | 90 | | 70 | |
| | — | 62 | — | 97 | | 95 | | 90 | |
| | — | — | 2000 | 100 | | 100 | | 40 | |
| | 62 | — | 2000 | 100 | 100 | 100 | 100 | 90* | 82 |
| | — | 62 | 2000 | 100 | 100 | 100 | 100 | 99* | 94 |
| 48 | 62 | — | — | 90 | | 70 | | 60 | |
| | — | 62 | — | 100 | | 100 | | 90 | |
| | — | — | 2000 | 100 | | 100 | | 40 | |
| | 62 | — | 2000 | 100 | 100 | 100 | 100 | 80* | 76 |
| | — | 62 | 2000 | 100 | 100 | 100 | 100 | 95 | 94 |
| 61 | 62 | — | — | 90 | | 60 | | 40 | |
| | — | 62 | — | 100 | | 95 | | 60 | |
| | — | — | 2000 | 100 | | 100 | | 40 | |
| | 62 | — | 2000 | 100 | 100 | 100 | 100 | 60 | 64 |
| | — | 62 | 2000 | 100 | 100 | 100 | 100 | 90* | 76 |

As can be seen from the results in Table 12, a number of the observed results for the mixtures on weeds were greater than expected from the Colby Equation, which indicates synergistic activity of these mixtures. Synergy was apparent with both Compound 2 and Compound 1, especially for wild spikenard and Italian cocklebur control. In test species where a greater than additive response was less apparent, it was typically because the expected effect was already near 100% at the rates tested. In addition, a number of the observed results for the mixtures on corn were less than expected from the Colby Equation, which indicates safening activity of these mixtures. Less than additive responses in corn occurred for both Compound 2 and Compound 1 with diuron. In sugarcane the expected effects were mostly 0 except at the 61 day evaluation when safening of the minor crop effect was observed.

### Test 13

A field trial was conducted to evaluate the effects of a mixture of Compound 2 with a commercial herbicide on several brush weed species. Plots were established in non-crop land and were 6.1 m long by 3.0 m wide. The plots were arranged in a randomized complete block design with each treatment being replicated three times. Treatments were applied postemergence to the brush weeds using a backpack sprayer delivering a spray volume of 468 L/ha using a pressure of 241 kPa. Treatments consisted of Compound 2 and the commercial herbicide fosamine-ammonium (b11), alone and in combination, dissolved or suspended in water. All treatments also included a surfactant. Weed species present in the experimental plots in sufficient quantity to be evaluated included mixed hardwoods (MXDSP) comprising black gum (Nyssa sylvatica Marsh), red maple (Acer rubrum L.) and sweet gum (Liquidambar styraciflua L.), and oak species (QUESS, Quercus L. spp.). The effects on the treated plants and untreated controls were recorded 56 days after application. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixture. The results and additive effects expected from Colby's Equation are listed in Table 13.

TABLE 13
Observed and Expected Results from Compound 2 Alone and
in Combination with Fosamine-ammonium

| | Application Rate (g a.i./ha) | | MXDSP | | QUESS | |
|---|---|---|---|---|---|---|
| DAA | Cpd 2 | Fosamine-ammonium | Obs | Exp | Obs | Exp |
| 56 | 250 | — | 45 | | 33 | |
| | — | 6700 | 47 | | 33 | |
| | 250 | 6700 | 88* | 71 | 88* | 56 |

As can be seen from the results in Table 13, the observed results for the mixture on the two groups of brush weeds evaluated were greater than expected from the Colby Equation, which indicates synergistic activity of the mixture.

### Test 14

A field trial was conducted to evaluate the effects of two- and three-way mixtures of Compound 2 with commercial herbicides on corn (ZEAMD, Zea mays ssp. indentata) and several weed species. Corn seeds (hybrid ‘Pioneer 31G96 RR’) were planted in mid spring season, 3.8 cm deep in a clay loam soil having 2% organic matter and a pH of 6.6. Plots were 6.1 m long by 3.0 m wide with rows spaced 76 cm apart. Seeds were spaced 15 cm apart within the rows. The field was managed using conventional tillage practices. The plots were arranged in a randomized complete block design with each treatment being replicated three times. Treatments were applied preemergence on the day of planting using a backpack sprayer delivering a spray volume of 224 L/ha using a pressure of 207 kPa. Treatments consisted of Compound 2 and the commercial herbicide rimsulfuron, an AHAS inhibitor, or S-metolachlor, a VLCFA inhibitor, alone and in two- and three-way combinations, dissolved or suspended in water. Weed species present in the experimental plots in sufficient quantity to be evaluated included velvetleaf (ABUTH, Abutilon theophrasti Medik.), common ragweed (AMBEL, Ambrosia artemisiifolia L.), giant ragweed (AMBTR, Ambrosia trifida L.), yellow nutsedge (CYPES, Cyperus esculentus L.), jimsonweed (DATST, Datura stramonium L.), ivyleaf morningglory (IPOHE, Ipomoea hederacea (L.) Jacquin), ladysthumb smartweed (POLPE, Polygonum persicaria L.), and giant foxtail (SETFA, Setaria faberi Herrm.). The effects on the treated plants and untreated controls were recorded 19, 28 and 56 days after application. Yellow nutsedge was only evaluated 19 and 28 days after application, and ivyleaf morningglory could only be evaluated 28 days after application. Plants were visually evaluated for growth inhibition compared to controls in response to the treatments using a scale of 0 to 100 where 0 is no effect and 100 is complete control. Results are the means of the three replicates. This growth inhibition data was converted to results in the form of “plant growth as a percent of control plant growth” using the calculation “100 minus growth inhibition”. Converted results are shown in Table 14 and are on a scale of 0 to 100 where 0 is complete control and 100 is no effect. The generalized form of Colby's Equation (Colby, S. R. “Calculating Synergistic and Antagonistic Responses of Herbicide Combinations,” Weeds, 15(1), pp 20-22 (1967)) that can be applied to mixtures having any number of components was used to determine the herbicidal effects expected from the mixtures. For “growth as a percent of control” data, Colby's Equation calculates the expected additive effect of herbicidal mixtures having two active ingredients as follows:

G_{a+b}=GₐG_{b}/100
wherein G_{a+b} is the growth as a percent of control of plants treated with the mixture expected from additive contribution of the individual components,
   Gₐ is the observed growth as a percent of control of plants treated with the first active ingredient at the same use rate as in the mixture, and
   G_{b} is the observed growth as a percent of control of plants treated with the second active ingredient at the same use rate as in the mixture.
      For mixtures having three active ingredients, Colby's Equation to calculate the expected additive effect of herbicidal mixtures is as follows:

G_{a+b+c}=GₐG_{b}G_{c}/10,000
wherein Gₐ and G_{b} are as defined above and
   G_{a+b+c} is the growth as a percent of control of plants treated with the mixture expected from additive contribution of the individual components, and
   G_{c} is the observed growth as a percent of control of plants treated with the third active ingredient at the same use rate as in the mixture.
      When these two forms of Colby's Equation are used, if the observed effects on weeds are less than the expected values, the mixture is synergistic. When the observed effects on crops are greater than the expected values, the mixture shows safening activity. The results and additive effects expected from Colby's Equation are listed in Table 14.

TABLE 14
Observed and Expected Results from Compound 2 Alone and in Combination
with Rimsulfuron and/or S-Metolachlor

| | Application Rate (g a.i./ha) | | | ZEAMD | ZEAMD | ABUTH | ABUTH | AMBEL | AMBEL |
|---|---|---|---|---|---|---|---|---|---|
| DAA | Cpd 2 | Rimsulfuron | S-Metolachlor | Obs | Exp | Obs | Exp | Obs | Exp |
| 19 | 75 | — | — | 97 | | 80 | | 75 | |
| | 100 | — | — | 95 | | 60 | | 55 | |
| | — | 12 | — | 98 | | 78 | | 88 | |
| | — | 24 | — | 98 | | 62 | | 80 | |
| | — | 36 | — | 93 | | 52 | | 68 | |
| | — | — | 1870 | 98 | | 68 | | 100 | |
| | 75 | 12 | — | 98# | 95 | 27* | 63 | 35* | 66 |
| | 75 | 24 | — | 98# | 95 | 37* | 49 | 23* | 60 |
| | 75 | 36 | — | 95# | 90 | 15* | 41 | 22* | 51 |
| | 100 | 12 | — | 93 | 93 | 40* | 47 | 38* | 49 |
| | 100 | 24 | — | 93 | 93 | 18* | 37 | 27* | 44 |
| | 100 | 36 | — | 93# | 89 | 12* | 31 | 25* | 38 |
| | 75 | — | 1870 | 97# | 95 | 22* | 55 | 15* | 75 |
| | 75 | 24 | 1870 | 95# | 93 | 0* | 34 | 2* | 60 |
| 28 | 75 | — | — | 95 | | 43 | | 20 | |
| | 100 | — | — | 93 | | 22 | | 15 | |
| | — | 12 | — | 100 | | 53 | | 100 | |
| | — | 24 | — | 100 | | 13 | | 45 | |
| | — | 36 | — | 98 | | 15 | | 33 | |
| | — | — | 1870 | 98 | | 6 | | 75 | |
| | 75 | 12 | — | 98# | 95 | 9* | 23 | 17* | 20 |
| | 75 | 24 | — | 92 | 95 | 11 | 6 | 11 | 9 |
| | 75 | 36 | — | 93 | 93 | 9 | 7 | 7 | 7 |
| | 100 | 12 | — | 87 | 93 | 10* | 12 | 9* | 15 |
| | 100 | 24 | — | 87 | 93 | 6 | 3 | 6 | 7 |
| | 100 | 36 | — | 85 | 92 | 5 | 3 | 6 | 5 |
| | 75 | — | 1870 | 93 | 93 | 14 | 2 | 12* | 15 |
| | 75 | 24 | 1870 | 95# | 93 | 2 | 0 | 2* | 7 |
| 56 | 75 | — | — | 100 | | 43 | | 17 | |
| | 100 | — | — | 100 | | 30 | | 12 | |
| | — | 12 | — | 100 | | 93 | | 85 | |
| | — | 24 | — | 100 | | 65 | | 63 | |
| | — | 36 | — | 100 | | 62 | | 53 | |
| | — | — | 1870 | 100 | | 87 | | 93 | |
| | 75 | 12 | — | 100 | 100 | 38* | 40 | 42 | 14 |
| | 75 | 24 | — | 100 | 100 | 53 | 28 | 37 | 11 |
| | 75 | 36 | — | 100 | 100 | 47 | 27 | 25 | 9 |
| | 100 | 12 | — | 100 | 100 | 65 | 28 | 25 | 10 |
| | 100 | 24 | — | 100 | 100 | 38 | 20 | 27 | 7 |
| | 100 | 36 | — | 100 | 100 | 22 | 19 | 17 | 6 |
| | 75 | — | 1870 | 100 | 100 | 47 | 38 | 32 | 16 |
| | 75 | 24 | 1870 | 100 | 100 | 12* | 24 | 20 | 10 |
| | Application Rate (g a.i./ha) | | | AMBTR | AMBTR | CYPES | CYPES | DATST | DATST |
| DAA | Cpd 2 | Rimsulfuron | S-Metolachlor | Obs | Exp | Obs | Exp | Obs | Exp |
| 19 | 75 | — | — | 65 | | 85 | | 93 | |
| | 100 | — | — | 73 | | 78 | | 73 | |
| | — | 12 | — | 88 | | 85 | | 100 | |
| | — | 24 | — | 80 | | 85 | | 93 | |
| | — | 36 | — | 75 | | 70 | | 85 | |
| | — | — | 1870 | 83 | | | | 100 | |
| | 75 | 12 | — | 45* | 57 | 68* | 72 | 60* | 93 |
| | 75 | 24 | — | 50* | 52 | 70* | 72 | 7* | 86 |
| | 75 | 36 | — | 42* | 49 | 60 | 60 | 37* | 79 |
| | 100 | 12 | — | 33* | 63 | 65* | 67 | 50* | 73 |
| | 100 | 24 | — | 28* | 58 | 63* | 67 | 38* | 68 |
| | 100 | 36 | — | 8* | 54 | 18* | 55 | 38* | 62 |
| | 75 | — | 1870 | 30* | 54 | 5 | 0 | 2* | 93 |
| | 75 | 24 | 1870 | 5* | 43 | 20 | | 0* | 86 |
| 28 | 75 | — | — | 100 | | 85 | | 32 | |
| | 100 | — | — | 23 | | 90 | | 30 | |
| | — | 12 | — | 100 | | 83 | | 100 | |
| | — | 24 | — | 60 | | 60 | | 62 | |
| | — | 36 | — | 60 | | 50 | | 48 | |
| | — | — | 1870 | 88 | | 8 | | 22 | |
| | 75 | 12 | — | 17* | 100 | 50* | 71 | 22* | 32 |
| | 75 | 24 | — | 18* | 60 | 65 | 51 | 30 | 20 |
| | 75 | 36 | — | 15* | 60 | 47 | 43 | 22 | 15 |
| | 100 | 12 | — | 15* | 23 | 47* | 75 | 25* | 30 |
| | 100 | 24 | — | 15 | 14 | 52* | 54 | 25 | 19 |
| | 100 | 36 | — | 2* | 14 | 40* | 45 | 17 | 15 |
| | 75 | — | 1870 | 60* | 88 | 5 | 6 | 7 | 7 |
| | 75 | 24 | 1870 | 10* | 53 | 2* | 4 | 2* | 4 |
| 56 | 75 | — | — | 20 | | — | | 0 | |
| | 100 | — | — | 18 | | — | | 5 | |
| | — | 12 | — | 90 | | — | | 100 | |
| | — | 24 | — | 83 | | — | | 92 | |
| | — | 36 | — | 68 | | — | | 92 | |
| | — | — | 1870 | 100 | | — | | 30 | |
| | 75 | 12 | — | 63 | 18 | — | | 55 | 0 |
| | 75 | 24 | — | 45 | 17 | — | | 75 | 0 |
| | 75 | 36 | — | 60 | 14 | — | | 73 | 0 |
| | 100 | 12 | — | 40 | 16 | — | | 42 | 5 |
| | 100 | 24 | — | 58 | 15 | — | | 48 | 5 |
| | 100 | 36 | — | 100 | 12 | — | | 50 | 5 |
| | 75 | — | 1870 | 51 | 20 | — | | 5 | 0 |
| | 75 | 24 | 1870 | 23 | 17 | — | | 5 | 0 |
| | Application Rate (g a.i./ha) | | | IPOHE | IPOHE | POLPE | POLPE | SETFA | SETFA |
| DAA | Cpd 2 | Rimsulfuron | S-Metolachlor | Obs | Exp | Obs | Exp | Obs | Exp |
| 19 | 75 | — | — | — | | 88 | | 58 | |
| | 100 | — | — | — | | 77 | | 48 | |
| | — | 12 | — | — | | 82 | | 32 | |
| | — | 24 | — | — | | 58 | | 33 | |
| | — | 36 | — | — | | 32 | | 7 | |
| | — | — | 1870 | — | | 100 | | 7 | |
| | 75 | 12 | — | — | | 32* | 72 | 18 | 18 |
| | 75 | 24 | — | — | | 37* | 51 | 10* | 19 |
| | 75 | 36 | — | — | | 5* | 28 | 5 | 4 |
| | 100 | 12 | — | — | | 33* | 63 | 18 | 15 |
| | 100 | 24 | — | — | | 12* | 44 | 10* | 16 |
| | 100 | 36 | — | — | | 13* | 24 | 8 | 3 |
| | 75 | — | 1870 | — | | 25* | 88 | 5 | 4 |
| | 75 | 24 | 1870 | — | | 0* | 51 | 0 | 1 |
| 28 | 75 | — | — | 0 | | 45 | | 68 | |
| | 100 | — | — | 0 | | 58 | | 67 | |
| | — | 12 | — | 100 | | 100 | | 33 | |
| | — | 24 | — | 3 | | 33 | | 9 | |
| | — | 36 | — | 43 | | 35 | | 5 | |
| | — | — | 1870 | 0 | | 53 | | 5 | |
| | 75 | 12 | — | 3 | 0 | 8* | 45 | 22 | 23 |
| | 75 | 24 | — | 0 | 0 | 18 | 15 | 20 | 6 |
| | 75 | 36 | — | 2 | 0 | 0* | 16 | 7 | 3 |
| | 100 | 12 | — | 0 | 0 | 7* | 58 | 22 | 22 |
| | 100 | 24 | — | 1 | 0 | 8* | 19 | 15 | 6 |
| | 100 | 36 | — | 0 | 0 | 2* | 20 | 6 | 3 |
| | 75 | — | 1870 | 0 | 0 | 17* | 24 | 0* | 3 |
| | 75 | 24 | 1870 | 0 | 0 | 2* | 8 | 0 | 0 |
| 56 | 75 | — | — | — | | 75 | | 92 | |
| | 100 | — | — | — | | 80 | | 97 | |
| | — | 12 | — | — | | 100 | | 70 | |
| | — | 24 | — | — | | — | | 40 | |
| | — | 36 | — | — | | — | | 28 | |
| | — | — | 1870 | — | | — | | 1 | |
| | 75 | 12 | — | — | | 30* | 75 | 68 | 64 |
| | 75 | 24 | — | — | | — | | 55 | 37 |
| | 75 | 36 | — | — | | 25 | | 23* | 26 |
| | 100 | 12 | — | — | | — | | 68 | 68 |
| | 100 | 24 | — | — | | — | | 45 | 39 |
| | 100 | 36 | — | — | | 45 | | 30 | 27 |
| | 75 | — | 1870 | — | | 85 | | 1 | 1 |
| | 75 | 24 | 1870 | — | | 13 | | 1 | 0 |

As can be seen from the results in Table 14, most of the observed results for the mixtures on weeds, especially at 19 and 28 days after application, were less than expected from the Colby Equation, which indicates synergistic activity of these mixtures. Synergy with Compound 2 was apparent with both rimsulfuron and S-metolachlor. The three-way mixture of Compound 2 plus rimsulfuron and S-metolachlor also resulted in less than expected results or synergy. In ivyleaf morningglory, where a less than additive response was not apparent, it was because the expected effect was already near 0% (complete control) at the rates tested. In addition, a number of the observed results for the mixtures on corn were greater than expected from the Colby Equation, which indicates safening activity of these mixtures. Greater than additive responses in corn occurred for mixtures of Compound 2 with rimsulfuron and/or S-metolachlor. The safening effect in corn was mainly observed at 19 days after application. Greater than additive responses were not observed in corn at 56 days after application because the expected effect was already 100% (no effect).

### Tests 15 to 18

Greenhouse tests were conducted to evaluate the effects on the weed velvetleaf (ABUTH, Abutilon theophrasti Medik.) of mixtures of Compound 2 with commercial or experimental herbicides having a primary site of action of protoporphyrinogen oxidase (PPO) inhibition. Velvetleaf seeds were planted in three soils: a silt loam having 3.9% organic matter and a pH of 5.3; a blend of a loam soil and sand having 1.3% organic matter and a pH of 6.4; and RediEarth, a commercial potting medium. Seeds were planted at 3 to 5 day intervals and grown in a greenhouse until they achieved the desired stage of growth for application. Plants were treated preemergence and postemergence at the 1-leaf, 2-leaf, and 4-leaf growth stages, and each treatment was replicated twice. Treatments were applied using a belt sprayer that delivered a spray volume of 457 L/ha using a pressure of 262 kPa. Treatments consisted of Compound 2 and the commercial herbicides oxyfluorfen, acifluorfen, flumioxazin, carfentrazone, and sulfentrazone, or the experimental herbicides, profluazol(1-chloro-N-[2-chloro-4-fluoro-5-[(6S,7aR)-6-fluorotetrahydro-1,3 -dioxo-1H-pyrrolo[1,2-c]imidazol-2(3H)-yl]phenyl]methanesulfonamide) and azafenidin(2-[2,4-dichloro-5-(2-propynyloxy)phenyl]-5,6,7,8-tetrahydro-1,2,4-triazole[4,3,-a]pyridine-3(2H)-one), alone and in combination, dissolved or suspended in water. After treatment, the plants were returned to a greenhouse where balanced supplemental lighting was used to maintain a 16-hour photoperiod and the daytime and nighttime temperatures were about 25° C. and 19° C., respectively. Plants were watered as needed. The effects on the treated plants and untreated controls were recorded approximately 14 days after application. Plants were visually evaluated compared to controls for response to the treatments using a scale of 0 to 100 where 0 is no effect and 100 is complete control. Results for postemergence treatments are the means of the two replicates, three soils and three growth stages. Results for preemergence treatments are the means of the two replicates and three soils. Colby's Equation was used to determine the herbicidal effects expected from the mixtures. The results and additive effects expected from Colby's Equation are listed in Tables 15 to 18.

TABLE 15
Observed and Expected Results from Compound 2 Alone and in
Combination with Oxyfluorfen or Profluazol (1-chloro-N-[2-
chloro-4-fluoro-5-[(6S,7aR)-6-fluorotetrahydro-1,3-dioxo-1H-
pyrrolo[1,2-c]imidazol-2(3H)-yl]phenyl]methane-sulfonamide).

| | | | | Postemergence | |
|---|---|---|---|---|---|
| | Application Rate (g a.i./ha) | | | ABUTH | ABUTH |
| DAA | Cpd 2 | Oxyfluorfen | Profluazol | Obs | Exp |
| 12 | 15 | — | — | 31 | |
| | 30 | — | — | 38 | |
| | 45 | — | — | 61 | |
| | — | 15 | — | 43 | |
| | — | 30 | — | 67 | |
| | — | 60 | — | 81 | |
| | — | — | 2 | 91 | |
| | — | — | 8 | 100 | |
| | — | — | 15 | 100 | |
| | 15 | 15 | — | 69* | 61 |
| | 15 | 30 | — | 79* | 77 |
| | 15 | 60 | — | 84 | 87 |
| | 30 | 15 | — | 81* | 65 |
| | 30 | 30 | — | 86* | 79 |
| | 30 | 60 | — | 89 | 89 |
| | 45 | 15 | — | 81* | 78 |
| | 45 | 30 | — | 86 | 87 |
| | 45 | 60 | — | 89 | 93 |
| | 15 | — | 2 | 95 | 94 |
| | 15 | — | 8 | 100 | 100 |
| | 30 | — | 2 | 99* | 94 |
| | 30 | — | 8 | 100 | 100 |
| | 45 | — | 2 | 96 | 96 |
| | 45 | — | 8 | 100 | 100 |
| | 45 | — | 15 | 100 | 100 |

As can be seen from the results in Table 15, a number of the observed results for the mixtures on velvetleaf (ABUTH) were greater than expected from the Colby Equation, which indicates synergistic activity of these mixtures. Synergy was apparent with profluazol(1-chloro-N-[2-chloro-4-fluoro-5-[(6S,7aR)-6-fluorotetrahydro-1,3-dioxo-1H-pyrrolo[1,2-c]imidazol-2(3H)-yl]phenyl]methanesulfonamide) and especially with oxyfluorfen. Where a greater than additive response was less apparent, it was typically because the expected effect was already near 100% at the rates tested. Note that only the postemergence treatments were applied in this test.

TABLE 16
Observed and Expected Results from Compound 2 Alone and in Combination
with Acifluorfen or Flumioxazin.

| | | | | Postemergence | | Preemergence | |
|---|---|---|---|---|---|---|---|
| | Application Rate (g a.i./ha) | | | ABUTH | ABUTH | ABUTH | ABUTH |
| DAA | Cpd 2 | Acifluorfen | Flumioxazin | Obs | Exp | Obs | Exp |
| 15 | 15 | — | — | 33 | | 23 | |
| | 30 | — | — | 38 | | 38 | |
| | 45 | — | — | 61 | | 42 | |
| | — | 7.5 | — | 0 | | 0 | |
| | — | 15 | — | 0 | | 2 | |
| | — | 30 | — | 0 | | 2 | |
| | — | — | 7.5 | 36 | | 58 | |
| | — | — | 15 | 47 | | 65 | |
| | — | — | 30 | 52 | | 93 | |
| | — | — | 45 | 69 | | 100 | |
| | 15 | 7.5 | — | 31 | 33 | 17 | 23 |
| | 15 | 15 | — | 46* | 33 | 5 | 24 |
| | 15 | 30 | — | 33 | 33 | 5 | 24 |
| | 30 | 7.5 | — | 39 | 38 | 31 | 38 |
| | 30 | 15 | — | 55* | 38 | 22 | 39 |
| | 30 | 30 | — | 50* | 38 | 27 | 39 |
| | 45 | 7.5 | — | 59 | 61 | 56* | 42 |
| | 45 | 15 | — | 67* | 61 | 48* | 43 |
| | 45 | 30 | — | 59 | 61 | 24 | 43 |
| | 15 | — | 7.5 | 59* | 57 | 39 | 68 |
| | 15 | — | 15 | 62 | 64 | 54 | 73 |
| | 15 | — | 30 | 65 | 68 | 100* | 95 |
| | 15 | — | 45 | 76 | 79 | 100 | 100 |
| | 30 | — | 7.5 | 63* | 61 | 53 | 74 |
| | 30 | — | 15 | 75* | 67 | 58 | 78 |
| | 30 | — | 30 | 83* | 70 | 94 | 96 |
| | 30 | — | 45 | 87* | 81 | 100 | 100 |
| | 45 | — | 7.5 | 75 | 75 | 55 | 76 |
| | 45 | — | 15 | 86* | 80 | 81 | 80 |
| | 45 | — | 30 | 85* | 81 | 88 | 96 |
| | 45 | — | 45 | 87 | 88 | 100 | 100 |

As can be seen from the results in Table 16, many of the observed results for the mixtures on velvetleaf (ABUTH) were greater than expected from the Colby Equation, which indicates synergistic activity of these mixtures. Synergy was apparent with both acifluorfen and flumioxazin and occurred with postemergence and preemergence treatments, though synergistic responses were more frequent with postemergence than preemergence applications.

TABLE 17
Observed and Expected Results from Compound 2 Alone and in
Combination with Carfentrazone.

| | Application Rate | | Postemergence | | Preemergence | |
|---|---|---|---|---|---|---|
| | (g a.i./ha) | | ABUTH | ABUTH | ABUTH | ABUTH |
| DAA | Cpd 2 | Carfentrazone | Obs | Exp | Obs | Exp |
| 12 | 15 | — | 29 | | 10 | |
| | 30 | — | 30 | | 24 | |
| | 45 | — | 45 | | 45 | |
| | — | 7.5 | 70 | | 4 | |
| | — | 15 | 79 | | 8 | |
| | — | 30 | 82 | | 8 | |
| | 15 | 7.5 | 72 | 79 | 11 | 14 |
| | 15 | 15 | 83 | 85 | 13 | 17 |
| | 15 | 30 | 84 | 87 | 12 | 17 |
| | 30 | 7.5 | 62 | 79 | 7 | 27 |
| | 30 | 15 | 80 | 85 | 13 | 30 |
| | 30 | 30 | 85 | 88 | 12 | 30 |
| | 45 | 7.5 | 73 | 84 | 24 | 47 |
| | 45 | 15 | 66 | 88 | 11 | 49 |
| | 45 | 30 | 87 | 90 | 31 | 49 |

As can be seen from the results in Table 17, none of the observed results for the mixtures on velvetleaf (ABUTH) was greater than expected from the Colby Equation, so synergy was not apparent for Compound 2 mixed with carfentrazone under the conditions of this test.

TABLE 18
Observed and Expected Results from Compound 2 Alone and in Combination
with Sulfentrazone or Azafenidin (2-[2,4-dichloro-5-(2-propynyloxy)phenyl]-5,6,7,8-
tetrahydro-1,2,4-triazole[4,3,-a]pyridine-3(2H)-one).

| | | | | Postemergence | | Preemergence | |
|---|---|---|---|---|---|---|---|
| | Application Rate (g a.i./ha) | | | ABUTH | ABUTH | ABUTH | ABUTH |
| DAA | Cpd 2 | Sulfentrazone | Azafenidin | Obs | Exp | Obs | Exp |
| 15 | 15 | — | — | 39 | | 16 | |
| | 30 | — | — | 58 | | 26 | |
| | 45 | — | — | 67 | | 28 | |
| | — | 7.5 | — | 10 | | 0 | |
| | — | 15 | — | 19 | | 3 | |
| | — | 30 | — | 44 | | 28 | |
| | — | — | 7.5 | 46 | | 18 | |
| | — | — | 15 | 73 | | 35 | |
| | — | — | 30 | 81 | | 67 | |
| | — | — | 45 | 86 | | 68 | |
| | 15 | 7.5 | — | 54* | 45 | 10 | 16 |
| | 15 | 15 | — | 61* | 51 | 20* | 18 |
| | 15 | 30 | — | 77* | 66 | 34 | 39 |
| | 30 | 7.5 | — | 68* | 62 | 21 | 26 |
| | 30 | 15 | — | 78* | 66 | 22 | 28 |
| | 30 | 30 | — | 81* | 76 | 38 | 46 |
| | 45 | 7.5 | — | 81* | 70 | 36* | 28 |
| | 45 | 15 | — | 84* | 73 | 35* | 29 |
| | 45 | 30 | — | 86* | 81 | 53* | 47 |
| | 15 | — | 7.5 | 81* | 67 | 40* | 31 |
| | 15 | — | 15 | 92* | 83 | 39 | 45 |
| | 15 | — | 30 | 92* | 88 | 63 | 72 |
| | 15 | — | 45 | 91 | 91 | 67 | 73 |
| | 30 | — | 7.5 | 88* | 77 | 44* | 39 |
| | 30 | — | 15 | 89 | 88 | 40 | 52 |
| | 30 | — | 30 | 90 | 92 | 67 | 75 |
| | 30 | — | 45 | 94 | 94 | 67 | 77 |
| | 45 | — | 7.5 | 88* | 82 | 41 | 41 |
| | 45 | — | 15 | 88 | 91 | 44 | 53 |
| | 45 | — | 30 | 85 | 94 | 53 | 76 |
| | 45 | — | 45 | 95 | 95 | 63 | 77 |

As can be seen from the results in Table 18, many of the observed results for the mixtures on velvetleaf (ABUTH) were greater than expected from the Colby Equation, which indicates synergistic activity of these mixtures. Synergy was apparent with both sulfentrazone and azafenidin(2-[2,4-dichloro-5-(2-propynyloxy)phenyl]-5,6,7,8-tetrahydro-1,2,4-triazole[4,3,-a]pyridine-3(2H)-one) and occurred with postemergence and preemergence treatments, though synergistic responses were more frequent with postemergence than preemergence applications.

### Test 19

A test was conducted to evaluate the effects on winter barley (HORVW, Hordeum vulgare L.) and winter wheat (TRZAW, Triticum aestivum L.) of mixtures of Compound 2 with the commercial herbicide (2,4-dichlorophenoxy)acetic acid (2,4-D), an auxin mimic. Seeds were planted in a blend of a loam soil and sand having 2.5% organic matter and a pH of 5.6 and grown in a growth chamber until they achieved the desired stage of growth for application. Plants were treated postemergence at the 3-leaf growth stage, and each treatment was replicated four times. Treatments were applied using a belt sprayer that delivered a spray volume of 280 L/ha using a pressure of 214 kPa. Treatments consisted of Compound 2 and 2,4-D alone and in combination, dissolved or suspended in water. After treatment, the plants were returned to a growth chamber where balanced lighting maintained a 12-hour photoperiod and the daytime and nighttime temperatures were about 16° C. and 10° C., respectively. Plants were watered as needed. The effects on the treated plants and untreated controls were recorded 17 days after application. Plants were visually evaluated compared to controls for response to the treatments using a scale of 0 to 100 where 0 is no effect and 100 is complete control. Results are the means of the four replicates. Colby's Equation was used to determine the herbicidal effects expected from the mixtures. The results and additive effects expected from Colby's Equation are listed in Table 19.

TABLE 19
Observed and Expected Results from Compound 2 Alone and
in Combination with 2,4-D.

| | Application Rate | | Postemergence | | | |
|---|---|---|---|---|---|---|
| | (g a.i./ha) | | HORVW | HORVW | TRZAW | TRZAW |
| DAA | Cpd 2 | 2,4-D | Obs | Exp | Obs | Exp |
| 17 | 16 | — | 45 | | 43 | |
| | — | 250 | 15 | | 23 | |
| | — | 500 | 5 | | 23 | |
| | — | 1000 | 10 | | 25 | |
| | 16 | 250 | 35# | 53 | 43# | 55 |
| | 16 | 500 | 39# | 48 | 39# | 55 |
| | 16 | 1000 | 31# | 51 | 43# | 57 |

As can be seen from the results in Table 19, all of the observed results for the mixtures on winter barley and winter wheat were less than expected from the Colby Equation, which indicates safening activity of these mixtures in both crops. Safening was apparent with 2,4-D at all three tested rates.

### Test 20

A test was conducted to evaluate the effects on winter barley (HORVW, Hordeum vulgare L.) and winter wheat (TRZAW, Triticum aestivum L.) of mixtures of Compound 2 with the commercial herbicides (2,4-dichlorophenoxy)acetic acid (2,4-D) and (4-chloro-2-methylphenoxy)acetic acid (MCPA), auxin mimics. Seeds were planted in a blend of a loam soil and sand having 2.5% organic matter and a pH of 5.6 or RediEarth, a commercial potting medium, and grown in a growth chamber until they reached the desired stage of growth for application. Plants were treated postemergence at the 2-leaf growth stage, and each treatment was replicated a total of four times (three times in the loam/sand blend and one time in RediEarth). Treatments were applied using a belt sprayer that delivered a spray volume of 280 L/ha using a pressure of 214 kPa. Treatments consisted of Compound 2 and 2,4-D or MCPA alone and in combination, dissolved or suspended in water. After treatment, the plants were returned to a growth chamber where balanced lighting maintained a 12-hour photoperiod and the daytime and nighttime temperatures were about 16° C. and 10° C., respectively. Plants were watered as needed. The effects on the treated plants and untreated controls were recorded 25 days after application. Plants were visually evaluated compared to controls for response to the treatments using a scale of 0 to 100 where 0 is no effect and 100 is complete control. Results are the means of the four replicates. Colby's Equation was used to determine the herbicidal effects expected from the mixtures. The results and additive effects expected from Colby's Equation are listed in Table 20.

TABLE 20
Observed and Expected Results from Compound 2
Alone and in Combination with 2,4-D or MCPA.

| | Application Rate | | | Postemergence | | | |
|---|---|---|---|---|---|---|---|
| | (g a.i./ha) | | | HORVW | HORVW | TRZAW | TRZAW |
| DAA | Cpd 2 | 2,4-D | MCPA | Obs | Exp | Obs | Exp |
| 25 | 4 | — | — | 26 | | 23 | |
| | 8 | — | — | 33 | | 28 | |
| | 16 | — | — | 44 | | 35 | |
| | — | 250 | — | 26 | | 18 | |
| | — | — | 250 | 33 | | 18 | |
| | 4 | 250 | — | 25# | 46 | 21# | 36 |
| | 8 | 250 | — | 21# | 50 | 24# | 40 |
| | 16 | 250 | — | 30# | 59 | 35# | 46 |
| | 4 | — | 250 | 20# | 50 | 34# | 36 |
| | 8 | — | 250 | 20# | 54 | 39 | 40 |
| | 16 | — | 250 | 20# | 62 | 41# | 46 |

As can be seen from the results in Table 20, nearly all of the observed results for the mixtures on winter barley and winter wheat were less than expected from the Colby Equation, which indicates safening activity of these mixtures in both crops. Safening was apparent with 2,4-D and MCPA at all three tested rates of Compound 2.

### Test 21

A test was conducted to evaluate the effects on winter barley (HORVW, Hordeum vulgare L.), winter wheat (TRZAW, Triticum aestivum L.), and several weed species, of mixtures of Compound 2 with the commercial herbicide (2,4-dichlorophenoxy)acetic acid (2,4-D), an auxin mimic. Seeds were planted in a blend of a loam soil and sand having 2.5% organic matter and a pH of 5.6 and grown in a growth chamber until they achieved the desired stage of growth for application. Weeds in the test included redroot pigweed (AMARE, Amaranthus retroflexus L.), common lambsquarters (CHEAL, Chenopodium album L.), galium (GALAP, Galium aparine L.), kochia (KCHSC, Kochia scoparia (L.) Schrad.), wild chamomile (MATCH, Matricaria chamomilla L.), field poppy (PAPRH, Papaver rhoeas L.), wild buckwheat (POLCO, Polygonum convolvulus L.), Russian thistle (SASKR, Salsola kali ssp. ruthenica (Iljin) Soo), wild mustard (SINAR, Sinapis arvensis L.), common chickweed (STEME, Stellaria media (L.) Vill), and field violet (VIOAR, Viola arvensis Murr.). Plants were treated postemergence at the 2-4 leaf growth stage, and each treatment was replicated one time. Treatments were applied using a belt sprayer that delivered a spray volume of 280 L/ha using a pressure of 214 kPa. Treatments consisted of Compound 2 and 2,4-D alone and in combination, dissolved or suspended in water. After treatment, the plants were returned to a growth chamber where balanced lighting maintained a 12-hour photoperiod and the daytime and nighttime temperatures were about 16° C. and 10° C., respectively. Plants were watered as needed. The effects on the treated plants and untreated controls were recorded 19 days after application. Plants were visually evaluated compared to controls for response to the treatments using a scale of 0 to 100 where 0 is no effect and 100 is complete control. Results are from single replicates. Colby's Equation was used to determine the herbicidal effects expected from the mixtures. The results and additive effects expected from Colby's Equation are listed in Table 21.

TABLE 21
Observed and Expected Results from Compound 2 Alone and
in Combination with 2,4-D.

| | Application Rate | | Postemergence | | | | | |
|---|---|---|---|---|---|---|---|---|
| | (g a.i./ha) | | HORVW | HORVW | TRZAW | TRZAW | AMARE | AMARE |
| DAA | Cpd 2 | 2,4-D | Obs | Exp | Obs | Exp | Obs | Exp |
| 19 | 16 | — | 30 | | 50 | | 60 | |
| | — | 125 | 25 | | 35 | | 50 | |
| | — | 250 | 25 | | 40 | | 50 | |
| | 16 | 125 | 25# | 48 | 45# | 68 | 85* | 80 |
| | 16 | 250 | 20# | 48 | 40# | 70 | 85* | 80 |
| | Application Rate | | Postemergence | | | | | |
| | (g a.i./ha) | | CHEAL | CHEAL | GALAP | GALAP | KCHSC | KCHSC |
| DAA | Cpd 2 | 2,4-D | Obs | Exp | Obs | Exp | Obs | Exp |
| 19 | 16 | — | 60 | | 90 | | 65 | |
| | — | 125 | 40 | | 30 | | 45 | |
| | — | 250 | 40 | | 35 | | 45 | |
| | 16 | 125 | 65 | 76 | 90 | 93 | 100* | 81 |
| | 16 | 250 | 100* | 76 | 90 | 94 | 100* | 81 |
| | Application Rate | | Postemergence | | | | | |
| | (g a.i./ha) | | MATCH | MATCH | PAPRH | PAPRH | POLCO | POLCO |
| DAA | Cpd 2 | 2,4-D | Obs | Exp | Obs | Exp | Obs | Exp |
| 19 | 16 | — | 60 | | 65 | | 70 | |
| | — | 125 | 40 | | 35 | | 20 | |
| | — | 250 | 45 | | 35 | | 20 | |
| | 16 | 125 | 75 | 76 | 65 | 77 | 70 | 76 |
| | 16 | 250 | 80* | 78 | 85* | 77 | 100* | 76 |

| Application | Postemergence | | | | | | | |
|---|---|---|---|---|---|---|---|---|
| Rate (g a.i./ha) | SASKR | SASKR | SINAR | SINAR | STEME | STEME | VIOAR | VIOAR |

| DAA | Cpd 2 | 2,4-D | Obs | Exp | Obs | Exp | Obs | Exp | Obs | Exp |
|---|---|---|---|---|---|---|---|---|---|---|
| 19 | 16 | — | 65 | | 65 | | 65 | | 60 | |
| | — | 125 | 60 | | 85 | | 50 | | 0 | |
| | — | 250 | 55 | | 65 | | 50 | | 20 | |
| | 16 | 125 | 75 | 86 | 85 | 95 | 75 | 83 | 70* | 60 |
| | 16 | 250 | 75 | 84 | 100* | 88 | 100* | 83 | 100* | 68 |

As can be seen from the results in Table 21, all of the observed results for the mixtures on winter barley and winter wheat were less than expected from the Colby Equation, which indicates safening activity of these mixtures in both crops. Safening was apparent with 2,4-D at both tested rates. In addition, a number of the observed results for the mixtures on weeds were greater than expected from the Colby Equation, which indicates synergistic activity of these mixtures. Synergy was also observed at both tested rates of 2,4-D.

### Test 22

A test was conducted to evaluate the effects on winter barley (HORVW, Hordeum vulgare L.), winter wheat (TRZAW, Triticum aestivum L.), and several weed species of mixtures of Compound 2 with the commercial herbicides (2,4-dichlorophenoxy)acetic acid (2,4-D) and (4-chloro-2-methylphenoxy)acetic acid (MCPA), auxin mimics. Seeds were planted in RediEarth, a commercial potting medium, and grown in a growth chamber until they achieved the desired stage of growth for application. Weeds in the test included redroot pigweed (AMARE, Amaranthus retroflexus L.), common lambsquarters (CHEAL, Chenopodium album L.), galium (GALAP, Galium aparine L.), kochia (KCHSC, Kochia scoparia (L.), Schrad.), wild buckwheat (POLCO, Polygonum convolvulus L.), Russian thistle (SASKR, Salsola kali ssp. ruthenica (Iljin) Soo), wild mustard (SINAR, Sinapis arvensis L.), and common chickweed (STEME, Stellaria media L., Vill.). Plants were treated postemergence at the 2-4 leaf growth stage, except KCHSC, SASKR and STEME which were in the 4-8 leaf growth stage. Each treatment was replicated one time. Treatments were applied using a belt sprayer that delivered a spray volume of 280 L/ha using a pressure of 214 kPa. Treatments consisted of Compound 2 and 2,4-D or MCPA alone and in combination, dissolved or suspended in water. After treatment, the plants were returned to a growth chamber where balanced lighting maintained a 12-hour photoperiod and the daytime and nighttime temperatures were about 16° C. and 10° C., respectively. Plants were watered as needed. The effects on the treated plants and untreated controls were recorded 25 days after application. Plants were visually evaluated compared to controls for response to the treatments using a scale of 0 to 100 where 0 is no effect and 100 is complete control. Results are from single replicates. Colby's Equation was used to determine the herbicidal effects expected from the mixtures. The results and additive effects expected from Colby's Equation are listed in Table 22.

TABLE 22
Observed and Expected Results from Compound 2 Alone and in Combination
with 2,4-D or MCPA.

| | Application Rate | | | Postemergence | | | | | |
|---|---|---|---|---|---|---|---|---|---|
| | (g a.i./ha) | | | HORVW | HORVW | TRZAW | TRZAW | AMARE | AMARE |
| DAA | Cpd 2 | 2,4-D | MCPA | Obs | Exp | Obs | Exp | Obs | Exp |
| 25 | — | — | — | 0 | | 0 | | 0 | |
| | 4 | — | — | 30 | | 30 | | 55 | |
| | 8 | — | — | 35 | | 35 | | 65 | |
| | 16 | — | — | 40 | | 40 | | 65 | |
| | — | 250 | — | 10 | | 20 | | 70 | |
| | — | — | 250 | 25 | | 10 | | 65 | |
| | 4 | 250 | — | 30# | 37 | 25# | 44 | 80 | 87 |
| | 8 | 250 | — | 30# | 42 | 30# | 48 | 80 | 90 |
| | 16 | 250 | — | 30# | 46 | 40# | 52 | 80 | 90 |
| | 4 | — | 250 | 10# | 48 | 35# | 37 | 70 | 84 |
| | 8 | — | 250 | 25# | 51 | 35# | 42 | 75 | 88 |
| | 16 | — | 250 | 30# | 55 | 40# | 46 | 80 | 88 |
| | Application Rate | | | Postemergence | | | | | |
| | (g a.i./ha) | | | CHEAL | CHEAL | GALAP | GALAP | KCHSC | KCHSC |
| DAA | Cpd 2 | 2,4-D | MCPA | Obs | Exp | Obs | Exp | Obs | Exp |
| 25 | — | — | — | 0 | | 0 | | 0 | |
| | 4 | — | — | 50 | | 65 | | 45 | |
| | 8 | — | — | 50 | | 90 | | 50 | |
| | 16 | — | — | 65 | | 100 | | 60 | |
| | — | 250 | — | 60 | | 30 | | 60 | |
| | — | — | 250 | 65 | | 50 | | 55 | |
| | 4 | 250 | — | 70 | 80 | 65 | 76 | 70 | 78 |
| | 8 | 250 | — | 70 | 80 | 85 | 93 | 75 | 80 |
| | 16 | 250 | — | 75 | 86 | 100 | 100 | 85 | 84 |
| | 4 | — | 250 | 70 | 83 | 75 | 83 | 70 | 75 |
| | 8 | — | 250 | 75 | 83 | 90 | 95 | 75 | 78 |
| | 16 | — | 250 | 80 | 88 | 90 | 100 | 75 | 82 |

| | |
|---|---|
| Application Rate | Postemergence |

| | (g a.i./ha) | | | POLCO | POLCO | SASKR | SASKR |
|---|---|---|---|---|---|---|---|
| DAA | Cpd 2 | 2,4-D | MCPA | Obs | Exp | Obs | Exp |
| 25 | — | — | — | 0 | | 0 | |
| | 4 | — | — | 55 | | 50 | |
| | 8 | — | — | 60 | | 50 | |
| | 16 | — | — | 60 | | 55 | |
| | — | 250 | — | 45 | | 60 | |
| | — | — | 250 | 40 | | 45 | |
| | 4 | 250 | — | 65 | 75 | 65 | 80 |
| | 8 | 250 | — | 75 | 78 | 70 | 80 |
| | 16 | 250 | — | 75 | 78 | 75 | 82 |
| | 4 | — | 250 | 65 | 73 | 55 | 73 |
| | 8 | — | 250 | 65 | 76 | 70 | 73 |
| | 16 | — | 250 | 70 | 76 | 75 | 75 |

| | |
|---|---|
| Application Rate | Postemergence |

| | (g a.i./ha) | | | SINAR | SINAR | STEME | STEME |
|---|---|---|---|---|---|---|---|
| DAA | Cpd 2 | 2,4-D | MCPA | Obs | Exp | Obs | Exp |
| 25 | — | — | — | 0 | | 0 | |
| | 4 | — | — | 60 | | 50 | |
| | 8 | — | — | 65 | | 50 | |
| | 16 | — | — | 65 | | 55 | |
| | — | 250 | | 75 | | 55 | |
| | — | — | 250 | 75 | | 50 | |
| | 4 | 250 | — | 80 | 90 | 65 | 78 |
| | 8 | 250 | — | 80 | 91 | 70 | 78 |
| | 16 | 250 | — | 85 | 91 | 75 | 80 |
| | 4 | — | 250 | 85 | 90 | 60 | 75 |
| | 8 | — | 250 | 85 | 91 | 65 | 75 |
| | 16 | — | 250 | 85 | 91 | 65 | 78 |

As can be seen from the results in Table 22, all of the observed results for the mixtures on winter barley and winter wheat were less than expected from the Colby Equation, which indicates safening activity of these mixtures in both crops. Safening was apparent with both 2,4-D and MCPA at all three of the tested rates of Compound 2.

### Test 23

A test was conducted to evaluate the effects on winter barley (HORVW, Hordeum vulgare L.), winter wheat (TRZAW, Triticum aestivum L.), and several weed species of mixtures of Compound 2 with the commercial herbicides (2,4-dichlorophenoxy)acetic acid (2,4-D) and (4-chloro-2-methylphenoxy)acetic acid (MCPA), auxin mimics. Seeds were planted in a blend of a loam soil and sand having 2.5% organic matter and a pH of 5.6 and grown in a growth chamber until they achieved the desired stage of growth for application. Weeds in the test included redroot pigweed (AMARE, Amaranthus retroflexus L.), common lambsquarters (CHEAL, Chenopodium album L.), galium (GALAP, Galium aparine L.), kochia (KCHSC, Kochia scoparia (L.) Schrad.), wild chamomile (MATCH, Matricaria chamomilla L.), field poppy (PAPRH, Papaver rhoeas L.), wild buckwheat (POLCO, Polygonum convolvulus L.), Russian thistle (SASKR, Salsola kali L. ssp. ruthenica (Iljin) Soo), wild mustard (SINAR, Sinapis arvensis L.), common chickweed (STEME, Stellaria media (L.), Vill.), and field violet (VIOAR, Viola arvensis Murr.). Plants were treated postemergence at the 2-4 leaf growth stage, and each treatment was replicated three times. Treatments were applied using a belt sprayer that delivered a spray volume of 280 L/ha using a pressure of 214 kPa. Treatments consisted of Compound 2 and 2,4-D or MCPA alone and in combination, dissolved or suspended in water. After treatment, the plants were returned to a growth chamber where balanced lighting maintained a 12-hour photoperiod and the daytime and nighttime temperatures were about 16° C. and 10° C., respectively. Plants were watered as needed. The effects on the treated plants and untreated controls were recorded 21 days after application. Plants were visually evaluated compared to controls for response to the treatments using a scale of 0 to 100 where 0 is no effect and 100 is complete control. Results are means of the three replicates. Colby's Equation was used to determine the herbicidal effects expected from the mixtures. The results and additive effects expected from Colby's Equation are listed in Table 23.

TABLE 23
Observed and Expected Results from Compound 2 Alone and in Combination
with 2,4-D or MCPA.

| | Application | | | Postemergence | | | | | |
|---|---|---|---|---|---|---|---|---|---|
| | Rate (g a.i./ha) | | | HORVW | HORVW | TRZAW | TRZAW | AMARE | AMARE |
| DAA | Cpd 2 | 2,4-D | MCPA | Obs | Exp | Obs | Exp | Obs | Exp |
| 21 | 4 | — | — | 32 | | 35 | | 43 | |
| | 8 | — | — | 38 | | 38 | | 62 | |
| | 16 | — | — | 38 | | 43 | | 68 | |
| | — | 250 | — | 25 | | 20 | | 67 | |
| | — | — | 250 | 35 | | 32 | | 63 | |
| | 4 | 250 | — | 28# | 49 | 33# | 48 | 75 | 81 |
| | 8 | 250 | — | 33# | 54 | 37# | 51 | 77 | 87 |
| | 16 | 250 | — | 37# | 54 | 38# | 55 | 80 | 89 |
| | 4 | — | 250 | 35# | 56 | 40# | 56 | 60 | 79 |
| | 8 | — | 250 | 30# | 60 | 37# | 58 | 72 | 86 |
| | 16 | — | 250 | 28# | 60 | 43# | 61 | 77 | 88 |

| | Application | | | Postemergence | | | | | |
|---|---|---|---|---|---|---|---|---|---|
| | Rate (g a.i./ha) | | | CHEAL | CHEAL | GALAP | GALAP | KCHSC | KCHSC |
| DAA | Cpd 2 | 2,4-D | MCPA | Obs | Exp | Obs | Exp | Obs | Exp |
| 21 | 4 | — | — | 53 | | 60 | | 53 | |
| | 8 | — | — | 55 | | 72 | | 60 | |
| | 16 | — | — | 55 | | 80 | | 70 | |
| | — | 250 | — | 58 | | 33 | | 70 | |
| | — | — | 250 | 70 | | 43 | | 67 | |
| | 4 | 250 | — | 70 | 81 | 63 | 73 | 72 | 86 |
| | 8 | 250 | — | 72 | 81 | 73 | 81 | 72 | 88 |
| | 16 | 250 | — | 75 | 81 | 85 | 87 | 82 | 91 |
| | 4 | — | 250 | 75 | 86 | 68 | 77 | 72 | 84 |
| | 8 | — | 250 | 80 | 87 | 77 | 84 | 73 | 87 |
| | 16 | — | 250 | 85 | 87 | 88 | 89 | 85 | 90 |

| | Application | | | Postemergence | | | | | |
|---|---|---|---|---|---|---|---|---|---|
| | Rate (g a.i./ha) | | | MATCH | MATCH | PAPRH | PAPRH | POLCO | POLCO |
| DAA | Cpd 2 | 2,4-D | MCPA | Obs | Exp | Obs | Exp | Obs | Exp |
| 21 | 4 | — | — | 52 | | 53 | | 48 | |
| | 8 | — | — | 63 | | 58 | | 53 | |
| | 16 | — | — | 75 | | 72 | | 55 | |
| | — | 250 | — | 60 | | 52 | | 58 | |
| | — | — | 250 | 53 | | 57 | | 52 | |
| | 4 | 250 | — | 72 | 81 | 73 | 77 | 65 | 78 |
| | 8 | 250 | — | 75 | 85 | 77 | 80 | 70 | 81 |
| | 16 | 250 | — | 80 | 90 | 78 | 86 | 75 | 81 |
| | 4 | — | 250 | 62 | 77 | 73 | 80 | 53 | 75 |
| | 8 | — | 250 | 68 | 83 | 78 | 82 | 62 | 77 |
| | 16 | — | 250 | 77 | 88 | 80 | 88 | 63 | 78 |

| | |
|---|---|
| Application | Postemergence |

| | Rate (g a.i./ha) | | | SASKR | SASKR | SINAR | SINAR |
|---|---|---|---|---|---|---|---|
| DAA | Cpd 2 | 2,4-D | MCPA | Obs | Exp | Obs | Exp |
| 21 | 4 | — | — | 55 | | 43 | |
| | 8 | — | — | 63 | | 53 | |
| | 16 | — | — | 72 | | 55 | |
| | — | 250 | — | 63 | | 65 | |
| | — | — | 250 | 43 | | 65 | |
| | 4 | 250 | — | 73 | 84 | 72 | 80 |
| | 8 | 250 | — | 75 | 87 | 75 | 84 |
| | 16 | 250 | — | 77 | 90 | 75 | 84 |
| | 4 | — | 250 | 67 | 75 | 72 | 80 |
| | 8 | — | 250 | 68 | 79 | 75 | 84 |
| | 16 | — | 250 | 72 | 84 | 80 | 84 |

| | |
|---|---|
| Application | Postemergence |

| | Rate (g a.i./ha) | | | STEME | STEME | VIOAR | VIOAR |
|---|---|---|---|---|---|---|---|
| DAA | Cpd 2 | 2,4-D | MCPA | Obs | Exp | Obs | Exp |
| 21 | 4 | — | — | 55 | | 60 | |
| | 8 | — | — | 58 | | 63 | |
| | 16 | — | — | 67 | | 72 | |
| | — | 250 | — | 65 | | 63 | |
| | — | — | 250 | 55 | | 60 | |
| | 4 | 250 | — | 70 | 84 | 72 | 85 |
| | 8 | 250 | — | 72 | 85 | 73 | 87 |
| | 16 | 250 | — | 77 | 88 | 77 | 90 |
| | 4 | — | 250 | 70 | 80 | 65 | 84 |
| | 8 | — | 250 | 75 | 81 | 67 | 85 |
| | 16 | — | 250 | 75 | 85 | 78 | 89 |

As can be seen from the results in Table 23, all of the observed results for the mixtures on winter barley and winter wheat were less than expected from the Colby Equation, which indicates safening activity of these mixtures in both crops. Safening was apparent with both 2,4-D and MCPA at all three of the tested rates of Compound 2.

### Test 24

A test was conducted to evaluate the effects of mixtures of Compound 2 with the commercial herbicide fluroxypyr, an auxin mimic, on two varieties each of winter barley (HORVW, Hordeum vulgare L.) and winter wheat (TRZAW, Triticum aestivum L.), and on several weed species. Seeds were planted in a blend of a loam soil and sand having 2.5% organic matter and a pH of 5.6 and grown in a growth chamber until they achieved the desired stage of growth for application. Weeds in the test included redroot pigweed (AMARE, Amaranthus retroflexus L.), common lambsquarters (CHEAL, Chenopodium album L.), galium (GALAP, Galium aparine L.), kochia (KCHSC, Kochia scoparia (L.) Schrad.), wild chamomile (MATCH, Matricaria chamomilla L.), field poppy (PAPRH, Papaver rhoeas L.), wild buckwheat (POLCO, Polygonum convolvulus L.), Russian thistle (SASKR, Salsola kali L. ssp. ruthenica (Iljin) Soo), wild mustard (SINAR, Sinapis arvensis L.), common chickweed (STEME, Stellaria media (L.) Vill.), and field violet (VIOAR, Viola arvensis Murr.). Plants were treated postemergence at the 2-4 leaf growth stage, and each treatment was replicated three times. Treatments were applied using a belt sprayer that delivered a spray volume of 280 L/ha using a pressure of 214 kPa. Treatments consisted of Compound 2 and fluroxypyr alone and in combination, dissolved or suspended in water. After treatment, the plants were returned to a growth chamber where balanced lighting maintained a 12-hour photoperiod and the daytime and nighttime temperatures were about 16° C. and 10° C., respectively. Plants were watered as needed. The effects on the treated plants and untreated controls were recorded 17 days after application. Plants were visually evaluated compared to controls for response to the treatments using a scale of 0 to 100 where 0 is no effect and 100 is complete control. Results for barley and wheat are the means across varieties of the three replicates, and results for the weeds are the means of the three replicates. Colby's Equation was used to determine the herbicidal effects expected from the mixtures. The results and additive effects expected from Colby's Equation are listed in Table 24.

TABLE 24
Observed and Expected Results from Compound 2 Alone and in Combination
with Fluroxypyr.

| | Application | | Postemergence | | | | | |
|---|---|---|---|---|---|---|---|---|
| | Rate (g a.i./ha) | | HORVW | HORVW | TRZAW | TRZAW | AMARE | AMARE |
| DAA | Cpd 2 | Fluroxypyr | Obs | Exp | Obs | Exp | Obs | Exp |
| 17 | 4 | — | 19 | | 21 | | 63 | |
| | 8 | — | 28 | | 33 | | 67 | |
| | 16 | — | 37 | | 39 | | 75 | |
| | — | 62 | 28 | | 13 | | 67 | |
| | — | 125 | 33 | | 23 | | 77 | |
| | 4 | 62 | 36# | 42 | 33 | 31 | 77 | 88 |
| | 8 | 62 | 42# | 48 | 37# | 42 | 82 | 89 |
| | 16 | 62 | 45# | 55 | 44# | 47 | 82 | 92 |
| | 4 | 125 | 43# | 46 | 38 | 39 | 82 | 91 |
| | 8 | 125 | 43# | 52 | 39# | 48 | 85 | 92 |
| | 16 | 125 | 48# | 58 | 48# | 53 | 88 | 94 |

| | Application | | Postemergence | | | | | |
|---|---|---|---|---|---|---|---|---|
| | Rate (g a.i./ha) | | CHEAL | CHEAL | GALAP | GALAP | KCHSC | KCHSC |
| DAA | Cpd 2 | Fluroxypyr | Obs | Exp | Obs | Exp | Obs | Exp |
| 17 | 4 | — | 45 | | 73 | | 65 | |
| | 8 | — | 60 | | 75 | | 77 | |
| | 16 | — | 73 | | 87 | | 88 | |
| | — | 62 | 47 | | 80 | | 68 | |
| | — | 125 | 58 | | 85 | | 73 | |
| | 4 | 62 | 55 | 71 | 87 | 95 | 83 | 89 |
| | 8 | 62 | 68 | 79 | 88 | 95 | 88 | 93 |
| | 16 | 62 | 78 | 86 | 93 | 97 | 90 | 96 |
| | 4 | 125 | 62 | 77 | 88 | 96 | 87 | 91 |
| | 8 | 125 | 73 | 83 | 90 | 96 | 93 | 94 |
| | 16 | 125 | 78 | 89 | 97 | 98 | 95 | 97 |

| | Application | | Postemergence | | | | | |
|---|---|---|---|---|---|---|---|---|
| | Rate (g a.i./ha) | | MATCH | MATCH | PAPRH | PAPRH | POLCO | POLCO |
| DAA | Cpd 2 | Fluroxypyr | Obs | Exp | Obs | Exp | Obs | Exp |
| 17 | 4 | — | 55 | | 62 | | 55 | |
| | 8 | — | 65 | | 72 | | 60 | |
| | 16 | — | 72 | | 75 | | 70 | |
| | — | 62 | 60 | | 65 | | 68 | |
| | — | 125 | 65 | | 73 | | 75 | |
| | 4 | 62 | 65 | 82 | 72 | 87 | 78 | 86 |
| | 8 | 62 | 70 | 86 | 78 | 90 | 82 | 87 |
| | 16 | 62 | 75 | 89 | 83 | 91 | 77 | 91 |
| | 4 | 125 | 72 | 84 | 75 | 90 | 83 | 89 |
| | 8 | 125 | 73 | 88 | 83 | 92 | 78 | 90 |
| | 16 | 125 | 78 | 90 | 90 | 93 | 87 | 93 |

| | |
|---|---|
| Application | Postemergence |

| | | | | |
|---|---|---|---|---|
| Rate (g a.i./ha) | SASKR | SASKR | SINAR | SINAR |

| DAA | Cpd 2 | Fluroxypyr | Obs | Exp | Obs | Exp |
|---|---|---|---|---|---|---|
| 17 | 4 | — | 63 | | 62 | |
| | 8 | — | 75 | | 65 | |
| | 16 | — | 75 | | 72 | |
| | — | 62 | 75 | | 75 | |
| | — | 125 | 75 | | 75 | |
| | 4 | 62 | 75 | 91 | 80 | 90 |
| | 8 | 62 | 78 | 94 | 82 | 91 |
| | 16 | 62 | 82 | 94 | 82 | 93 |
| | 4 | 125 | 80 | 91 | 82 | 90 |
| | 8 | 125 | 82 | 94 | 83 | 91 |
| | 16 | 125 | 83 | 94 | 85 | 93 |

| | |
|---|---|
| Application | Postemergence |

| | | | | |
|---|---|---|---|---|
| Rate (g a.i./ha) | STEME | STEME | VIOAR | VIOAR |

| DAA | Cpd 2 | Fluroxypyr | Obs | Exp | Obs | Exp |
|---|---|---|---|---|---|---|
| 17 | 4 | — | 47 | | 47 | |
| | 8 | — | 63 | | 62 | |
| | 16 | — | 67 | | 72 | |
| | — | 62 | 75 | | 73 | |
| | — | 125 | 83 | | 82 | |
| | 4 | 62 | 82 | 87 | 77 | 86 |
| | 8 | 62 | 85 | 91 | 83 | 90 |
| | 16 | 62 | 87 | 92 | 83 | 92 |
| | 4 | 125 | 87 | 91 | 85 | 90 |
| | 8 | 125 | 90 | 94 | 83 | 93 |
| | 16 | 125 | 92 | 94 | 87 | 95 |

As can be seen from the results in Table 24, nearly all of the observed results for the mixtures on winter barley and winter wheat were less than expected from the Colby Equation, which indicates safening activity of these mixtures in both crops. Safening was apparent with both tested rates of fluroxypyr and at two or three of the tested rates of Compound 2.

### Test 25

A field trial was conducted to evaluate the effects of two- and three-way mixtures of Compound 2 with commercial herbicides on corn (ZEAMD, Zea mays ssp. indentata) and several weed species. Corn seeds (hybrid ‘Pioneer 31G96 RR’) were planted in mid spring season, 3.8 cm deep in a clay loam soil having 2% organic matter and a pH of 6.6. Plots were 6.1 m long by 3.0 m wide with rows spaced 76 cm apart. Seeds were spaced 15 cm apart within the rows. The field was managed using conventional tillage practices. The plots were arranged in a randomized complete block design with each treatment being replicated three times. Treatments were applied postemergence 27 days after planting using a backpack sprayer delivering a spray volume of 224 L/ha using a pressure of 476 kPa. Treatments consisted of Compound 2 and the commercial herbicide nicosulfuron, an AHAS inhibitor, or diflufenzopyr, an auxin transport inhibitor, alone and in two- and three-way combinations, dissolved or suspended in water. Weed species present in the experimental plots in sufficient quantity to be evaluated included velvetleaf (ABUTH, Abutilon theophrasti Medik.), redroot pigweed (AMARE, Amaranthus retroflexus L.), common ragweed (AMBEL, Ambrosia artemisiifolia L.), giant ragweed (AMBTR, Ambrosia trifida L.), common lambsquarters (CHEAL, Chenopodium album L.), Pennsylvania smartweed (POLPY, Polygonum pensylvanicum L.), and giant foxtail (SETFA, Setaria faberi Herrm.). The effects on the treated plants and untreated controls were recorded 14, 28 and 56 days after application. Giant ragweed and Pennsylvania smartweed could only be evaluated 14 days after application. Plants were visually evaluated for growth inhibition compared to controls in response to the treatments using a scale of 0 to 100 where 0 is no effect and 100 is complete control. Results are the means of the three replicates. This growth inhibition data was converted to results in the form of “plant growth as a percent of control plant growth” using the calculation “100 minus growth inhibition”. Converted results are shown in Table 25 and are on a scale of 0 to 100 where 0 is complete control and 100 is no effect. The generalized form of Colby's Equation that can be applied to mixtures having any number of components is described in detail in Test 14 and was used to determine the herbicidal effects expected from the mixtures.

When this form of Colby's Equation is used, if the observed effects on weeds are less than the expected values, the mixture is synergistic. When the observed effects on crops are greater than the expected values, the mixture shows safening activity. The results and additive effects expected from Colby's Equation are listed in Table 25.

TABLE 25
Observed and Expected Results from Compound 2 Alone and in Combination
with Diflufenzopyr with or without Nicosulfuron.

| | | | | Postemergence | | | | | |
|---|---|---|---|---|---|---|---|---|---|
| | Application Rate (g a.i./ha) | | | ZEAMD | ZEAMD | ABUTH | ABUTH | AMARE | AMARE |
| DAA | Cpd 2 | Diflufenzopyr | Nicosulfuron | Obs | Exp | Obs | Exp | Obs | Exp |
| 14 | 15 | — | — | 100 | | 70 | | 47 | |
| | 30 | — | — | 88 | | 45 | | 35 | |
| | 45 | — | — | 77 | | 37 | | 28 | |
| | — | 30 | — | 100 | | 28 | | 48 | |
| | — | 45 | — | 100 | | 15 | | 47 | |
| | — | — | 15 | 100 | | 48 | | 2 | |
| | 15 | 30 | — | 93 | 100 | 12* | 20 | 11* | 23 |
| | 30 | 30 | — | 88 | 88 | 8* | 13 | 3* | 17 |
| | 45 | 30 | — | 78 | 77 | 1* | 10 | 0* | 14 |
| | 15 | 45 | — | 95 | 100 | 27 | 11 | 15* | 22 |
| | 30 | 45 | — | 78 | 88 | 1* | 7 | 2* | 16 |
| | 45 | 45 | — | 73 | 77 | 3* | 6 | 0* | 13 |
| | 30 | 30 | 15 | 88 | 88 | 5 | 6 | 0 | 0 |
| 28 | 15 | — | — | 100 | | 72 | | 38 | |
| | 30 | — | — | 97 | | 53 | | 22 | |
| | 45 | — | — | 95 | | 40 | | 20 | |
| | — | 30 | — | 83 | | 58 | | 63 | |
| | — | 45 | — | 88 | | 55 | | 55 | |
| | — | — | 15 | 100 | | 73 | | 2 | |
| | 15 | 30 | — | 92* | 83 | 25* | 41 | 3* | 24 |
| | 30 | 30 | — | 95* | 80 | 18* | 31 | 0* | 14 |
| | 45 | 30 | — | 92* | 78 | 2* | 23 | 0* | 13 |
| | 15 | 45 | — | 93* | 88 | 9* | 39 | 3* | 21 |
| | 30 | 45 | — | 100* | 85 | 5* | 29 | 2* | 12 |
| | 45 | 45 | — | 92* | 83 | 3* | 22 | 2* | 11 |
| | 30 | 30 | 15 | 100* | 80 | 18* | 22 | 0 | 0 |
| 56 | 15 | — | — | 100 | | 62 | | 0 | |
| | 30 | — | — | 100 | | 28 | | 0 | |
| | 45 | — | — | 100 | | 20 | | 28 | |
| | — | 30 | — | 100 | | 33 | | 30 | |
| | — | 45 | — | 100 | | 40 | | 55 | |
| | — | — | 15 | 100 | | 100 | | 33 | |
| | 15 | 30 | — | 100 | 100 | 17* | 20 | 0 | 0 |
| | 30 | 30 | — | 100 | 100 | 8 | 9 | 0 | 0 |
| | 45 | 30 | — | 100 | 100 | 0* | 7 | 0* | 8 |
| | 15 | 45 | — | 100 | 100 | 12* | 25 | 0 | 0 |
| | 30 | 45 | — | 100 | 100 | 5* | 11 | 0 | 0 |
| | 45 | 45 | — | 100 | 100 | 2* | 8 | 0* | 15 |
| | 30 | 30 | 15 | 100 | 100 | 18 | 9 | 0 | 0 |

| | | | | Postemergence | | | | | |
|---|---|---|---|---|---|---|---|---|---|
| | Application Rate (g a.i./ha) | | | AMBEL | AMBEL | AMBTR | AMBTR | CHEAL | CHEAL |
| DAA | Cpd 2 | Diflufenzopyr | Nicosulfuron | Obs | Exp | Obs | Exp | Obs | Exp |
| 14 | 15 | — | — | 20 | | — | | 15 | |
| | 30 | — | — | 22 | | 5 | | 20 | |
| | 45 | — | — | 12 | | 0 | | 7 | |
| | — | 30 | — | 60 | | — | | 50 | |
| | — | 45 | — | 57 | | 75 | | 45 | |
| | — | — | 15 | 95 | | 100 | | 95 | |
| | 15 | 30 | — | 4* | 12 | 5 | | 9 | 8 |
| | 30 | 30 | — | 1* | 13 | 5 | | 2* | 10 |
| | 45 | 30 | — | 0* | 7 | — | | 0* | 3 |
| | 15 | 45 | — | 22 | 11 | 10 | | 11 | 7 |
| | 30 | 45 | — | 1* | 12 | 0* | 4 | 1* | 9 |
| | 45 | 45 | — | 0* | 7 | 0 | 0 | 0* | 3 |
| | 30 | 30 | 15 | 1* | 12 | 2 | 0 | 1* | 10 |
| 28 | 15 | — | — | 16 | | — | | 2 | |
| | 30 | — | — | 12 | | — | | 1 | |
| | 45 | — | — | 8 | | — | | 0 | |
| | — | 30 | — | 73 | | — | | 78 | |
| | — | 45 | — | 60 | | — | | 65 | |
| | — | — | 15 | 100 | | — | | 72 | |
| | 15 | 30 | — | 0* | 11 | — | | 0* | 2 |
| | 30 | 30 | — | 1* | 9 | — | | 0 | 1 |
| | 45 | 30 | — | 0* | 5 | — | | 0 | 0 |
| | 15 | 45 | — | 0* | 9 | — | | 0* | 2 |
| | 30 | 45 | — | 0* | 7 | — | | 0 | 0 |
| | 45 | 45 | — | 0* | 5 | — | | 0 | 0 |
| | 30 | 30 | 15 | 5* | 9 | — | | 0 | 0 |
| 56 | 15 | — | — | 0 | | — | | 0 | |
| | 30 | — | — | 0 | | — | | 0 | |
| | 45 | — | — | 0 | | — | | 0 | |
| | — | 30 | — | 83 | | — | | 10 | |
| | — | 45 | — | 75 | | — | | 0 | |
| | — | — | 15 | 100 | | — | | 53 | |
| | 15 | 30 | — | 2 | 0 | — | | 0 | 0 |
| | 30 | 30 | — | 5 | 0 | — | | 0 | 0 |
| | 45 | 30 | — | 0 | 0 | — | | 0 | 0 |
| | 15 | 45 | — | 0 | 0 | — | | 0 | 0 |
| | 30 | 45 | — | 0 | 0 | — | | 0 | 0 |
| | 45 | 45 | — | 0 | 0 | — | | 0 | 0 |
| | 30 | 30 | 15 | 8 | 0 | — | | 0 | 0 |

Postemergence

| | Application Rate (g a.i./ha) | | | POLPY | POLPY | SETFA | SETFA |
|---|---|---|---|---|---|---|---|
| DAA | Cpd 2 | Diflufenzopyr | Nicosulfuron | Obs | Exp | Obs | Exp |
| 14 | 15 | — | — | 95 | | 93 | |
| | 30 | — | — | 55 | | 85 | |
| | 45 | — | — | 65 | | 73 | |
| | — | 30 | — | 30 | | 40 | |
| | — | 45 | — | 35 | | 40 | |
| | — | — | 15 | 28 | | 15 | |
| | 15 | 30 | — | 23* | 29 | 47 | 37 |
| | 30 | 30 | — | 6* | 17 | 28* | 34 |
| | 45 | 30 | — | 2* | 20 | 32 | 29 |
| | 15 | 45 | — | 28* | 33 | 47 | 37 |
| | 30 | 45 | — | 5* | 19 | 33 | 34 |
| | 45 | 45 | — | 0* | 23 | 28 | 29 |
| | 30 | 30 | 15 | 5 | 5 | 12 | 5 |
| 28 | 15 | — | — | — | | 98 | |
| | 30 | — | — | — | | 88 | |
| | 45 | — | — | — | | 80 | |
| | — | 30 | — | — | | 60 | |
| | — | 45 | — | — | | 58 | |
| | — | — | 15 | — | | 11 | |
| | 15 | 30 | — | — | | 48* | 59 |
| | 30 | 30 | — | — | | 33* | 53 |
| | 45 | 30 | — | — | | 22* | 48 |
| | 15 | 45 | — | — | | 42* | 57 |
| | 30 | 45 | — | — | | 20* | 51 |
| | 45 | 45 | — | — | | 20* | 46 |
| | 30 | 30 | 15 | — | | 10 | 6 |
| 56 | 15 | — | — | — | | 100 | |
| | 30 | — | — | — | | 80 | |
| | 45 | — | — | — | | 83 | |
| | — | 30 | — | — | | 68 | |
| | — | 45 | — | — | | 60 | |
| | — | — | 15 | — | | 7 | |
| | 15 | 30 | — | — | | 58* | 68 |
| | 30 | 30 | — | — | | 45* | 54 |
| | 45 | 30 | — | — | | 37* | 56 |
| | 15 | 45 | — | — | | 57* | 60 |
| | 30 | 45 | — | — | | 45* | 48 |
| | 45 | 45 | — | — | | 28* | 50 |
| | 30 | 30 | 15 | — | | 25 | 4 |

As can be seen from the results in Table 25, most of the observed results for the mixtures on weeds were less than expected from the Colby Equation, which indicates synergistic activity of these mixtures. Synergy with Compound 2 was apparent with both diflufenzopyr and in the three-way mixture of Compound 2 plus diflufenzopyr and nicosulfuron. At 56 DAA, a less than additive response was not as apparent in redroot pigweed, common ragweed and common lambsquarters as at earlier observation timings. This result is because the expected effect was already near 0% (complete control) at the rates tested. Greater than additive responses, which would indicate safening activity of these mixtures, were observed in corn at 28 DAA. At 56 DAA, safening was not observed because the expected effect was already 100% (no effect) at the rates tested.

### Test 26

A field trial was conducted to evaluate the effects of mixtures of Compound 2 with a commercial herbicide on corn (ZEAMD, Zea mays ssp. indentata) and several weed species. Corn seeds (hybrid ‘Pioneer 31G96’) were planted in mid spring season, 3.8 cm deep in a silt loam soil having 2% organic matter and a pH of 6.6. Plots were 6.1 m long by 3.0 m wide with rows spaced 76 cm apart. Seeds were spaced 15 cm apart within the rows. The field was managed using conventional tillage practices. The plots were arranged in a randomized complete block design with each treatment being replicated three times. Treatments were applied postemergence 29 days after planting using a backpack sprayer delivering a spray volume of 224 L/ha using a pressure of 476 kPa. Treatments consisted of Compound 2 and the commercial herbicide thifensulfuron-methyl, an AHAS inhibitor, alone and in combination, dissolved or suspended in water. All treatments also included a surfactant. Weed species present in the experimental plots in sufficient quantity to be evaluated included velvetleaf (ABUTH, Abutilon theophrasti Medik.), common ragweed (AMBEL, Ambrosia artemisiifolia L.), giant ragweed (AMBTR, Ambrosia trifida L.), common lambsquarters (CHEAL, Chenopodium album L.), jimsonweed (DATST, Datura stramonium L.), ivyleaf morningglory (IPOHE, Ipomoea hederacea (L.) Jacquin), Pennsylvania smartweed (POLPY, Polygonum pensylvanicum L.), and giant foxtail (SETFA, Setaria faberi Herrm.). The effects on the treated plants and untreated controls were recorded 14, 28 and 56 days after application. Some of the weed species could not be evaluated at every timing. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 26.

TABLE 26
Observed and Expected Results from Compound 2 Alone and in Combination
with Thifensulfuron-methyl.

| | Application | | | | | | | |
|---|---|---|---|---|---|---|---|---|
| | Rate (g a.i./ha) | | Postemergence | | | | | |
| | | Thifensulfuron- | ZEAMD | ZEAMD | ABUTH | ABUTH | AMBEL | AMBEL |
| DAA | Cpd 2 | methyl | Obs | Exp | Obs | Exp | Obs | Exp |
| 14 | 30 | — | 0 | | 86 | | 94 | |
| | 45 | — | 2 | | 64 | | 67 | |
| | 60 | — | 7 | | 95 | | 98 | |
| | — | 2 | 0 | | 53 | | 55 | |
| | — | 4 | 0 | | 60 | | 72 | |
| | — | 8 | 0 | | 55 | | 76 | |
| | 30 | 2 | 0 | 0 | 81 | 93 | 87 | 97 |
| | 45 | 2 | 5 | 2 | 92* | 83 | 85 | 85 |
| | 60 | 2 | 8 | 7 | 97 | 98 | 98 | 99 |
| | 30 | 4 | 3 | 0 | 90 | 94 | 88 | 98 |
| | 45 | 4 | 5 | 2 | 98* | 86 | 99* | 91 |
| | 60 | 4 | 8 | 7 | 99 | 98 | 98 | 100 |
| | 30 | 8 | 3 | 0 | 98* | 94 | 97 | 99 |
| | 45 | 8 | 5 | 2 | 98* | 84 | 99* | 92 |
| | 60 | 8 | 7 | 7 | 98 | 98 | 97 | 100 |
| 28 | 30 | — | 2 | | 80 | | 88 | |
| | 45 | — | 3 | | 59 | | 95 | |
| | 60 | — | 5 | | 90 | | 98 | |
| | — | 2 | 0 | | 75 | | 23 | |
| | — | 4 | 0 | | 79 | | 53 | |
| | — | 8 | 2 | | 87 | | 43 | |
| | 30 | 2 | 2 | 2 | 88 | 95 | 93* | 91 |
| | 45 | 2 | 13 | 3 | 92* | 90 | 99* | 96 |
| | 60 | 2 | 0# | 5 | 90 | 98 | 98 | 98 |
| | 30 | 4 | 0# | 2 | 92 | 96 | 96 | 95 |
| | 45 | 4 | 0# | 3 | 93 | 92 | 98 | 98 |
| | 60 | 4 | 2# | 5 | 96 | 98 | 100 | 99 |
| | 30 | 8 | 0# | 3 | 94 | 97 | 97* | 93 |
| | 45 | 8 | 3# | 5 | 94 | 95 | 97 | 97 |
| | 60 | 8 | 0# | 7 | 95 | 99 | 99 | 99 |
| 56 | 30 | — | 0 | | 40 | | 73 | |
| | 45 | — | 0 | | 57 | | 95 | |
| | 60 | — | 7 | | 63 | | 95 | |
| | — | 2 | 0 | | 33 | | 0 | |
| | — | 4 | 0 | | 30 | | 17 | |
| | — | 8 | 0 | | 73 | | 25 | |
| | 30 | 2 | 0 | 0 | 57 | 60 | 77* | 73 |
| | 45 | 2 | 0 | 0 | 33 | 71 | 98* | 95 |
| | 60 | 2 | 5# | 7 | 35 | 76 | 99* | 95 |
| | 30 | 4 | 0 | 0 | 58 | 58 | 82* | 78 |
| | 45 | 4 | 0 | 0 | 62 | 70 | 95 | 96 |
| | 60 | 4 | 7 | 7 | 78* | 74 | 100* | 96 |
| | 30 | 8 | 0 | 0 | 77 | 84 | 92* | 80 |
| | 45 | 8 | 0 | 0 | 80 | 88 | 95 | 96 |
| | 60 | 8 | 5# | 7 | 93* | 90 | 100* | 96 |

| | Application | | | | | | | |
|---|---|---|---|---|---|---|---|---|
| | Rate (g a.i./ha) | | Postemergence | | | | | |
| | | Thifensulfuron- | AMBTR | AMBTR | CHEAL | CHEAL | DATST | DATST |
| DAA | Cpd 2 | methyl | Obs | Exp | Obs | Exp | Obs | Exp |
| 14 | 30 | — | 97 | | 88 | | — | |
| | 45 | — | — | | 63 | | — | |
| | 60 | — | — | | 100 | | — | |
| | — | 2 | 75 | | 65 | | — | |
| | — | 4 | — | | 83 | | — | |
| | — | 8 | — | | 80 | | — | |
| | 30 | 2 | 85 | 99 | 93 | 96 | — | |
| | 45 | 2 | — | | 87 | 87 | — | |
| | 60 | 2 | — | | 97 | 100 | — | |
| | 30 | 4 | — | | 96 | 98 | — | |
| | 45 | 4 | — | | 100* | 94 | — | |
| | 60 | 4 | — | | 98 | 100 | — | |
| | 30 | 8 | — | | 100* | 98 | — | |
| | 45 | 8 | — | | 100* | 93 | — | |
| | 60 | 8 | — | | 97 | 100 | — | |
| 28 | 30 | — | 100 | | 100 | | 100 | |
| | 45 | — | 100 | | 100 | | 100 | |
| | 60 | — | 100 | | 100 | | 100 | |
| | — | 2 | 5 | | 90 | | 40 | |
| | — | 4 | 5 | | 93 | | 87 | |
| | — | 8 | — | | 98 | | 83 | |
| | 30 | 2 | 100 | 100 | 100 | 100 | 100 | 100 |
| | 45 | 2 | 100 | 100 | 100 | 100 | 100 | 100 |
| | 60 | 2 | 100 | 100 | 100 | 100 | 100 | 100 |
| | 30 | 4 | 100 | 100 | 100 | 100 | 98 | 100 |
| | 45 | 4 | 100 | 100 | 100 | 100 | 100 | 100 |
| | 60 | 4 | 100 | 100 | 100 | 100 | 100 | 100 |
| | 30 | 8 | — | | 100 | 100 | 100 | 100 |
| | 45 | 8 | — | | 100 | 100 | 99 | 100 |
| | 60 | 8 | — | | 100 | 100 | 100 | 100 |
| 56 | 30 | — | — | | 100 | | — | |
| | 45 | — | — | | 100 | | — | |
| | 60 | — | — | | 100 | | — | |
| | — | 2 | — | | 27 | | — | |
| | — | 4 | — | | 50 | | — | |
| | — | 8 | — | | 93 | | — | |
| | 30 | 2 | — | | 93 | 100 | — | |
| | 45 | 2 | — | | 100 | 100 | — | |
| | 60 | 2 | — | | 100 | 100 | — | |
| | 30 | 4 | — | | 100 | 100 | — | |
| | 45 | 4 | — | | 100 | 100 | — | |
| | 60 | 4 | — | | 100 | 100 | — | |
| | 30 | 8 | — | | 100 | 100 | — | |
| | 45 | 8 | — | | 100 | 100 | — | |
| | 60 | 8 | — | | 100 | 100 | — | |

| | Application | | | | | | | |
|---|---|---|---|---|---|---|---|---|
| | Rate (g a.i./ha) | | Postemergence | | | | | |
| | | Thifensulfuron- | IPOHE | IPOHE | POLPY | POLPY | SETFA | SETFA |
| DAA | Cpd 2 | methyl | Obs | Exp | Obs | Exp | Obs | Exp |
| 14 | 30 | — | 90 | | — | | — | |
| | 45 | — | 67 | | — | | — | |
| | 60 | — | 98 | | 100 | | — | |
| | — | 2 | 57 | | — | | — | |
| | — | 4 | 72 | | — | | — | |
| | — | 8 | 73 | | 0 | | — | |
| | 30 | 2 | 85 | 96 | — | | — | |
| | 45 | 2 | 85 | 86 | — | | — | |
| | 60 | 2 | 98 | 99 | — | | — | |
| | 30 | 4 | 97 | 97 | — | | — | |
| | 45 | 4 | 100* | 91 | — | | — | |
| | 60 | 4 | 99 | 100 | — | | — | |
| | 30 | 8 | 99* | 97 | — | | — | |
| | 45 | 8 | 99* | 91 | — | | — | |
| | 60 | 8 | 99 | 100 | 80 | 100 | — | |
| 28 | 30 | — | 95 | | 20 | | 98 | |
| | 45 | — | 99 | | 62 | | 97 | |
| | 60 | — | 98 | | 75 | | 99 | |
| | — | 2 | 17 | | 73 | | 87 | |
| | — | 4 | 20 | | 100 | | 88 | |
| | — | 8 | 45 | | 100 | | 82 | |
| | 30 | 2 | 97 | 96 | 80 | 79 | 96 | 100 |
| | 45 | 2 | 99 | 99 | 92* | 90 | 99 | 100 |
| | 60 | 2 | 93 | 99 | 92 | 93 | 98 | 100 |
| | 30 | 4 | 98* | 96 | 90 | 100 | 97 | 100 |
| | 45 | 4 | 99 | 99 | 97 | 100 | 98 | 100 |
| | 60 | 4 | 99 | 99 | 100 | 100 | 99 | 100 |
| | 30 | 8 | 99* | 97 | 98 | 100 | 98 | 100 |
| | 45 | 8 | 98 | 100 | 100 | 100 | 98 | 99 |
| | 60 | 8 | 99 | 99 | 100 | 100 | 98 | 100 |
| 56 | 30 | — | 88 | | — | | 50 | |
| | 45 | — | 96 | | — | | 73 | |
| | 60 | — | 98 | | — | | 70 | |
| | — | 2 | 0 | | — | | 0 | |
| | — | 4 | 0 | | — | | 23 | |
| | — | 8 | 20 | | — | | 13 | |
| | 30 | 2 | 89 | 88 | — | | 62* | 50 |
| | 45 | 2 | 89 | 96 | — | | 75* | 73 |
| | 60 | 2 | 97 | 98 | — | | 73* | 70 |
| | 30 | 4 | 96* | 88 | — | | 63 | 62 |
| | 45 | 4 | 95 | 96 | — | | 60 | 80 |
| | 60 | 4 | 96 | 98 | — | | 83* | 77 |
| | 30 | 8 | 90 | 91 | — | | 62* | 57 |
| | 45 | 8 | 98 | 97 | — | | 62 | 77 |
| | 60 | 8 | 97 | 99 | — | | 85* | 74 |

As can be seen from the results in Table 26, a number of the observed results for the mixture treatments on weeds were greater than expected from the Colby Equation, which indicates synergistic activity of the mixtures. Synergy was particularly apparent in velvetleaf, common ragweed, ivyleaf morningglory, and giant foxtail. In test species where a greater than additive response was less apparent, it was typically because the expected effect was already near 100% at the rates tested. In addition, a number of the observed results for the mixtures on corn were less than expected from the Colby Equation, which indicates safening activity of these mixtures. Less than additive responses were apparent for Compound 2 with thifensulfuron-methyl, particularly at the 28 DAT observation.

### Test 27

A field trial was conducted to evaluate the effects of mixtures of Compound 2 with commercial herbicides on winter wheat (TRZAW, Triticum aestivum L.) and a weed species. Wheat seeds (cv. ‘Custer’) were planted in late fall season in a clay loam soil. Plots were 9 m long by 1.8 m wide. The field was managed using conventional tillage practices. The plots were arranged in a randomized complete block design with each treatment being replicated three times. Treatments were applied postemergence in the early spring (112 days after planting) using a backpack sprayer delivering a spray volume of 140 L/ha using a pressure of 145 kPa. Treatments consisted of Compound 2 and the commercial herbicides thifensulfuron-methyl and tribenuron-methyl, AHAS inhibitors, alone and in combination, dissolved or suspended in water. All treatments also included a surfactant. The weed species present in the experimental plots in sufficient quantity to be evaluated was kochia (KCHSC, Kochia scoparia (L.) Schrad.). The effects on the treated plants and untreated controls were recorded 16, 28 and 49 days after application. Plants were visually evaluated compared to controls for response to the treatments using a scale of 0 to 100 where 0 is no effect and 100 is complete control. Results are the means of the three replicates. Colby's Equation was used to determine the herbicidal effects expected from the mixtures. The results and additive effects expected from Colby's Equation are listed in Table 27.

TABLE 27
Observed and Expected Results from Compound 2 Alone and in Combination
with Thifensulfuron-methyl or Tribenuron-methyl.

| | | | | Postemergence | | | |
|---|---|---|---|---|---|---|---|
| | Application Rate (g a.i./ha) | | | TRZAW | TRZAW | KCHSC | KCHSC |
| DAA | Cpd 2 | Thifensulfuron-methyl | Tribenuron-methyl | Obs | Exp | Obs | Exp |
| 16 | 15 | — | — | 2 | | 30 | |
| | 30 | — | — | 10 | | 65 | |
| | 45 | — | — | 17 | | 78 | |
| | — | 10 | — | 0 | | 0 | |
| | — | — | 10 | 0 | | 22 | |
| | 15 | 10 | — | 2 | 2 | 33* | 30 |
| | 30 | 10 | — | 7# | 10 | 65 | 65 |
| | 45 | 10 | — | 17 | 17 | 79 | 78 |
| | 15 | — | 10 | 4 | 2 | 47* | 45 |
| | 30 | — | 10 | 13 | 10 | 65 | 73 |
| | 45 | — | 10 | 18 | 17 | 79 | 83 |
| 28 | 15 | — | — | 0 | | 43 | |
| | 30 | — | — | 12 | | 79 | |
| | 45 | — | — | 25 | | 94 | |
| | — | 10 | — | 0 | | 0 | |
| | — | — | 10 | 0 | | 23 | |
| | 15 | 10 | — | 2 | 0 | 63* | 43 |
| | 30 | 10 | — | 7# | 12 | 83* | 79 |
| | 45 | 10 | — | 20# | 25 | 93 | 94 |
| | 15 | — | 10 | 0 | 0 | 62* | 57 |
| | 30 | — | 10 | 10# | 12 | 83 | 84 |
| | 45 | — | 10 | 17# | 25 | 91 | 95 |
| 49 | 15 | — | — | 3 | | 32 | |
| | 30 | — | — | 17 | | 73 | |
| | 45 | — | — | 35 | | 96 | |
| | — | 10 | — | 0 | | 0 | |
| | — | — | 10 | 0 | | 22 | |
| | 15 | 10 | — | 0# | 3 | 53* | 32 |
| | 30 | 10 | — | 14# | 17 | 78* | 73 |
| | 45 | 10 | — | 32# | 35 | 84 | 96 |
| | 15 | — | 10 | 0# | 3 | 50* | 46 |
| | 30 | — | 10 | 13# | 17 | 77 | 79 |
| | 45 | — | 10 | 30# | 35 | 87 | 97 |

As can be seen from the results in Table 27, a number of the observed results for the mixture treatments on kochia were greater than expected from the Colby Equation, which indicates synergistic activity of the mixtures. Synergy was apparent with both thifensulfuron-methyl and tribenuron-methyl mixtures. In addition, a number of the observed results for the mixtures on winter wheat were less than expected from the Colby Equation, which indicates safening activity of these mixtures. Less than additive responses were apparent for Compound 2 with both thifensulfuron-methyl and tribenuron-methyl, particularly at the 28 and 49 DAT observation timings.

### Test 28

A greenhouse test was conducted to evaluate the effects on the plant species corn (ZEAMD, Zea mays ssp. indentata), sorghum (SORVU, Sorghum vulgare L.), dry-seeded rice (ORYSA, Oryza sativa L.), wheat (TRZAW, Triticum aestivum L.), ivyleaf morningglory (IPOHE, Ipomoea hederacea (L.) JACQ.), and barnyardgrass (ECHCG, Echinochloa crus-galli (L.) P. BEAUV.), of mixtures of Compound 2 with isoxadifen-ethyl. Corn, sorghum, rice, wheat, ivyleaf morningglory and barnyardgrass seeds were planted in RediEarth, a commercial potting medium. Seeds were planted at appropriate intervals and grown in a greenhouse until they achieved the desired stage of growth for application. Corn plants were treated postemergence at the V2 growth stage, and sorghum, rice, wheat, ivyleaf morningglory, and barnyardgrass plants were treated postemergence at the 3-leaf stage. In addition, corn and wheat seeds were planted in a silt loam soil having 3.9% organic matter and a pH of 5.3, and were treated preemergence with mixtures of Compound 2 and isoxadifen-ethyl. Each treatment was replicated three times. Treatments were applied using a belt sprayer that delivered a spray volume of 280 L/ha using a pressure of 262 kPa. Treatments consisted of Compound 2 and isoxadifen-ethyl, alone and in combination, dissolved or suspended in a non-phytotoxic solvent mixture. After treatment, the plants were returned to a greenhouse where balanced supplemental lighting was used to maintain a 16-hour photoperiod and the daytime and nighttime temperatures were about 27° C. and 21° C., respectively. Plants were watered as needed. Effects on the treated plants and untreated controls were recorded approximately 26 days after application. Plants were visually evaluated compared to controls for response to the treatments using a scale of 0 to 100 where 0 is no effect and 100 is complete control. Colby's Equation was used to determine the herbicidal effects expected from the mixtures. The results and additive effects expected from Colby's Equation are listed in Table 28.

TABLE 28
Observed and Expected Results from Compound 2 Alone and in Combination
with Isoxadifen-ethyl.

| | | | Postemergence | | | |
|---|---|---|---|---|---|---|
| | Application Rate (g a.i./ha) | | TRZAW | TRZAW | ZEAMD | ZEAMD |
| DAA | Cpd 2 | Isoxadifen-ethyl | Obs | Exp | Obs | Exp |
| 26 | 32 | — | 80 | | 27 | |
| | 64 | — | 90 | | 50 | |
| | — | 64 | 0 | | 0 | |
| | — | 128 | 0 | | 0 | |
| | — | 256 | 0 | | 0 | |
| | — | 512 | 0 | | 0 | |
| | — | 1024 | 0 | | 0 | |
| | 32 | 64 | 77# | 80 | 0# | 27 |
| | 32 | 128 | 80 | 80 | 13# | 27 |
| | 32 | 256 | 63# | 80 | 3# | 27 |
| | 32 | 512 | 57# | 80 | 7# | 27 |
| | 32 | 1024 | 77# | 80 | 0# | 27 |
| | 64 | 64 | 83# | 90 | 27# | 50 |
| | 64 | 128 | 77# | 90 | 0# | 50 |
| | 64 | 256 | 77# | 90 | 33# | 50 |
| | 64 | 512 | 83# | 90 | 27# | 50 |
| | 64 | 1024 | 77# | 90 | 33# | 50 |
| | | | Postemergence | | | |
| | Application Rate (g a.i./ha) | | IPOHE | IPOHE | SORVU | SORVU |
| DAA | Cpd 2 | Isoxadifen-ethyl | Obs | Exp | Obs | Exp |
| 26 | 32 | — | 100 | | 73 | |
| | 64 | — | 100 | | 96 | |
| | — | 64 | 0 | | 0 | |
| | — | 128 | 0 | | 0 | |
| | — | 256 | 0 | | 0 | |
| | — | 512 | 0 | | 0 | |
| | — | 1024 | 0 | | 0 | |
| | 32 | 64 | 100 | 100 | 73 | 73 |
| | 32 | 128 | 95 | 100 | 73 | 73 |
| | 32 | 256 | 97 | 100 | 50 | 73 |
| | 32 | 512 | 100 | 100 | 57 | 73 |
| | 32 | 1024 | 95 | 100 | 33 | 73 |
| | 64 | 64 | 100 | 100 | 96 | 96 |
| | 64 | 128 | 100 | 100 | 96 | 96 |
| | 64 | 256 | 100 | 100 | 80 | 96 |
| | 64 | 512 | 100 | 100 | 73 | 96 |
| | 64 | 1024 | 97 | 100 | 87 | 96 |
| | | | Postemergence | | | |
| | Application Rate (g a.i./ha) | | ECHCG | ECHCG | ORYSA | ORYSA |
| DAA | Cpd 2 | Isoxadifen-ethyl | Obs | Exp | Obs | Exp |
| 26 | 32 | — | 83 | | 60 | |
| | 64 | — | 87 | | 83 | |
| | — | 64 | 0 | | 0 | |
| | — | 128 | 0 | | 0 | |
| | — | 256 | 0 | | 0 | |
| | — | 512 | 0 | | 0 | |
| | — | 1024 | 0 | | 0 | |
| | 32 | 64 | 80 | 83 | 7# | 60 |
| | 32 | 128 | 80 | 83 | 23# | 60 |
| | 32 | 256 | 70 | 83 | 0# | 60 |
| | 32 | 512 | 53 | 83 | 0# | 60 |
| | 32 | 1024 | 0 | 83 | 17# | 60 |
| | 64 | 64 | 90 | 87 | 73# | 83 |
| | 64 | 128 | 90 | 87 | 40# | 83 |
| | 64 | 256 | 87 | 87 | 37# | 83 |
| | 64 | 512 | 77 | 87 | 7# | 83 |
| | 64 | 1024 | 60 | 87 | 27# | 83 |
| | | | Preemergence | | | |
| | Application Rate (g a.i./ha) | | ZEAMD | ZEAMD | TRZAW | TRZAW |
| DAA | Cpd 2 | Isoxadifen-ethyl | Obs | Exp | Obs | Exp |
| 26 | 32 | — | 7 | | 0 | |
| | 64 | — | 7 | | 27 | |
| | — | 64 | 0 | | 0 | |
| | — | 128 | 0 | | 0 | |
| | — | 256 | 0 | | 0 | |
| | — | 512 | 0 | | 0 | |
| | — | 1024 | 0 | | 0 | |
| | 32 | 64 | 0# | 7 | 0 | 0 |
| | 32 | 128 | 0# | 7 | 0 | 0 |
| | 32 | 256 | 0# | 7 | 0 | 0 |
| | 32 | 512 | 0# | 7 | 0 | 0 |
| | 32 | 1024 | 0# | 7 | 10 | 0 |
| | 64 | 64 | 7 | 7 | 20# | 27 |
| | 64 | 128 | 0# | 7 | 13# | 27 |
| | 64 | 256 | 0# | 7 | 30 | 27 |
| | 64 | 512 | 0# | 7 | 27 | 27 |
| | 64 | 1024 | 0# | 7 | 23# | 27 |

As can be seen from the results in Table 28, a number of the observed results for the mixtures on wheat (TRZAW), preemergence and postemergence; corn (ZEAMD), preemergence and postemergence; sorghum (SORVU); barnyardgrass (ECHCG); and rice (ORYSA) were less than expected from the Colby Equation, which indicates safening activity of these mixtures. In particular, corn and rice showed substantial amounts of safening with these mixtures.

### Test 29

A greenhouse test was conducted to evaluate the effects of Compounds 1 and 2, applied preemergence, on the plant species corn (ZEAMD, Zea mays ssp. indentata) and wheat (TRZAW, Triticum aestivum L.) grown from seed treated with and without naphthalic anhydride. Naphthalic anhydride was applied at a rate of 1% wt/wt basis to corn and wheat seed. Seed treatments were made as follows for evaluations of the chemical materials employed. One-hundred grams of each crop seed were placed in a separate self-closing plastic bag to which 1 gram of the chemical material was added. The bag containing the seed was tightly closed and gently agitated thereby allowing the seed to slowly come in contact with the chemical material to achieve maximal distribution on the seed surface, arriving at a uniform coverage. Treatment rate comparisons between spray application and seed treatment materials were made on the calculated area rate of naphthalic anhydride in grams active ingredient per hectare for a given crop. These rates were calculated based on a typical seeding rate per hectare used for agronomic production of a given crop. For wheat, a typical average seeding rate is 200 wheat seeds per square meter which weigh 6.8 g. For corn, a typical average seeding rate is 7.5 corn seeds per square meter which weigh 2.0 g. Corn was planted into a silt loam soil having 3.9% organic matter and a pH of 5.3, and wheat was planted into a sand/soil mixture. Compounds 1 and 2 were dissolved or suspended in a non-phytotoxic solvent and applied using a belt sprayer that delivered a spray volume of 458 L/ha at a pressure of 214 kPa. Corn treatments were replicated three times. Wheat treatments were replicated two times. After treatment, the pots were placed in a greenhouse where balanced supplemental lighting was used to maintain a 16-hour photoperiod. Daytime and nighttime temperatures were about 28° C. and 21° C., respectively. Plants were watered as needed. Effects on the treated plants and untreated controls were recorded at 26 days after application. Plants were visually evaluated compared to controls for response to the treatments using a scale of 0 to 100 where 0 is no effect and 100 is complete control. Colby's Equation was used to determine the herbicidal effects expected from the combinations. The results and additive effects expected from Colby's Equation are listed in Table 29.

TABLE 29
Observed and Expected Results from Compounds 1 or 2 Applied to Corn and
Wheat Plants Grown from Seed Treated with or without Naphthalic Anhydride.

| | Application Rate | | | Preemergence | | | |
|---|---|---|---|---|---|---|---|
| | (g a.i./ha) | | | ZEAMD | ZEAMD | TRZAW | TRZAW |
| DAA | Cpd 1 | Cpd 2 | Naphthalic anhydride | Obs | Exp | Obs | Exp |
| 26 | 35 | — | — | 22 | | 63 | |
| | 140 | — | — | 47 | | 93 | |
| | — | 35 | — | 15 | | 53 | |
| | — | 140 | — | 40 | | 73 | |
| | — | — | 200 | 0 | | | |
| | 35 | — | 200 | 0# | 22 | | |
| | 140 | — | 200 | 15# | 47 | | |
| | — | 35 | 200 | 13# | 15 | | |
| | — | 140 | 200 | 7# | 40 | | |
| | — | — | 680 | | | 0 | |
| | 35 | — | 680 | | | 48# | 63 |
| | 140 | — | 680 | | | 55# | 93 |
| | — | 35 | 680 | | | 40# | 53 |
| | — | 140 | 680 | | | 63# | 73 |

As can be seen from the results in Table 29, observed results for Compounds 1 and 2, in combinations with naphthalic anhydride, on corn (ZEAMD) and wheat (TRZAW), were less than expected from the Colby Equation, which indicates safening activity of these combinations.

### Test 30

A growth chamber test was conducted to evaluate the effects on the plant species wheat (TRZAW, Triticum aestivum L.) and barley (HORVX, Hordeum vulgare L.) with mixtures of Compound 1 and Compound 2 with glycerol. Wheat and barley seeds were planted in a sandy loam soil having 0.9% organic matter and a pH of 6.3. Seeds were planted at appropriate intervals and grown in a growth chamber until they achieved the desired stage of growth for application. Wheat and barley plants were treated postemergence at the two leaf growth stage for Compound 1 and at the three leaf growth stage for Compound 2. Each treatment was replicated one time. Treatments were applied using a belt sprayer that delivered a spray volume of 280 L/ha using a pressure of 214 kPa. Treatments consisted of Compound 1 and Compound 2 and glycerol, alone and in combination, dissolved or suspended in deionized water. After treatment, the plants were returned to a growth chamber where balanced lighting was used to maintain a 16-hour photoperiod and the daytime and nighttime temperatures were about 16° C. and 10° C., respectively. Plants were watered as needed. Effects on the treated plants and untreated controls were recorded approximately 17 or 18 days after application. Plants were visually evaluated compared to controls for response to the treatments using a scale of 0 to 100 where 0 is no effect and 100 is complete control. Colby's Equation was used to determine herbicidal effects expected from the mixtures. The results and additive effects expected from Colby's Equation are listed in Table 30.

TABLE 30
Observed and Expected Results from Compound 1 and Compound 2 Alone and
in Combination with Glycerol.

| | Application Rate | | | Postemergence | | | |
|---|---|---|---|---|---|---|---|
| | (g a.i./ha) | | | TRZAW | TRZAW | HORVX | HORVX |
| DAA | Cpd 1 | Cpd 2 | Glycerol | Obs | Exp | Obs | Exp |
| 18 | 1 | — | — | 30 | | 0 | |
| | 4 | — | — | 35 | | 20 | |
| | 16 | — | — | 45 | | 40 | |
| | — | — | 7100 | 0 | | 0 | |
| | — | — | 14200 | 0 | | 0 | |
| | 1 | — | 7100 | 20# | 30 | 0 | 0 |
| | 4 | — | 7100 | 25# | 35 | 0# | 20 |
| | 16 | — | 7100 | 30# | 45 | 25# | 40 |
| | 1 | — | 14200 | — | 30 | 0 | 0 |
| | 4 | — | 14200 | 10# | 35 | 0# | 20 |
| | 16 | — | 14200 | 40# | 45 | 20# | 40 |
| 17 | — | 1 | — | 20 | | 25 | |
| | — | 4 | — | 20 | | 30 | |
| | — | 16 | — | 35 | | 35 | |
| | — | — | 7100 | 0 | | 0 | |
| | — | — | 14200 | 0 | | 0 | |
| | — | 1 | 7100 | 10# | 20 | 20# | 25 |
| | — | 4 | 7100 | 10# | 20 | 20# | 30 |
| | — | 16 | 7100 | 20# | 35 | 20# | 35 |
| | — | 1 | 14200 | 10# | 20 | 20# | 25 |
| | — | 4 | 14200 | 20 | 20 | 20# | 30 |
| | — | 16 | 14200 | 20# | 35 | 15# | 35 |

As can be seen from the results in Table 30, observed results for Compounds 1 and 2, in combinations with glycerol, on wheat (TRZAW) or barley (HORVX) were less than expected from the Colby Equation, which indicates safening activity of these combinations.

### Test 31

A field trial was conducted to evaluate the effects of Compound 2 with a commercial premix herbicide formulation of foramsulfuron and isoxadifen-ethyl (1:1 weight mixture) on several hybrids of corn (ZEAMD, Zea mays ssp. indentata). Corn seeds of hybrids Pioneer ‘34A15’, ‘34N43’, ‘35D28’, and ‘3730’ were planted in mid-spring season, approximately 3.8 cm deep in a sandy loam soil having 3.8% organic matter and a pH of 6.5. Plots were 9.1 m long by 3.0 m wide with rows spaced 76 cm apart. Seeds were spaced approximately 18 cm apart within the rows. The field was managed using conventional tillage practices. Plots were arranged with hybrid as the main block and herbicide treatments randomized within each block. Treatments were applied to corn in the V4 growth stage using a backpack sprayer delivering a spray volume of 131 L/ha with a pressure of 221 kPa. Treatments consisted of Compound 2 alone and in combination with a premix formulation of foramsulfuron and isoxadifen-ethyl, dissolved or suspended in water containing the spray adjuvants ammonium sulfate, applied at 1 kg/Ha, and methylated seed oil, applied at 1% vol/vol. Effects on the treated corn plants and untreated controls were recorded 14 days after application. Plants were visually evaluated compared to controls for response to the treatments using a scale of 0 to 100 where 0 is no effect and 100 is complete control.

TABLE 31
Observed and Expected Results from Compound 2 Alone and in
Combinations with Premix Formulations of Foramsulfuron and
Isoxadifen-ethyl.

| | Application Rate (g a.i./ha) | | Postemergence | | | |
|---|---|---|---|---|---|---|
| | | Foramsulfuron and | 34A15 | 34N43 | 35D28 | 3730 |
| DAA | Cpd 2 | Isoxadifen-ethyl | Obs | Obs | Obs | Obs |
| 14 | 30 | — | 25 | 15 | 60 | 60 |
| | 60 | — | 30 | 20 | 65 | 75 |
| | 30 | 12.25 | 0 | 0 | 5 | 10 |
| | 30 | 24.5 | 10 | 0 | 10 | 10 |
| | 60 | 12.25 | 0 | 0 | 5 | 10 |
| | 60 | 24.5 | 10 | 10 | 15 | 20 |

Observed corn responses were surprisingly less than expected for combinations of Compound 2 with the premix formulation of foramsulfuron and isoxadifen-ethyl.

### Test 32

A greenhouse trial was conducted to evaluate the effects of Compound 1 and isoxadifen-ethyl at different ratios in simulated flooded rice culture. Plastic pots (11-cm diameter) were partially filled with non-sterilized Tama silt loam soil containing a 15:57:28 ratio of sand, silt and clay and 2.9% organic matter. Seeds of Heteranthera limosa (ducksalad; HETLI), Cyperus difformis (smallflower umbrella sedge; CYPDI), one stand of Echinochloa crus-galli (barnyardgrass; ECHCG), and one stand of four rice seedlings (Oryza sativa cv. ‘M202’; ORYSA) were planted into a single 11-cm diameter pot for each rate and mixture of rates. To obtain this planting, C. difformis and H. limosa seeds were planted separately on the surface soil layer at particular locations within each pot. Water levels were brought to a puddled condition above the soil surface directly after planting. E. crus-galli and rice seeds were planted in cavity trays in the silt loam soil and transplanted at the 1.5 and 2.0 leaf stage, respectively. E. crus-galli and rice plants were transplanted to about 2-cm depth by transferring plugs from the cavity trays. Plantings were sequential so that these plant species all reached the 2.0- to 2.5-leaf stage in the 11-cm diameter pot at time of treatment. Plantings were established and maintained in a greenhouse with day and night temperatures of about 29.5 and 26.7° C. respectively; supplemental balanced lighting was provided to maintain a 16-hour photoperiod. Pots were fertilized periodically with a 200 ppm solution of commercial Scotts Peters® Professional® General Purpose 20-20-20 Water Soluble Fertilizer, amended to 10 ppm with a commercial iron-chelate micronutrient fertilizer. The solution was supplied at time of watering via a liquid fertilizer injector.

At treatment time, test pots were flooded to 3 cm above the soil surface and maintained at that water depth for the duration of the test. Chemical treatments were formulated in acetone and applied directly to the paddy water (i.e., postemergence to flood). Make-up volumes of acetone were added to ensure that all pots were treated with a consistent volume. Test pots were maintained in the greenhouse. A randomized complete block design was employed. Five replicates of each treatment, alone and in mixture, were used. Each species was visually evaluated for treatment effects by comparing those treated to untreated controls and rated for plant response after 21 days. Plant response ratings are reported on a 0 to 100 scale where 0 is no effect and 100 is complete control. The results and additive effects expected from Colby's Equation are listed in Table 32.

TABLE 32
Observed and Expected Results from Compound 1 Alone and in Combinations
with Isoxadifen-ethyl.

| | Application | | Postemergence to flood | | | | | | | |
|---|---|---|---|---|---|---|---|---|---|---|
| | Rate (g a.i./ha) | | ORYSA | | CYPDI | | HETLI | | ECHCG | |
| DAA | Cpd 1 | Isoxadifen-ethyl | Obs | Exp | Obs | Exp | Obs | Exp | Obs | Exp |
| 21 | 0 | — | 0 | | 0 | | 0 | | 0 | |
| | 31.25 | — | 9 | | 80 | | 38 | | 10 | |
| | 62.5 | — | 15 | | 74 | | 76 | | 19 | |
| | 125 | — | 27 | | 92 | | 95 | | 37 | |
| | — | 31.25 | 2 | | 28 | | 10 | | 4 | |
| | — | 62.5 | 5 | | 24 | | 29 | | 9 | |
| | — | 125 | 11 | | 84 | | 35 | | 15 | |
| | — | 250 | 7 | | 59 | | 19 | | 10 | |
| | — | 500 | 5 | | 49 | | 23 | | 5 | |
| | — | 1000 | 5 | | 53 | | 25 | | 8 | |
| | — | 1500 | 10 | | 59 | | 36 | | 9 | |
| | 31.25 | 31.25 | 14 | 11 | 87 | 86 | 50 | 44 | 17 | 14 |
| | 31.25 | 62.5 | 3# | 14 | 63 | 85 | 32 | 56 | 15 | 18 |
| | 31.25 | 125 | 18 | 19 | 45 | 97 | 24 | 60 | 10 | 24 |
| | 31.25 | 250 | 16 | 15 | 65 | 92 | 47 | 50 | 16 | 19 |
| | 31.25 | 500 | 6# | 14 | 54 | 90 | 28 | 52 | 14 | 15 |
| | 31.25 | 1000 | 6# | 14 | 19 | 91 | 15 | 54 | 16 | 17 |
| | 31.25 | 1500 | 5# | 18 | 30 | 92 | 25 | 60 | 14 | 18 |
| | 62.5 | 31.25 | 10# | 17 | 88 | 81 | 42 | 78 | 21 | 22 |
| | 62.5 | 62.5 | 6# | 19 | 80 | 80 | 50 | 83 | 12 | 26 |
| | 62.5 | 125 | 5# | 24 | 57 | 96 | 38 | 84 | 14 | 31 |
| | 62.5 | 250 | 6# | 21 | 25 | 89 | 32 | 81 | 11 | 27 |
| | 62.5 | 500 | 3# | 19 | 64 | 87 | 55 | 82 | 18 | 23 |
| | 62.5 | 1000 | 0# | 19 | 42 | 88 | 32 | 82 | 12 | 25 |
| | 62.5 | 1500 | 5# | 24 | 78 | 89 | 44 | 85 | 13 | 26 |
| | 125 | 31.25 | 32 | 28 | 87 | 94 | 94 | 96 | 36 | 40 |
| | 125 | 62.5 | 15# | 31 | 63 | 94 | 85 | 96 | 28 | 43 |
| | 125 | 125 | 12# | 35 | 94 | 99 | 89 | 97 | 20 | 46 |
| | 125 | 250 | 2# | 32 | 68 | 97 | 88 | 96 | 18 | 43 |
| | 125 | 500 | 8# | 31 | 60 | 96 | 82 | 96 | 21 | 40 |
| | 125 | 1000 | 11# | 31 | 77 | 96 | 86 | 96 | 40 | 42 |
| | 125 | 1500 | 4# | 34 | 81 | 97 | 82 | 97 | 38 | 43 |

Observed rice responses were surprisingly less than expected for combinations of Compound 1 with isoxadifen-ethyl, which indicates safening activity of these combinations.

What is claimed is:

1. A mixture comprising (a) at least one herbicidal compound selected from the pyrimidines of Formula 1, including all geometric and stereoisomers, N-oxides, and salts thereof, 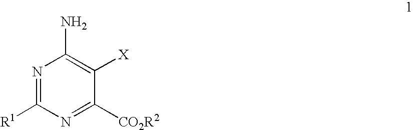
wherein
R¹ is cyclopropyl, 4-Br-phenyl or 4-Cl-phenyl;
X is Cl or Br; and
R² is H, C₁-C₁₄ alkyl, C₂-C₁₄ alkoxyalkyl, C₃-C₁₄ alkoxyalkoxyalkyl, C₂-C₁₄ hydroxyalkyl or benzyl; and
(b) at least one additional herbicide or herbicide safener compound selected from the group consisting of
(b1) ACCase (acetyl-coenzyme A carboxylase) inhibitors;
(b2) AHAS (acetohydroxy acid synthase) inhibitors;
(b3) photosystem II inhibitors;
(b4) photosystem I electron diverters;
(b5) PPO (protoporphyrinogen oxidase) inhibitors;
(b6) EPSP (5-enol-pyruvylshikimate-3-phosphate) synthase inhibitors;
(b7) GS (glutamine synthetase) inhibitors;
(b8) VLCFA (very long chain fatty acid) elongase inhibitors;
(b9) auxin mimics;
(b10) auxin transport inhibitors;
(b11) other herbicides selected from the group consisting of flamprop-M-methyl, flamprop-M-isopropyl, difenzoquat, DSMA, MSMA, bromobutide, flurenol, cinmethylin, cumyluron, dazomet, dymron, methyldymron, etobenzanid, fosamine-ammonium, isoxaflutole, metam, oxaziclomefone, oleic acid, pelargonic acid and pyributicarb;
(b12) herbicide safeners selected from the group consisting of benoxacor, 1-bromo-4-[(chloromethyl)sulfonyl]benzene, cloquintocet-mexyl, cyometrinil, dichlormid, 2-(dichloromethyl)-2-methyl-1,3-dioxolane, fenchlorazole-ethyl, fenclorim, flurazole, fluxofenim, furilazole, isoxadifen-ethyl, mefenpyr-diethyl, methoxyphenone, naphthalic anhydride and oxabetrinil; and
salts of compounds of (b1) through (b12).

2. The mixture of claim 1 wherein
R² is H or C₁-C₂ alkyl.

3. The mixture of claim 1 wherein
R² is C₅-C₈ alkyl, C₅-C₈ alkoxyalkyl, C₅-C₈ alkoxyalkoxyalkyl or C₅-C₈ hydroxyalkyl.

4. The mixture of claim 1 wherein the pyrimidine compound of Formula 1 and its salts is selected from the group consisting of:
6-amino-5-chloro-2-cyclopropyl-4-pyrimidinecarboxylic acid,
methyl 6-amino-5-chloro-2-cyclopropyl-4-pyrimidinecarboxylate,
ethyl 6-amino-5-chloro-2-cyclopropyl-4-pyrimidinecarboxylate,
6-amino-5-bromo-2-cyclopropyl-4-pyrimidinecarboxylic acid,
methyl 6-amino-5-bromo-2-cyclopropyl-4-pyrimidinecarboxylate,
ethyl 6-amino-5-bromo-2-cyclopropyl-4-pyrimidinecarboxylate,
6-amino-5-chloro-2-(4-chlorophenyl)-4-pyrimidinecarboxylic acid,
methyl 6-amino-5-chloro-2-(4-chlorophenyl)-4-pyrimidinecarboxylate,
ethyl 6-amino-5-chloro-2-(4-chlorophenyl)-4-pyrimidinecarboxylate,
phenylmethyl 6-amino-5-bromo-2-cyclopropyl-4-pyrimidinecarboxylate,
6-amino-5-bromo-2-cyclopropyl-4-pyrimidinecarboxylic acid monosodium salt,
phenylmethyl 6-amino-5-chloro-2-cyclopropyl-4-pyrimidinecarboxylate,
6-amino-5-chloro-2-cyclopropyl-4-pyrimidinecarboxylic acid monosodium salt,
ethyl 6-amino-2-(4-bromophenyl)-5-chloro-4-pyrimidinecarboxylate,
methyl 6-amino-2-(4-bromophenyl)-5-chloro-4-pyrimidinecarboxylate,
6-amino-2-(4-bromophenyl)-5-chloro-4-pyrimidinecarboxylic acid,
1-methylethyl 6-amino-5-chloro-2-cyclopropyl-4-pyrimidinecarboxylate,
butyl 6-amino-5-chloro-2-cyclopropyl-4-pyrimidinecarboxylate,
3-hydroxypropyl 6-amino-5-chloro-2-cyclopropyl-4-pyrimidinecarboxylate,
propyl 6-amino-5-chloro-2-cyclopropyl-4-pyrimidinecarboxylate,
1-methylheptyl 6-amino-5-chloro-2-cyclopropyl-4-pyrimidinecarboxylate,
2-(2-methoxyethoxy)ethyl 6-amino-5-chloro-2-cyclopropyl-4-pyrimidinecarboxylate,
octyl 6-amino-5-chloro-2-cyclopropyl-4-pyrimidinecarboxylate,
2-butoxyethyl 6-amino-5-chloro-2-cyclopropyl-4-pyrimidinecarboxylate,
2-ethylhexyl 6-amino-5-chloro-2-cyclopropyl-4-pyrimidinecarboxylate, and
2-butoxy-1-methylethyl 6-amino-5-chloro-2-cyclopropyl-4-pyrimidinecarboxylate.

5. The mixture of claim 4 wherein the pyrimidine compound of Formula 1 is selected from the group consisting of:
6-amino-5-chloro-2-cyclopropyl-4-pyrimidinecarboxylic acid, and
methyl 6-amino-5-chloro-2-cyclopropyl-4-pyrimidinecarboxylate.

6. The mixture of any one of claims 1 through 5 wherein the additional herbicide or herbicide safener compound (b) is selected from the group consisting of fenoxaprop, clodinafop, diuron, atrazine, paraquat, glyphosate, glufosinate, S-metolachlor, metolachlor, fosamine-ammonium, foramsulfuron, rimsulfuron, oxyfluorfen, profluazol, acifluorfen, flumioxazin, carfentrazone, sulfentrazone, azafenidin, 2,4-D, MCPA, fluroxypyr, diflufenzopyr, nicosulfuron, thifensulfuron-methyl, tribenuron-methyl, isoxadifen-ethyl and naphthalic anhydride.

7. The mixture of any one of claims 1 through 5 wherein at least two additional herbicide or herbicide safener compounds (b) are selected from the group consisting of (b1), (b2), (b3), (b4), (b5), (b6), (b7), (b8), (b9), (b10), (b11) and (b12).

8. A herbicidal composition comprising a herbicidally effective amount of the mixture of any one of the preceding Claims and at least one additional component selected from the group consisting of a surfactant, humectant, a solid diluent and a liquid diluent.

9. The herbicidal composition of claim 8 comprising glycerol.

10. A method for controlling the growth of undesired vegetation comprising contacting the vegetation or its environment with a herbicidally effective amount of the mixtures of any one of claims 1 through 7.
